(19) United States
(12) Patent Application Publication
(10) Pub. No.: US 2025/0130098 A1
(43) Pub. Date: Apr. 24, 2025

(54) SERVO-TYPE VIBRATION DETECTOR AND EVALUATION METHOD FOR SERVO-TYPE VIBRATION DETECTOR

(71) Applicant: TOKKYOKIKI CORPORATION, Amagasaki-shi, Hyogo (JP)

(72) Inventors: Teruo MARUYAMA, Hirakata-shi (JP); Takumi OKADA, Ikoma-shi (JP); Hiroshi TAKIMOTO, Amagasaki-shi (JP); Satoki YAMAGUCHI, Osaka-shi (JP)

(21) Appl. No.: 18/717,933

(22) PCT Filed: Dec. 14, 2022
(86) PCT No.: PCT/JP2022/045991

§ 371 Date: Jan. 3, 2025

(30) Foreign Application Priority Data
Dec. 15, 2021 (JP) 2021-203698
Dec. 16, 2021 (JP) 2021-204452
Dec. 16, 2021 (JP) 2021-204453
Dec. 16, 2021 (JP) 2021-204454

(51) Int. Cl. G01H 11/06; G01P 15/125; G01P 15/13

(52) U.S. Cl. CPC G01H 11/06; G01P 15/125; G01P 15/13

(57) ABSTRACT

In the case of the conventional servo-type acceleration sensor, the sensor needs to be configured within a narrow range that simultaneously satisfies the following three conflicting challenges: (1) reduction in resonance peak, (2) improvement of responsiveness, and (3) improvement of sensor sensitivity. Therefore, there is a limit to performance improvement. A mechanical damping effect of a dynamic fluid pressure in the inter-electrode void portion is reduced by forming a flow hole, a flow groove, and the like at the relative movement surface of the electrode, and this damping effect is replaced with an equivalent damping unit by using an electrical circuit in the servo amplifier. As a result, although the sensor sensitivity, determined by the gap between the electrodes and the outer diameter of the electrode, and the sensor dynamic characteristics have conventionally been in a trade-off relationship, the sensor sensitivity and the sensor dynamic characteristics can be independently set.

### TECHNICAL FIELD

The present invention relates to a vibration sensor or a vibration elimination control device that detects, in a wide frequency band, a signal of acceleration of an object to be controlled that is supported with respect to a foundation and vibrates due to disturbance, or a signal of an absolute speed or an absolute displacement with respect to an inertial space.

### BACKGROUND ART

### 1. Trends in the World

Use of vibration control for blocking or reducing fine vibration is growing in various fields such as a semiconductor manufacturing process, a liquid crystal manufacturing process, and precision machining. Microfabrication and inspection devices such as scanning electron microscopes and semiconductor exposure devices (steppers) used in these processes are required to satisfy strict vibration tolerance conditions for guaranteeing the performance of the devices. Together with further higher integration and miniaturization of products, an increase in the speed of a fabrication process and an increase in the size of a device will progress going forward, and vibration tolerance conditions will tend to be increasingly strict.

### 2. Disturbance to be Eliminated by Vibration Isolator

In recent years, an active vibration control technique has been widespread. The active vibration control technique controls a control device by generating a control signal on the basis of displacement/speed/acceleration information from vibration sensors disposed at a plurality of positions of a structure to be subjected to vibration control (e.g., a precision vibration isolator).

FIG. 64 is a model view of a conventional active vibration isolator. This active vibration isolator is publicly known as described in Patent Literature 1 and Patent Literature 2. A plurality of sets of pneumatic actuators (502a and 502b) for supporting a surface plate 501 are disposed on a floor surface 500. A precision device (not illustrated) is mounted on or above the surface plate 501. Reference sign 503 denotes an acceleration sensor for detecting acceleration of the surface plate 501 in the vertical and horizontal directions, and reference sign 504 denotes an acceleration sensor for detecting acceleration of the floor surface 500 (vibration state of the foundation). Reference signs 505a and 505b denote displacement sensors for respectively detecting vertical and horizontal relative displacement of the surface plate 501 with respect to the floor surface 500. Output signals from these sensors are input to a controller 506. A servo valve 508 controlled by the controller 506 is coupled to the pneumatic actuator 502a via a pipe 507. The servo valve 508 adjusts the flow rate of the compressed air supplied to and exhausted from the pneumatic actuator 502a, thereby controlling the internal pressure of the actuator 502a and driving the pneumatic actuator.

The disturbance to be eliminated in the vibration isolator is roughly classified into ground motion disturbance caused by vibration of the installed floor and linear motion disturbance input from above the vibration isolator.

Regarding sources of the vibration that serves as the ground motion disturbance, the vibration caused by the movement of a person, called walking vibration, has a frequency of 1 to 3 Hz, the vibration caused by a motor such as an air conditioner has a frequency of 6 to 35 Hz, and the resonance point of the floor and the wall has a frequency of about 10 to 100 Hz. The super high-rise seismically isolated building has a natural frequency at or near 0.2 to 0.3 Hz. A slight vibration of 0.1 to 1.0 Hz is also generated at the building due to the wind-induced vibration. Therefore, the vibration isolator is required not only to reduce high-frequency vibration but also to eliminate low-frequency vibration.

When a positioning stage 509 as a source of the high-frequency vibration due to the linear motion disturbance is mounted on, for example, the vibration isolator, the structure including the vibration isolator is hit by the acceleration/deceleration operation of the stage and swung by the drive reaction force. The performance of the stage cannot be maintained unless vibration due to the hitting and the shaking due to the drive reaction force are reduced. In summary, the vibration isolator is required to have both functions: “vibration isolation” in which a vibration due to ground motion disturbance is eliminated; and “vibration damping” in which a vibration due to linear motion disturbance is suppressed.

### 3. Role of Vibration Sensor in Active Vibration Isolator

In the active vibration control, a control method by state feedback is adopted. This is a method of controlling the control device on the basis of acceleration/speed/displacement information from vibration sensors disposed at a plurality of positions of the structure to be subjected to vibration control. In order to obtain vibration isolation performance in a wide frequency region, for example, the acceleration signal is mainly used to control a state quantity of 10 Hz or more, the speed signal is used to control a state quantity of 1 to 10 Hz, and the displacement signal is used to control a state quantity of 1 Hz or less. For example,
a. by using a signal from an acceleration sensor disposed on or above the surface plate 501 to perform acceleration feedback, it is equivalent to an increase in a mass M, and effects such as reducing the natural frequency and lowering the resonance peak can be obtained;
b. by converting the signal from the above-described acceleration sensor into an absolute speed signal or an absolute displacement signal and performing feedback or feedforward, the vibration isolation performance can be significantly improved in a wide frequency region; and
c. by using a signal from an acceleration sensor disposed immediately below the surface plate 501 to convert the signal into an absolute speed signal or an absolute displacement signal, and similarly performing feedforward, vibration isolation performance can be improved in a wide frequency region.

In order to perform the control described in the above b. and c., information about speed and position with respect to the inertial space is necessary. Since the acceleration sensor can measure the acceleration with respect to the inertial space, the acceleration applied to a target to be controlled can be detected by attaching the acceleration sensor to the target to be controlled. Therefore, the conventional active vibration isolator adopts a method of obtaining a speed signal by integrating the output of the acceleration sensor once, and further, obtaining a displacement signal by integrating the output of the acceleration sensor twice.

### 4. Basic Configuration and Detection Principle of Acceleration Sensor

FIG. 65 is a model diagram illustrating a basic configuration and a detection principle of a capacitive acceleration sensor. Reference sign 301 denotes a main unit that houses each member of the sensor, reference sign 302 denotes a mass body, reference sign 303 denotes a spring that mechanically supports the mass body 302 with respect to a vibration measurement surface A, and reference sign 304 denotes a damper. The mass body 302 also serves as a movable-side electrode of the capacitive sensor. Reference sign 305 denotes a fixed-side electrode disposed on the opposing face side of the movable-side electrode (mass body 302), and reference sign 306 denotes a void portion between the two electrodes.

Reference sign 307 denotes an electromagnetic actuator that drives the mass body 302 in a direction perpendicular to the vibration measurement surface A. A capacitance C is determined by the size of the clearance of the void portion 306. Thus, the measurement of the capacitance C makes it possible to detect relative displacement U-X, which is the difference between ground motion absolute displacement U and absolute displacement X of the mass body. A servo circuit 310 (indicated by a two-dot chain line) includes a displacement detector 311 and a proportional amplifier 312. The relative displacement signal U-X detected by the displacement detector 311 flows therethrough and is amplified by the proportional amplifier 312 using a gain K_{P}.

Hereinafter, a detection principle of the acceleration sensor will be described using a mathematical expression. The following equation of motion holds, wherein m is a mass of the mass body 302, k is a spring constant of the mechanical spring 303 that supports the mass body, c is a damping coefficient of the damper 304, and the driving force of the actuator 307 is designated as F=A_{f} i₀.

$$\begin{matrix}[ Mathematical Expression 1 ] & \\ m \frac{{d}^{2} x}{{dt}^{2}} = c \frac{d}{dt} ( u - x ) + k ( u - x ) + {A}_{j} {i}_{0} & ( 1 )\end{matrix}$$

A current i₀ of the actuator is controlled by the amplifier having the proportional gain constant K_{P} so that the relative displacement U-X reaches and remains zero.

$$\begin{matrix}[ Mathematical Expression 2 ] & \\ {A}_{j} {i}_{0} = {K}_{P} ( u - x ) & ( 2 )\end{matrix}$$

$$\begin{matrix}[ Mathematical Expression 3 ] & \\ m \frac{{d}^{2} x}{{dt}^{2}} = c \frac{d}{dt} ( u - x ) + k ( u - x ) + {K}_{P} ( u - x ) & ( 3 )\end{matrix}$$

Assuming that the proportional gain constant K_{P} is sufficiently large and the first term and the second term are negligible compared to the third term on the right side of Expression (3), the following expression holds:

$$\begin{matrix}[ Mathematical Expression 4 ] & \\ \frac{{d}^{2} x}{{dt}^{2}} \approx \frac{{K}_{P}}{m} ( u - x ) & ( 4 )\end{matrix}$$

By detecting the current i₀ flowing through the actuator from Expressions (2) and (4), the acceleration of the mass body 302 can be approximately obtained.

### 5. Specific Structure of Conventional Servo-Type Acceleration Sensor

FIG. 66 is a front sectional view illustrating an example of the specific structure [Patent Literature (3)] of a conventional capacitive acceleration sensor, which is configured pursuant to the basic configuration and the detection principle illustrated in FIG. 65. Reference sign 11 denotes a permanent magnet, reference sign 12 denotes a pole piece portion, reference sign 13 denotes a pole piece protrusion, reference sign 14 denotes a permanent magnet-side yoke member, reference sign 15 denotes a coil-side yoke member, reference sign 16a denotes a force coil, reference sign 16b denotes a verification coil, reference sign 17 denotes a coil bobbin, and reference signs 18 and 19 denote coil bobbin support members made of a non-magnetic and non-conductive material. Reference sign 20 denotes a front disc-shaped spring, reference sign 21 denotes a rear disc-shaped spring, reference sign 22 denotes a front coupling member for coupling the front disc-shaped spring 20 and the coil-side yoke member 15, and reference sign 23 denotes a rear coupling member for coupling the rear disc-shaped spring 21 and the coil-side yoke member 15.

Reference sign 24 denotes a movable-side electrode, reference sign 25 denotes a fixed-side electrode, reference sign 26 denotes a front panel, reference sign 27 denotes a central plate, and reference sign 28 denotes a fastening member for fastening the fixed-side electrode 25 and the front panel 26.

A magnetic void portion 29 is formed in the radial direction between the outer peripheral portion of the pole piece portion 12 and the inner peripheral portion of the coil-side yoke member 15. Reference sign 29a denotes a permanent magnet-side void portion, and reference sign 29b denotes a yoke member-side void portion. A closed-loop magnetic circuit is formed by “the permanent magnet 11→the pole piece portion 12→the magnetic void portion 29→the coil-side yoke member 15→the permanent magnet-side yoke member 14”. When a current flows through the force coil 16a disposed in the space of the magnetic void portion 29, a Lorentz force that moves the movable-side electrode 24 in the axial direction is generated. Reference sign 30 denotes a void portion formed by the movable-side electrode 24 and the fixed-side electrode 25. The capacitance C is determined by the size of the clearance of the void portion 30. Thus, the measurement of the capacitance C makes it possible to detect the relative displacement U-X, which is the difference between the ground motion absolute displacement U and the absolute displacement X of the mass body. The servo circuit includes a displacement detector 31, an amplifier 32, and a driver 33. The amplifier 32 and the driver 33 are displacement amplifiers that amplify the relative displacement signal U-X with the gain K_{P}. The current i₀ of the actuator is controlled by the amplifier having the proportional gain constant K_{P} so that the relative displacement U-X reaches and remains zero. As described above, the acceleration acting on the movable portion can be obtained by detecting the current i₀ flowing through the force coil 16a.

### CITATION LIST

### Patent Literature

Patent Literature 1: JP 2006-283966 A
Patent Literature 2: JP 2007-155038 A
Patent Literature 3: JP 2004-205284 A
Patent Literature 4: JP 2010-96509 A

### Non Patent Literature

Non Patent Literature 1: J, Gannon et al.: A Robust Low Noise MEMS Servo Accelerometer, Proceedings of the Emerging Technologies Conference, Sep. 10-12, 2001

### SUMMARY OF INVENTION

### Technical Problem

When the servo-type acceleration sensor is applied to the active vibration isolator, the following three conditions need to be satisfied at the same time:
(1) a sufficiently high resonance frequency and a small resonance peak value;
(2) improved responsiveness (reduced phase delay in frequency range below resonance point); and
(3) high sensor sensitivity.

The resonance frequency of a passive element equipment such as a pneumatic actuator to be controlled by the active vibration isolator is generally f₀=4 to 6 Hz. In order to control this passive element, the active vibration isolator needs to have a control range of 40 to 50 Hz. In order to obtain sufficient control performance in this control range, high responsiveness is required for control elements other than the pneumatic actuators to be controlled (acceleration sensor, servo valve). As an evaluation index based on a large number of empirical values, a phase delay (responsiveness) at f=100 Hz of the acceleration sensor ideally realizes Δθ≤10 deg.

In the above (1), the reason why the acceleration sensor is required to have a high resonance frequency f₀ is that the higher resonance frequency f₀ can provide a smaller phase delay in the frequency range at or below the resonance point, serving as the evaluation index of the above (2). Provided, however, that the resonance frequency of the servo-type acceleration sensor is determined by the following expression on the basis of a mass m of the movable portion and a servo rigidity K that gives a restoring force to the actuator.

$$\begin{matrix}[ Mathematical Expression 5 ] & \\ {f}_{0} = \frac{1}{2 π} \sqrt{\frac{K}{m}} & ( 5 )\end{matrix}$$

The servo rigidity K is proportional to the control gain. The magnitude of the control gain is constrained by a delay element such as an inductance of the coil, in addition to a second-order delay element due to the mass m and the rigidity K. Therefore, the resonance frequency of the servo-type acceleration sensor has been generally limited to f₀=350 to 500 Hz.

In the above (1), the resonance peak value at the resonance point is desirably made as smaller as possible when evaluation is performed on the assumption that the range of the resonance frequency f₀ of the acceleration sensor (f₀=350 to 500 Hz) cannot be greatly changed. This is because the smaller resonance peak value can provide a larger gain margin for determining the stability margin of the control system and allows a larger control gain for determining the servo rigidity to be reserved.

Larger damping can provide a smaller resonance peak value. However, when the damping increases, the responsiveness decreases, and the phase delay at f=100 Hz increases. Therefore, the above (1) and (2) are in a conflicting relationship (trade-off relationship). In the case of the capacitive servo-type acceleration sensor, the magnitude of the damping is determined by an inter-electrode gap for detecting a capacitance and an electrode area (outer diameter of the electrode).

$$\begin{matrix}[ Mathematical Expression 6 ] & \\ D = \frac{3 μ {A}^{2}}{8 π {d}^{3}} & ( 6 )\end{matrix}$$

In the above expression, A is an electrode area, D is a damping constant (damping coefficient), d is an inter-electrode gap, and μ is a viscosity coefficient of air. The damping constant D increases in proportion to the square of the electrode area A and in inverse proportion to the cube of the clearance d.

In the above (3), the most effective measure for obtaining high sensor sensitivity is to set the capacitance of the displacement detector to be large. As is well known, assuming that A is an area of two conductor plates installed in parallel, d is a gap, ε₀ is a dielectric constant, and εᵣ is a relative permittivity of air, the capacitance C is expressed by:

$$\begin{matrix}[ Mathematical Expression 7 ] & \\ C = \frac{{ε}_{0} {ε}_{r} A}{d} & ( 7 )\end{matrix}$$

That is, as the electrode area A is larger, or as the inter-electrode gap d is smaller, the capacitance C is larger, and the sensor sensitivity is improved. However, from Expression (6), this measure increases damping and reduces responsiveness. Therefore, the above (1) to (3) are in a conflicting relationship (trade-off relationship).

FIG. 67 indicates gain/phase characteristics of the conventional acceleration sensor with respect to the frequency in cases of inter-electrode gaps h₀=20, 30, and 40 μm. Specifications of the sensor is as follows: the resonance frequency f₀=350 Hz, an electrode outer diameter of Φ13 mm, and being made of a conventional sensor (excluding a damping coefficient) in Table 1 to be described later.
(1) When the inter-electrode gap h₀=40 μm, a resonance peak value is the highest as ΔP=7 dB, and the phase delay Δθ at f=100 Hz is the smallest as 10 deg or less.
(2) When the inter-electrode gap h₀=30 μm, the resonance peak value ΔP≈0 dB, and the phase delay at f=100 Hz is Δθ=14.2 deg. The ideal target specification Δθ≤10 deg is not satisfied, but this is the most balanced characteristics among the three cases regarding an inter-electrode gap.
(3) When the inter-electrode gap h₀=20 μm, the resonance peak value ΔP is the lowest as ΔP=−10 dB, and the phase delay Δθ at f=100 Hz is the largest as Δθ=40 deg. This is obviously a characteristic of excessive damping, and is not applicable to an active vibration isolator.

Therefore, from the results of (1) to (3), only h₀=30 μm is selectable for the inter-electrode gap in the above-described specification of the acceleration sensor. As a result, the sensor sensitivity determined by the size of the gap is constrained.

### Solution to Problem

As described above, in the case of the conventional servo-type acceleration sensor, the sensor needs to be configured within a narrow range that simultaneously satisfies the conditions required for the sensor, that is, the following three conflicting challenges: (1) reduction in resonance peak, (2) improvement of responsiveness (reduction in phase delay), and (3) improvement of sensor sensitivity. Therefore, there is a limit to performance improvement. The origin of the idea of the present invention is to find a measure to ravel out the trade-off relationship among these three challenges and independently solve them.

In the case of the capacitive servo-type acceleration sensor, from its structural characteristics, attention is paid to the fact that the damping effect, which dominates the above-described three characteristics, is a dynamic fluid pressure (squeeze pressure) generated at the void portion between the electrodes.

Under the circumstance described above, a servo-type vibration detector according to a first invention of the present application includes a housing as a fixed member, a movable member being provided to be movable in a predetermined direction with respect to the housing, an elastic member being configured to support the movable member, the movable member being disposed with a void portion being interposed between the housing and the movable member, a displacement detection unit being configured to detect displacement of the movable member in the predetermined direction, a drive unit being configured to be driven by a servo amplifier, the drive unit being configured to generate a generative force with which the movable member is returned to an origin position when a relative displacement of the movable member from the origin position is detected at the displacement detection unit, a movable-side electrode being provided at the movable member, and a fixed-side electrode being provided opposing the movable-side electrode, the fixed-side electrode being closer to the housing than the movable-side electrode is. The displacement detection unit is configured to detect a capacitance being formed at a void portion between the movable-side electrode and the fixed-side electrode, either a groove or a hole communicating with the atmosphere is formed at a relative movement surface between the movable-side electrode and the fixed-side electrode, and is configured to reduce a damping effect of a dynamic fluid pressure being generated at the void portion between the movable-side electrode and the fixed-side electrode, and the servo amplifier includes a damping unit based on an electrical circuit, and is configured to compensate for a reduction in the damping effect.

In other words, in an embodiment of the present invention, the mechanical damping effect due to squeeze pressure at the void portion between the electrodes is reduced by dividing the electrode into a plurality of pieces and setting the boundary portion of each electrode to atmospheric pressure or forming a plurality of through-holes each communicating with atmospheric pressure at the electrode surface. Also, this damping effect is replaced with an equivalent damping units based on an electrical circuit in the servo amplifier. As a result, appropriate sensor dynamic characteristics can be obtained without depending on the gap between the electrodes and the outer diameter of the electrode. That is, although the sensor sensitivity, determined by the gap between the electrodes and the outer diameter of the electrode, and the sensor dynamic characteristics have conventionally been in a trade-off relationship, the sensor sensitivity and the sensor dynamic characteristics can be independently set.

In the servo-type vibration detector according to a second invention of the present application, the groove includes a flow groove having a substantially concentric shape with respect to an axis of the fixed-side electrode or the movable-side electrode, and/or a flow groove having a substantially radial shape in a radial direction.

That is, in an embodiment of the present invention, the flow groove communicating with the atmosphere is formed concentrically with respect to the axis of the fixed-side electrode or the movable-side electrode or radially in the radial direction. By forming the groove to have a small width and a depth sufficiently greater than that of the inter-electrode gap, each groove can maintain atmospheric pressure regardless of the size of the inter-electrode gap. Since the proportion of the area of the groove to the total area of the electrodes can be made sufficiently small, a decrease in capacitance due to the formed groove can be made very small.

In the servo-type vibration detector according to a third invention of the present application, the damping unit based on the electrical circuit includes a differentiation circuit being configured to differentiate a signal of the relative displacement.

That is, in an embodiment of the present invention, a differentiation circuit that differentiates the signal of the relative displacement is provided in an electrical circuit that drives the drive unit by a servo amplifier.

The servo-type vibration detector according to a fourth invention of the present application further includes a proportional amplifier circuit being configured to proportionally amplify the signal of the relative displacement that is output from the displacement detection unit, in which the drive unit is configured to be driven by a sum signal of the proportional amplifier circuit and the differentiation circuit, and the sum signal is a sensor output signal indicating a detected vibration.

That is, as can be seen from an embodiment of the present invention, ideal sensor dynamic characteristics (gain/phase characteristics) beyond the common knowledge in the past can be obtained by using the sum signal of the proportional amplifier circuit and the differentiation circuit as the sensor output signal. As a result of the theoretical analysis, this unexpected effect is found to be brought by adding the phase-lead element into the transfer characteristics of the sensor output with respect to the input acceleration. The effect of the phase-lead element can significantly reduce the resonance peak value at the resonance point and the phase delay in a wide frequency range. The present invention can provide a sensor that can independently set the following three conditions (1) to (3), which have been conventionally in a conflicting relationship (trade-off relationship): (1) improvement in sensor sensitivity, (2) improvement in responsiveness (reduction in phase delay), and (3) reduction in resonance peak value.

In the servo-type vibration detector according to a fifth invention of the present application, two sets of the displacement detection units are provided, each of the two sets of the displacement detection units individually includes the movable-side electrode and the fixed-side electrode, and a gap of a void portion between the movable-side electrode and the fixed-side electrode of one of the two sets of the displacement detection units is configured to change in an opposite phase with respect to a gap of a void portion between the movable-side electrode and the fixed-side electrode of the other of the two sets of the displacement detection units.

That is, an embodiment of the present invention includes two sets of capacitive displacement detection units, and is configured as a differential sensor in which the gaps of the respective displacement detection units change in opposite phases. A microgroove and a through-hole for reducing the damping effect of the dynamic fluid pressure generated at the void portion are formed at the relative movement surface of the two sets of electrodes. The servo amplifier that processes the differential signal includes a damping unit based on an electrical circuit so as to compensate for the reduction in the damping effect. Since the mechanical damping of the void portions of the two sets of electrodes can be set to satisfy C_{M}≈0, the sensor sensitivity need not be sacrificed. For example, measures such as increasing the inter-electrode gap to reduce mechanical damping are unnecessary.

The differential type is subject to a constraint condition that the sum of the gaps between the two sets of electrodes is constant, i.e., δ_{L}+δ_{R}=constant. In the present invention, however, the size and accuracy of the inter-electrode gaps δ_{L} and δ_{R} do not affect the sensor dynamic characteristics. Since the necessary damping effect can be replaced with the electrical damping C_{E}, the above-described constraint condition of the differential type in which two sets of capacitive sensors are disposed is eliminated.

In the servo-type vibration detector according to a sixth invention of the present application, the movable-side electrode is provided at each of both end portions of the movable member in an axial direction, the fixed-side electrode is provided opposing each of the movable-side electrodes, and is closer to the housing than a corresponding one of the movable-side electrodes is, and a differential sensor is configured by detecting a difference between two capacitances formed between the movable-side electrodes and the respective fixed-side electrodes.

That is, an embodiment of the present invention includes an actuator structure in which the movable-side electrodes can be respectively mounted to both end portions of the movable member in the axial direction. Therefore, when the axis of the movable member is defined as the Z-axis and the Y-axis orthogonal to the Z-axis is set to the center portion of the movable member, the two sets of the movable-side electrodes and the fixed-side electrodes are disposed “mirror-symmetrically” with respect to the Y-axis. Furthermore, the two sets of electrodes, permanent magnets, coils, and the like can be disposed “axisymmetrically” with respect to the Z-axis, which is the axis of the movable member. The purpose of adopting the differential type is to obtain a differential output in which noise and a drift are canceled by commonly applying noise and a drift to the two sets of electrode outputs. In the present invention in which constituent elements are structurally disposed “mirror-symmetrically” and “axisymmetrically”, the disturbance noise and the drift input to the two sets of electrode outputs are exactly symmetric, so that the differential type can be more effectively utilized.

The servo-type vibration detector according to a seventh invention of the present application further includes a coil being fixed to the fixed member, and a permanent magnet being disposed to generate a magnetic flux flowing in the void portion between the housing and the movable member, in which the movable member includes the permanent magnet and a movable-side yoke member being configured to form a magnetic path between the movable-side yoke member and the permanent magnet, or consists of the movable-side yoke member, and a closed-loop magnetic circuit is formed by the movable member, the void portion between the housing and the movable member, the fixed member, and the permanent magnet, to constitute the drive unit using an electromagnetic force that moves the movable member in an axial direction.

That is, an embodiment of the present invention focuses on the fact that the drive unit using electromagnetic force includes elements of a movable member, a magnetic void portion, a fixed member as a yoke member, and a permanent magnet. As a result, the actuator includes a closed-loop magnetic circuit in which a coil is fixed. Therefore, the following processes and the like required for mass production of the conventional MC servo-type sensor are not necessary: (i) cutting and division of the disc-shaped spring, (ii) insulation of the signal line, and (iii) a complicated production method involving an extra-fine wire soldering process. Thus, productivity can be greatly improved. From the structural characteristics that the coil does not move,
(1) a support span L of the movable portion can be set large since both ends in the axial direction can have an open structure; and
(2) the torsional rigidity of the movable portion can be set large since division and cutting of the disc-shaped spring that supports the movable portion are unnecessary.

According to the above (1) and (2), the dynamic stability of the sensor movable portion can be achieved. Thus, for example, the sensor sensitivity can be easily improved by increasing the diameter of the movable-side electrode and increasing the capacitance.

In the servo-type vibration detector according to an eighth invention of the present application, the movable member includes one end fixed to the housing, and is configured to swing while being supported by the elastic member, the movable member includes front and back faces, and one of the front and back faces opposes a fixed-side opposing face, and a plurality of through-holes each communicating with atmospheric pressure or a plurality of divided electrode surfaces are formed at relative movement surfaces of the front and back faces and the fixed-side opposing face.

That is, in an embodiment of the present invention, the present invention is applied to a swing motion sensor in which a pendulum having one end fixed thereto swings in a narrow void. For example, a semi-arc shaped ring is provided at opposing faces of the electrodes formed on the front and back of the pendulum, and a microgroove communicating with the atmosphere is formed at the semi-arc shaped ring.

Even in the case of the swing motion type, the same effects as that of the linear motion type described above can be obtained. That is, the following effects can be obtained: (1) a dynamic characteristic improvement effect obtained by a combination of microgrooves and electrical damping, (2) noise/drift cancelling effect provided by a differential type, (3) productivity improvement due to relaxation of the requirement on the accuracy of a gap between both electrodes, and the like. It has been pointed out that the swing motion type is susceptible to thermal expansion of members due to the asymmetry of the sensor structure. However, by setting the mechanical damping to satisfy C_{M}≈0 by using the microgrooves formed at the relative movement surface between the electrodes, it is possible to avoid the impact of a minute change in the inter-electrode gaps due to thermal expansion on the sensor characteristics.

In the servo-type vibration detector according to a ninth invention of the present application, ζ_{M}+ζ_{E}≥0.2 holds, or ζ_{M}≤0.6 holds, where a mechanical damping ratio ζ_{M} and an electrical damping ratio ζ_{E} are defined as

$$\begin{matrix}{ζ}_{M} = \frac{{C}_{M}}{2 \sqrt{{mK}_{p}}} \\ {ζ}_{E} = \frac{{C}_{E}}{2 \sqrt{{mK}_{p}}}\end{matrix} \qquad [ Mathematical Expression 7 - 1 ]$$

where m is an inertial mass of the movable member, with a unit of kg, K_{P} is a proportional gain that is a sum of an electrical gain of the servo amplifier and a mechanical spring rigidity of the elastic member, with a unit of N/m, C_{M} is a mechanical damping coefficient with a unit of Ns/m, and C_{E} is an electrical damping coefficient of the servo amplifier.

That is, an embodiment of the present invention obtains the ranges of ζ_{E} and ζ_{M} satisfying the following (1) and (2) in the gain/phase characteristics of the servo-type acceleration sensor.
(1) A peak value at the resonance point is 15 dB or less.
(2) The phase delay Δθ at ω/ωₙ=0.2 is 10 deg or less.

Conditions of the mechanical damping ratio ζ_{M} and the electrical damping ratio ζ_{E} satisfying the above (1) are ζ_{M}≥0.2 and ζ_{E}≥0.2. That is, the peak value at the resonance point is determined only by the magnitude of damping, irrespective of electrical and mechanical factors.

The conditions of ζ_{M} and ζ_{E} satisfying the above (2) is ζ_{M}≤0.6. Even when the electrical damping ratio ζ_{E} is sufficiently large, ζ_{E} does not affect the condition of the above (2), and the phase delay is determined only by the mechanical damping ζ_{M}.

A tenth invention of the present application is an evaluation method for the servo-type vibration detector, and the evaluation method includes obtaining a damping coefficient from an actual measurement value of a peak value of a gain at a resonance point, and evaluating an effect of the damping unit provided in the electrical circuit of the servo amplifier from a characteristic of the damping coefficient with respect to a size of an inter-electrode gap.

In the servo-type vibration detector according to an eleventh invention of the present application, a plate-shaped member in which the groove or the hole is formed by using a surface processing technique is mounted to the relative movement surface between the movable-side electrode and the fixed-side electrode by using a bolt or an adhesive.

That is, in an embodiment of the present invention, the groove and/or the hole is (are) formed at a thin plate-shaped member by etching, and the plate-shaped member is mounted to the relative movement surface between the movable-side electrode and the fixed-side electrode by using a bolt, an adhesive, or the like. Application of the etching method makes it possible to simultaneously produce several tens of electrodes with a microgroove, which are joined to one metal plate having a large area. It suffices to cut a junction (bridge) between individual single plates in use. Therefore, excellent mass productivity can be ensured, and a significant cost reduction can be achieved, as well as variation in damping performance (damping coefficient C) can be made very small.

In the servo-type vibration detector according to a twelfth invention of the present application, a plurality of small-diameter holes each communicating with the atmosphere are open at the relative movement surface between the movable-side electrode and the fixed-side electrode, and the plurality of small-diameter holes are disposed substantially axisymmetrically.

That is, in an embodiment of the present invention, reduction in squeeze pressure is achieved by forming only a large number of through-holes instead of a continuous groove shape. The point of this embodiment of the present invention is that the effect of reducing squeeze pressure is adjusted not by the number of ring grooves or the like but by the number n of through-holes. The through-holes is disposed axisymmetric so that a moment load due to damping force is not applied to the electrodes. The damping effect (damping coefficient) decreases as the number n of the through-holes increases, and conversely, the damping effect (damping coefficient) increases as the number n decreases. By setting n in this way, the damping coefficient can be finely adjusted.

A servo-type vibration detector according to a thirteenth invention of the present application includes a housing as a fixed member, a movable member being provided to be movable in a predetermined direction with respect to the housing, an elastic member being configured to support the movable member, the movable member being disposed with a void portion being interposed between the housing and the movable member, a displacement detection unit being configured to detect displacement of the movable member in the predetermined direction, a drive unit being configured to be driven by a servo amplifier, the drive unit being configured to generate a generative force with which the movable member is returned to an origin position when a relative displacement of the movable member from the origin position is detected at the displacement detection unit, a movable-side electrode being provided at the movable member, and a fixed-side electrode being provided opposing the movable-side electrode, the fixed-side electrode being closer to the housing than the movable-side electrode is. The displacement detection unit is configured to detect a capacitance being formed at a void portion between the movable-side electrode and the fixed-side electrode, discontinuous-shaped grooves each communicating with the atmosphere is formed at a relative movement surface between the movable-side electrode and the fixed-side electrode, and is configured to reduce a damping effect of a dynamic fluid pressure generated at the void portion between the movable-side electrode and the fixed-side electrode, and the discontinuous-shaped grooves are each formed by passing through a plate-shaped member by using a surface processing technique.

That is, by through-etching, an embodiment of the present invention can simultaneously produce several tens of electrodes with a microgroove, which are joined to one metal plate having a large area. For example, in addition to the plurality of discontinuous ring-shaped grooves, a plurality of discontinuous radial grooves can be formed. The flow path connecting the “portion at which no groove is formed” and the “groove” may be sufficiently narrow. A requirement is that one plate is not divided by the formation of the grooves. Therefore, the viscous fluid resistance of the flow path between the grooves can be sufficiently reduced. For example, the discontinuous ring-shaped groove may be considered as a “pseudo circumferential groove” as compared with a circumferential groove formed by machining. In addition, since the pressure inside each groove is maintained at atmospheric pressure due to the through-hole communicating with the atmosphere, a sufficiently large effect of reducing the damping effect can be obtained.

In the servo-type vibration detector according to a fourteenth invention of the present application, the plate-shaped member having an outer diameter larger than an outer diameter of the movable-side electrode is attached to the fixed-side electrode at an outer peripheral portion of the plate-shaped member, and a hole communicating the discontinuous-shaped grooves and the atmosphere is formed at the fixed-side electrode or the movable-side electrode.

That is, in an embodiment of the present invention, the plate-shaped member (fixed-side electrode plate) is formed to have an outer diameter larger than that of the movable-side electrode. Therefore, the plate-shaped member is bonded and fixed to the fixed-side electrode base at the outer peripheral portion. A discontinuous groove is not formed at the outer peripheral portion, the bonding and fixation are not obstructed. Bolting can also be performed using the space of the outer peripheral portion.

In the servo-type vibration detector according to a fifteenth invention of the present application, an outer peripheral portion of the plate-shaped member is attached to the fixed-side electrode, and a portion at which the discontinuous-shaped grooves are formed is open to the atmosphere.

That is, in an embodiment of the present invention, each discontinuous groove (microgroove) formed at the fixed-side electrode plate is directly open to the atmosphere on the opposite side of the movable electrode-side. Therefore, the through-hole for connecting the groove and the atmosphere as described in the above embodiments is unnecessary. When the electrode includes a through-hole connecting the groove and the atmosphere, a groove width h_{G} needs to be set so that the viscous fluid resistance Rₘ allowing air to flow along the groove is sufficiently small.

The larger the groove width h_{G} is, or the larger the number of grooves is, the lower the effective area of the capacitance is. In the embodiment of the present invention in which each groove is open to the atmosphere at the back face, the viscous fluid resistance can be set to Rₘ=0. As a result, since each groove width h_{G} can be made sufficiently small, the impact of the capacitance due to the formation of the microgrooves can be sufficiently reduced.

In the servo-type vibration detector according to a sixteenth invention of the present application, the discontinuous-shaped groove are formed to satisfy f_{P}>fₙ, where m is a mass of the movable member of the servo-type vibration detector, K_{P} is a proportional gain of the servo amplifier, fₙ is a resonance frequency determined by the m and the K_{P}, and f_{P} is a primary resonance frequency when the outer peripheral portion of the plate-shaped member is fixed.

That is, an embodiment of the present invention provides a condition of a discontinuous groove shape that can avoid the impact on sensor dynamic characteristics (gain/phase characteristics). For example, it is assumed that discontinuous grooves are formed in a ring shape and a cross shape at the plate-shaped member. When the clearance between the two discontinuous grooves decreases, the rigidity of the plate-shaped member in the axial direction is reduced. Thus, the resonance frequency f_{P} of the plate-shaped member in which the outer peripheral portion is fixedly supported is reduced. Note that the smaller clearance between the discontinuous grooves further improves the effect of reducing squeeze pressure. The discontinuous groove does not affect the sensor dynamic characteristics when f_{P}>fₙ is satisfied, where fₙ is a resonance frequency determined by the mass m of the movable member and the proportional gain K_{P} of the servo amplifier.

A servo-type vibration detector according to a seventeenth invention of the present application includes a housing as a fixed member, a movable member being provided to be movable in a predetermined direction with respect to the housing, an elastic member being configured to support the movable member, the movable member being disposed with a void portion being interposed between the housing and the movable member, a displacement detection unit being configured to detect displacement of the movable member in the predetermined direction, a drive unit being configured to be driven by a servo amplifier, the drive unit being configured to generate a generative force with which the movable member is returned to an origin position when a relative displacement of the movable member from the origin position is detected at the displacement detection unit, a movable-side electrode being provided at the movable member, and a fixed-side electrode being provided opposing the movable-side electrode, the fixed-side electrode being closer to the housing than the movable-side electrode is. The displacement detection unit is configured to detect a capacitance being formed at a void portion between the movable-side electrode and the fixed-side electrode, a groove communicating with the atmosphere is formed at a relative movement surface between the movable-side electrode and the fixed-side electrode, and is configured to reduce a damping effect of a dynamic fluid pressure being generated at the void portion between the movable-side electrode and the fixed-side electrode, and the groove is formed in a substantially symmetric shape by half etching at a front and a back of a plate-shaped member, one face of the plate-shaped member is mounted to an electrode surface by using a bolt or an adhesive, and a hole communicating with the atmosphere is formed at the other electrode surface opposing the plate-shaped member.

That is, in an embodiment of the present invention, microgrooves are formed at the front and back of the plate-shaped member by microgrooving using double-sided half etching. Effects thereof are as follows:
(1) It is possible to form optimum microgrooves that can reduce the damping effect of a large squeeze pressure.
(2) The warpage of the plate-shaped member can be eliminated by double-sided half etching.
(3) The plate-shaped member formed with the microgrooves is bonded and fixed to the movable-side electrode base. With this configuration, the adhesive flows into the flow groove, and the adhesive strength can be greatly increased.

A servo-type vibration detector according to an eighteenth invention of the present application includes a housing as a fixed member, a movable member being provided to be movable in a predetermined direction with respect to the housing, an elastic member being configured to support the movable member, the movable member being disposed with a void portion being interposed between the housing and the movable member, a displacement detection unit being configured to detect displacement of the movable member in the predetermined direction, a drive unit being configured to be driven by a servo amplifier, the drive unit being configured to generate a generative force with which the movable member is returned to an origin position when a relative displacement of the movable member from the origin position is detected at the displacement detection unit, a movable-side electrode being provided at the movable member, and a fixed-side electrode being provided opposing the movable-side electrode, the fixed-side electrode being closer to the housing than the movable-side electrode is. The displacement detection unit is configured to detect a capacitance being formed at a void portion between the movable-side electrode and the fixed-side electrode, and any one of relative movement surfaces of the movable-side electrode and the fixed-side electrode is made of a non-conductive material, a plurality of electrode surfaces are formed by division in a circumferential direction and are each fixed on or above a surface made of the non-conductive material, a flow groove having a substantially radial shape is formed at a boundary of the plurality of electrode surfaces, and the flow groove is configured to concurrently serve for a reduction in a damping effect of a dynamic fluid pressure being generated at the void portion between the movable-side electrode and the fixed-side electrode and as electrical insulation between the plurality of electrode surfaces, and the plurality electrode surfaces and an opposing electrode surface constitute a plurality of sets of independent capacitive displacement detectors.

That is, in an embodiment of the present invention, radial grooves for reducing squeeze pressure are formed at one of the two electrode surfaces by being divided in the circumferential direction. The radial grooves also serve as electrical insulation between the divided electrode surfaces. That is, according to the present invention, sensor dynamic characteristics (gain/phase characteristics) can be improved, and a multi-electrode servo-type vibration detector that detects a plurality of independent displacement/speed/acceleration signals.

An assembly method for the servo-type vibration detector according to a nineteenth invention of the present application discloses an assembly method for the servo-type vibration detector according to the eighteenth invention of the present application, and the assembly method includes measuring an inclination angle of the void portion between the movable-side electrode and the fixed-side electrode on a basis of signals of the plurality of sets of independent capacitive displacement detectors, and correcting an inclination on the basis of a measurement result.

That is, in an embodiment of the present invention, for example, the radial grooves are divided into four portions in the circumferential direction and formed axisymmetrically. In this case, the inclination angle of the void portion between the movable-side electrode and the fixed-side electrode can be measured from two displacement signals of the electrode surfaces separated by 180 degrees. The inclination of the fixed-side electrode with respect to the movable-side electrode can be corrected so that the inclination angle Δθ approaches zero as Δθ→0.

A servo-type vibration detector according to a twentieth invention of the present application includes a fixed member, a movable member being provided to be movable in a predetermined direction with respect to the fixed member, an elastic member being configured to support the movable member, the movable member being disposed with a void portion being interposed between the fixed member and the movable member, a displacement detection unit being configured to detect displacement of the movable member in the predetermined direction, a drive unit being configured to generate a force with which the movable member is returned to an origin position when a relative displacement of the movable member from the origin position is detected at the displacement detection unit. The displacement detection unit includes a movable-side electrode being provided at one end face of the movable member in an axial direction, a fixed-side electrode being provided opposing the movable-side electrode, and a fixed-side electrode support member being configured to support or being integrated with the fixed-side electrode. The displacement detection unit is configured to detect a capacitance being formed at a void portion between the movable-side electrode and the fixed-side electrode, and an opening to which a gap adjustment unit of the void portion between the movable-side electrode and the fixed-side electrode is applicable is formed at the fixed member or the fixed-side electrode support member, and both end portions of the movable member in the axial direction have open axes, or an end portion opposite to the movable-side electrode among the both end portions has an open axis.

That is, an embodiment of the present invention applies an actuator structure that can form both ends of the movable portion in the axial direction or the end portion of the movable member opposite to the movable-side electrode into an open structure. By combining this actuator structure and the gap adjustment unit using the opening, the inter-electrode gap can be adjusted with high accuracy without being limited to an optical means.

In the servo-type vibration detector according to a twenty-first invention of the present application, the movable member is configured to be firmly held from an outside or restricted from moving in the axial direction by using the open axes at the both end portions in the axial direction or the open axis at the end portion of the movable member that is opposite to the movable-side electrode.

That is, in an embodiment of the present invention, the movable member can be fixed without applying a moment of an external force to the movable member, by using the support method of pressing both left and right ends of the movable member from the outside on the same axis. Alternatively, the same effect can be obtained by firmly holding the movable member end portion opposite to the movable-side electrode in all axis (X-axis, Y-axis, Z-axis) directions.

Due to this effect, even when the movable-side electrode is inclined by a minute amount, the unit of adjusting the gap between the electrodes using a shim, a spacer, or the like can be applied while maintaining the inclined state.

In the servo-type vibration detector according to a twenty-second invention of the present application, the gap adjustment unit is a gap adjustment member including a shim or a spacer, and the opening being configured to receive insertion of the gap adjustment member into the void portion between the movable-side electrode and the fixed-side electrode is formed.

That is, in an embodiment of the present invention, the opening divided into at least three portions in the circumferential direction is formed by the gap adjustment member such as the shim and the spacer inserted through the opening so that the inter-electrode gap can be uniformly adjusted in the circumferential direction. Alternatively, a shim having a large width close to the electrode diameter is used, and the opening is formed in a shape that allows the insertion of a shim having a void portion equal to or larger than the outer diameter of the support rod at the center portion.

In the servo-type vibration detector according to a twenty-third invention of the present application, a through-hole being configured to receive insertion of a small-diameter member from the outside is formed at a center portion of the fixed-side electrode.

That is, in the sensor structure according to an embodiment of the present invention, a through-hole is formed at the center portion of the fixed-side electrode so that a support rod that presses the movable member can be inserted. Therefore, the movable member can be fixed from both left and right ends. Since the through-hole can have a small diameter, the through-hole does not greatly affect the capacitance determined by the total area.

A servo-type vibration detector according to a twenty-fourth invention of the present application includes a fixed member, a movable member being provided to be movable in a predetermined direction with respect to the fixed member, an elastic support member being configured to support the movable member, the movable member being disposed with a void portion being interposed between the fixed member and the movable member, a displacement detection unit being configured to detect displacement of the movable member in the predetermined direction, a drive unit being configured to be driven by a servo amplifier, the drive unit being configured to generate a generative force with which the movable member is returned to an origin position when a relative displacement of the movable member from the origin position is detected at the displacement detection unit, a movable-side electrode being provided at the movable member, and a fixed-side electrode being provided opposing the movable-side electrode, the fixed-side electrode being closer to the fixed member than the movable-side electrode is. The displacement detection unit is configured to detect a capacitance being formed at a void portion between the movable-side electrode and the fixed-side electrode. The movable member includes a permanent magnet being magnetized in an axial direction, and a pole piece including a front pole piece portion and a rear pole piece portion, both of which are disposed sandwiching the permanent magnet in the axial direction, and through both of which a magnetic flux flows. The servo-type vibration detector further includes a front coil being fixed to the fixed member in a void portion between an outer peripheral side of the front pole piece portion and an inner peripheral side of the fixed member, and a rear coil being fixed to the fixed member in a void portion between an outer peripheral side of the rear pole piece portion and an inner peripheral side of the fixed member. The drive unit is configured to generate an electromagnetic force with which the movable member is moved in the axial direction by forming a closed-loop magnetic circuit by the permanent magnet, the front pole piece portion, the fixed member, the rear pole piece portion, and the permanent magnet.

That is, in an embodiment of the present invention, the drive unit (actuator) of the MM acceleration sensor is configured by mounting the pole piece portions on the front side and the rear side with the permanent magnet magnetized in the axial direction being sandwiched therebetween, and disposing the coil on the fixed side opposing each of the pole piece portions.

When evaluation is performed in a performance aspect, for example, for the generative force of the actuator, two MC coil bobbins can be installed on the outer peripheral portion of the pole piece portion, where the outer diameter can be set large, and thus the large coil housing volume can be reserved. Therefore, a large number of coil turns can be set without increasing electrical resistance accompanied by heat generation while a coil having a large wire diameter is used. The generative force is proportional to the number of coil turns. Thus, the embodiment of the present invention eliminates the disadvantage of the MM type requiring the generative force enough to compensate for the amount of increase in the inertial mass.

When evaluation is performed from the viewpoint of productivity, the structure of the movable portion using the permanent magnet magnetized in the axial direction is easy to be assembled in mass production as compared with the structure using the magnet magnetized in the radial direction. In addition, since the outer diameter of the pole piece portion can be increased, a disc (the elastic support member) that supports the movable portion at both ends can be stably installed. Therefore, the perpendicularity between the disc surface and the movable electrode surface with respect to the axis of the sensor main body can be obtained with high accuracy.

In the servo-type vibration detector according to a twenty-fifth invention of the present application, when an axis of the movable member is defined as a Z-axis, and an X-axis orthogonal to the Z-axis is set at a center portion of the permanent magnet in the axial direction, the front pole piece portion and the rear pole piece portion, the front coil and the rear coil, and a front side and a rear side of the fixed member are respectively substantially axisymmetric with respect to the Z-axis, and are respectively substantially mirror-symmetric with respect to the X-axis.

That is, in an embodiment of the present invention, the permanent magnet is installed at the center portion, and the actuator unit is configured to be “axisymmetric and mirror-symmetric”. Outer diameters and lengths in the axial direction of the front pole piece portion and the rear pole piece portion are also configured symmetrically. Similarly, the coils and the fixed member on the front side and the rear side are configured symmetrically. When evaluation is performed in a quality aspect, for example, for the impact of thermal expansion on thermal deformation of members, an axisymmetric and mirror-symmetric structure of a coil as a heat source is extremely effective for countermeasures against thermal expansion. In the case of the swing type, which is a conventional sensor, the swing type sensor has a pendulum structure having one end as a fixed end and has a non-mirror-symmetric structure. Thus, the impact of deformation of each member due to thermal expansion on sensor characteristics cannot be avoided.

In the servo-type vibration detector according to a twenty-sixth invention of the present application, respective winding directions of the front coil and the rear coil are set to ensure that directions of forces acting on the movable member by electromagnetic forces acting on the front coil and the rear coil are identical to each other.

That is, in an embodiment of the present invention, independent coils are disposed on the fixed side opposing the pole piece portions that are mounted both on the front side and the rear side with the permanent magnet interposed therebetween. A closed-loop magnetic circuit B_{M} is formed in the route of “permanent magnet→front pole piece portion→front magnetic void portion→coil-side yoke member→rear magnetic void portion→permanent magnet”. The front coil is disposed at the front magnetic void portion, and the rear coil is disposed at the rear magnetic void portion. Accordingly, the direction of the magnetic flux passing through each coil is opposite. When the winding direction (clockwise or counterclockwise) of each coil is set such that the forces acting on the movable member have the same direction by the electromagnetic force acting on each coil, the generative force is the sum total of the two electromagnetic forces.

In the servo-type vibration detector according to a twenty-seventh invention of the present application, the front pole piece portion and the rear pole piece portion each include a hollow member.

That is, in an embodiment of the present invention, the pole piece portion forming the magnetic path through which the magnetic flux flows is formed in a hollow shape having a sectional area in which the magnetic saturation phenomenon does not occur. The magnetic flux Φ flowing through the closed-loop magnetic circuit is constant, and the magnetic flux density B=Φ/S, where S is the sectional area of the magnetic path. By setting the inner diameter of the hollow portion so as to obtain the sectional area S in which the magnetic saturation phenomenon does not occur, the weight of the movable portion can be reduced while maintaining the same generative force.

In the servo-type vibration detector according to a twenty-eighth invention of the present application, the movable-side electrode is fixed to one or both of distal end portions of the front pole piece portion and the rear pole piece portion with a non-conductive material interposed between the movable-side electrode and the front pole piece portion and/or the rear pole piece portion, and the fixed-side electrode is disposed at an opposing face of the movable-side electrode.

That is, in an embodiment of the present invention, the movable-side electrode is fixed to an end portion of the pole piece portion with the non-conductive material interposed therebetween. By achieving complete electrical insulation from the pole piece portion through which the eddy current flows, a minute capacitance signal between the electrodes can be processed.

In the servo-type vibration detector according to a twenty-ninth invention of the present application, the elastic support member also serves as a conductive path being configured to transmit a capacitance signal of the movable-side electrode, and is fixed to the fixed member at an outer peripheral portion of the elastic support member, with a non-conductive material interposed between the elastic support member and the fixed member.

That is, in an embodiment of the present invention, the elastic support member (disc) that supports the movable member also serves as a conductive path that transmits a minute capacitance signal. An eddy current flows through the fixed member. Therefore, an outer peripheral portion of the elastic support member is fixed to the fixed member with the non-conductive material interposed therebetween.

In the servo-type vibration detector according to a thirtieth invention of the present application, the movable-side electrode includes a front movable-side electrode being fixed to a distal end portion of the front pole piece portion with a non-conductive material being interposed between the front movable-side electrode and the front pole piece portion, and a rear movable-side electrode being fixed to a distal end portion of the rear pole piece portion with a non-conductive material being interposed between the rear movable-side electrode and the rear pole piece portion. The fixed-side electrode includes a front fixed-side electrode being provided opposing the front movable-side electrode, the front fixed-side electrode being closer to the fixed member than the front movable-side electrode is, and a rear fixed-side electrode being provided opposing the rear movable-side electrode, the rear fixed-side electrode being closer to the fixed member than the rear movable-side electrode is. A differential sensor is configured by detecting a difference between two capacitances being formed between the front movable-side electrode and the front fixed-side electrode and between the rear movable-side electrode and the rear fixed-side electrode.

With this configuration, the elastic support member can achieve electrical conduction with the movable-side electrode. In addition, both the elastic support member and the movable-side electrode can achieve electrical insulation from the pole piece portion.

In the servo-type vibration detector according to a thirty-first invention of the present application, a plurality of grooves being configured to house lead wires of the front coil and the rear coil are formed at an inner peripheral surface of the fixed member, and positions of the plurality of grooves in a circumferential direction are axisymmetric.

### Advantageous Effects of Invention

As described above, in the servo-type vibration detector according to the present invention, the mechanical damping effect of squeeze pressure at the void portion between the electrodes can be reduced by dividing the electrode into a plurality of pieces and setting the boundary portion of each electrode to atmospheric pressure or by forming a plurality of through-holes each communicating with atmospheric pressure at the electrode surface. Also, this damping effect can be replaced with an equivalent damping unit based on an electrical circuit in the servo amplifier. As a result, appropriate sensor dynamic characteristics can be obtained without depending on the gap between the electrodes and the outer diameter of the electrode. That is, although the sensor sensitivity, determined by the gap between the electrodes and the outer diameter of the electrode, and the sensor dynamic characteristics have conventionally been in a trade-off relationship, the sensor sensitivity and the sensor dynamic characteristics can be independently set.

### BRIEF DESCRIPTION OF DRAWINGS

FIG. 1 is a model diagram illustrating a basic configuration and a detection principle of a capacitive acceleration sensor according to Embodiment 1 of the present invention.

FIG. 2 illustrates an example of a servo-type acceleration sensor according to Embodiment 1, in which FIG. 2(a) is a view taken along a line DD in FIG. 2(b) and viewed in a direction of arrows DD, and FIG. 2(b) is a front sectional view of a sensor main body.

FIG. 3 is a graph of an input waveform applied to an inter-electrode gap.

FIG. 4 is a graph of a squeeze pressure when a maximum load is generated with respect to a position of the electrode in the radial direction.

FIG. 5 is a graph of a sinusoidal response of a generated load applied to the electrode.

FIG. 6 is a graph indicating a relationship between a damping coefficient and the inter-electrode gap.

FIG. 7 is a control block diagram including a displacement detection unit and a control circuit unit of Embodiment 1.

FIG. 8 is a set of graphs indicating gain/phase characteristics of the sensor of the present invention and a conventional sensor at the inter-electrode gap h₀=30 μm.

FIG. 9 is a set of graphs comparing gain/phase characteristics at the inter-electrode gaps h₀ of 20 to 40 μm in the sensor of the present invention configured as in Case 2 in Table 1.

FIG. 10 is a set of graphs comparing gain/phase characteristics of the sensors of the present invention configured as in Cases 1 to 3 in Table 1.

FIG. 11 is a set of graphs of gain/phase characteristics when a frequency axis is made dimensionless and ζ_{E}=0.

FIG. 12 is a set of graphs of gain/phase characteristics when the frequency axis is made dimensionless and ζ_{M}=0.

FIG. 13 is a graph indicating phase characteristics limited to a range of 0.1<ω/ωₙ<0.4 in FIG. 11.

FIG. 14 is a graph indicating phase characteristics limited to a range of 0.1<ω/ωₙ<0.4 in FIG. 12.

FIG. 15a illustrates an example of a servo-type acceleration sensor according to Embodiment 2 of the present invention, and is a sectional view taken along a line DD in FIG. 15b and viewed in a direction of arrows DD.

FIG. 15b illustrates the example of the servo-type acceleration sensor according to Embodiment 2 of the present invention, and is a front sectional view of a sensor main body.

FIG. 15c illustrates the example of the servo-type acceleration sensor according to Embodiment 2 of the present invention, and is an external view of a front disc.

FIG. 15d illustrates the example of the servo-type acceleration sensor according to Embodiment 2 of the present invention, and is an external view of a rear permanent magnet.

FIG. 16 is a view illustrating only an electrode portion in a conventional reference sensor.

FIG. 17 is a view illustrating only an electrode portion in an MM sensor to which the present invention is applied.

FIG. 18 is a set of graphs indicating the obtained gain/phase characteristics of an MM sensor configured under the conditions of Table 2, and comparing the MM sensor with no flow groove (one-dot chain line) and that with the flow groove (solid line: the present invention).

FIG. 19 is a set of graphs indicating the obtained gain/phase characteristics of an MM sensor configured under the conditions of Table 3, and comparing the MM sensor with the flow groove (solid line: the present invention) and that with no flow groove (one-dot chain line).

FIG. 20 is a two-dimensional analysis model of an electrode surface on which microgrooves are formed.

FIG. 21 indicates a numerical analysis result of two-dimensional squeeze pressure distribution.

FIG. 22 is a graph of a speed waveform when the inter-electrode gap changes in a sinusoidal waveform.

FIG. 23 is a graph obtained by extracting a speed waveform in the range of time of 0.002<t<0.006 seconds in FIG. 22.

FIGS. 24(a) to 24(d) are views indicating squeeze pressure distributions changing depending on speed.

FIG. 25 illustrates an example of a differential servo-type acceleration sensor according to Embodiment 3 of the present invention, in which FIG. 25(a) is a view taken along a line DD in FIG. 25(b) and viewed in a direction of arrows DD, and FIG. 25(b) is a front sectional view.

FIG. 26 is a view illustrating that the MM sensor can be changed to a differential type by replacing a left or right fixed-side electrode unit with a fixed-side electrode unit having the microgrooves and by mounting the fixed-side electrode unit having the microgrooves on the remaining side, in which FIG. 26(a) is a view illustrating a front fixed-side electrode unit, FIG. 26(b) is a front sectional view of a non-differential MM sensor with no microgrooves, and FIG. 26(c) is a view illustrating a rear fixed-side electrode unit.

FIG. 27 is a front sectional view of a swing motion acceleration sensor according to Embodiment 4 of the present invention.

FIG. 28 is a view taken along a line AA in FIG. 27 and viewed in a direction of arrows AA, and illustrating a specific shape of a microgroove.

FIG. 29 is a view illustrating a semi-arc shaped ring formed with the microgrooves, in which FIG. 29(a) is a top view, and FIG. 29(b) is a sectional view taken along a line BB in FIG. 29(a).

FIG. 30 is a view indicating a relationship between an electrode output, noise and a drift, and a sensor acceleration output of a conventional acceleration sensor.

FIG. 31 is a view indicating a relationship between two electrode outputs, the noise and the drift, and the sensor acceleration output of the differential acceleration sensor according to Embodiment 3.

FIG. 32 illustrates an example of a servo-type acceleration sensor according to Embodiment 2-1 of the present invention, in which FIG. 32(a) is a view taken along a line AA in FIG. 32(b) and viewed in a direction of arrows AA, and FIG. 32(b) is a front sectional view of a sensor main body.

FIG. 33 is a view illustrating a shape of a single fixed-side electrode plate in Embodiment 2-1.

FIG. 34 illustrates the fixed-side electrode plate being bolted in Embodiment 2-1, in which FIG. 34(a) is a sectional view taken along a line BB in FIG. 34(b) and viewed in a direction of arrows BB, and FIG. 34(b) is a front sectional view illustrating only an electrode portion.

FIG. 35 illustrates an example of a servo-type acceleration sensor according to Embodiment 2-2 of the present invention, in which FIG. 35(a) is a view taken along a line CC in FIG. 35(b) and viewed in a direction of arrows CC, and FIG. 35(b) is a front sectional view illustrating only an electrode portion.

FIG. 36 illustrates an example of a servo-type acceleration sensor according to Embodiment 2-3 of the present invention, in which FIG. 36(a) is a view taken along a line AA in FIG. 36(c) and viewed in a direction of arrows AA, FIG. 36(b) is a view taken along a line BB in FIG. 36(c) and viewed in a direction of arrows BB, and FIG. 36(c) is a front sectional view of a sensor main body illustrating only an electrode portion.

FIG. 37 illustrates a shape of a single plate in Embodiment 2-3, in which FIG. 37(a) is a front view of the plate, FIG. 37(b) is a side view thereof, and FIG. 37(c) is a view illustrating a back face of FIG. 37(a).

FIG. 38 illustrates a case in which microgrooves are formed at a movable-side electrode plate by one-side half etching and with through-holes, in which FIG. 38(a) is a front view of the movable-side electrode plate, FIG. 38(b) is a side view thereof, and FIG. 38(c) is a back-side view thereof.

FIG. 39 illustrates an example of a servo-type acceleration sensor according to Embodiment 2-4 of the present invention, in which FIG. 39(a) is a view taken along a line AA in FIG. 39(b) and viewed in a direction of arrows AA, and FIG. 39(b) is a front sectional view of an acceleration sensor.

FIG. 40 illustrates an example of a servo-type acceleration sensor according to Embodiment 2-5 of the present invention, in which FIG. 40(a) is a front view of a sensor main body, and FIG. 40(b) is a front sectional view.

FIG. 41 is a view illustrating a state in which a fixed-side electrode plate is mounted to a fixed-side electrode base, in which FIG. 41(a) is a side sectional view, and FIG. 41(b) is a front view.

FIG. 42 is a view illustrating “mass-production processing by etching” in Step 1.

FIG. 43 is a view illustrating a state in which “one electrode is cut out” in Step 2.

FIG. 44 is a view illustrating a state in which “the electrode is attached to a ceramic plate” in Step 3.

FIG. 45 is a view illustrating a state in which “unnecessary portions are cut and removed” in Step 4.

FIG. 46 is a model view illustrating a method for measuring a gap between electrodes and an inclination angle in the sensor according to the present invention in which multiple electrodes are incorporated in Embodiment 2-5.

FIG. 47a illustrates an example of an MM servo-type acceleration sensor according to Embodiment 3-1 of the present invention, and is a side view of FIG. 47b.

FIG. 47b illustrates the example of the MM servo-type acceleration sensor according to Embodiment 3-1 of the present invention, and is a sectional view taken along a line AA in FIG. 47a and viewed in a direction of arrows AA.

FIG. 47c illustrates the example of the MM servo-type acceleration sensor according to Embodiment 3-1 of the present invention, and is a sectional view taken along a line BB in FIG. 47b.

FIG. 47d illustrates the example of the MM servo-type acceleration sensor according to Embodiment 3-1 of the present invention, and is a side view of a rear disc.

FIG. 48 is a view illustrating that adjustment of an inter-electrode gap is limited to optical means in a conventional MC type.

FIG. 49 is a view illustrating that both ends of a movable portion can be held for adjustment of an inter-electrode gap in the MM type of the present invention.

FIG. 50 is a front sectional view of an MM servo-type acceleration sensor according to Embodiment 3-2 of the present invention.

FIG. 51 is a view illustrating setting of an inter-electrode gap by a shim in Step 1 of a gap adjustment process.

FIG. 52 is a view illustrating fixing of a fixing ring by radial-direction fastening bolts in Step 2 of the gap adjustment process.

FIG. 53 is a view illustrating release of the shim or the like from a sensor main body in Step 3 of the gap adjustment process.

FIG. 54 is a view illustrating a state in which this product is disassembled.

FIG. 55a illustrates a partially modified Embodiment 3-2 of the present invention, and is a front sectional view of a movable-side electrode and the vicinity thereof.

FIG. 55b illustrates the partially modified Embodiment 3-2 of the present invention, and is an exploded view.

FIG. 56 is a front sectional view of a servo-type acceleration sensor according to Embodiment 4-1 of the present invention.

FIG. 57 is an external view illustrating a rear disc having a spiral pattern and a support member.

FIG. 58 is an exploded view illustrating a configuration of parts of the sensor of the present embodiment.

FIG. 59 is a model view of an actuator unit of the MM sensor.

FIG. 60 indicates a numerical analysis result of the MM sensor.

FIG. 61 is a model view of an actuator unit of the conventional MC sensor.

FIG. 62 indicates a numerical analysis result of the conventional MC sensor.

FIG. 63 illustrates a differential servo-type acceleration sensor according to Embodiment 4-2 of the present invention, in which FIG. 63(a) is a front sectional view, and FIG. 63(b) is a view taken along a line AA in FIG. 63(a) and viewed in a direction of arrows AA.

FIG. 64 is a model diagram of a conventional active vibration isolator.

FIG. 65 is a model diagram illustrating a basic configuration and a detection principle of a conventional capacitive acceleration sensor.

FIG. 66 is a front sectional view illustrating an example of the specific structure of a conventional linear motion acceleration sensor.

FIG. 67 is a set of graphs indicating gain/phase characteristics of the conventional acceleration sensor with respect to a frequency at inter-electrode gaps h₀=20, 30, and 40 μm.

FIG. 68 is a front sectional view illustrating an example of a conventional swing motion acceleration sensor.

### DESCRIPTION OF EMBODIMENTS

### First Invention Group Included in Present Specification

### Embodiment 1

### [1] Model Diagram of Present Embodiment

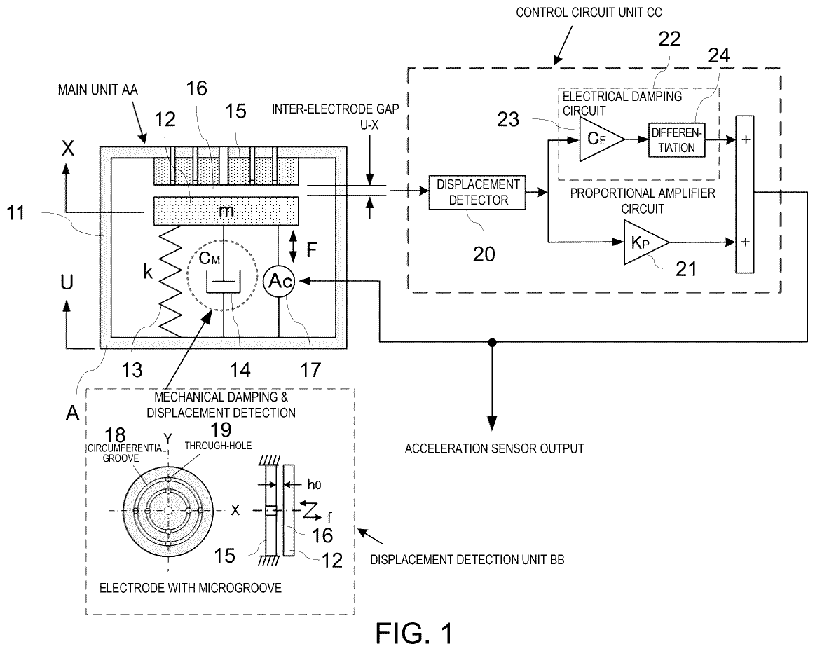

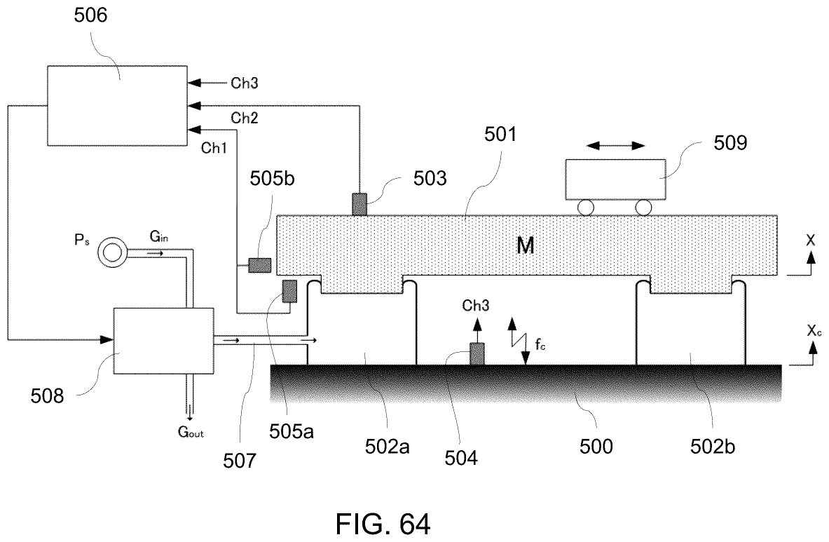

FIG. 1 is a model diagram illustrating a basic configuration and a detection principle of a capacitive acceleration sensor according to Embodiment 1 of the present invention. Reference sign AA denotes a sensor main unit, and a chain line BB section illustrates a displacement detection unit that detects capacitance and also serves as a damper. A chain line CC section illustrates a control circuit unit in which a servo amplifier that drives an actuator is built. Hereinafter, a description will be given in comparison with FIG. 64, which is a conventional model diagram.

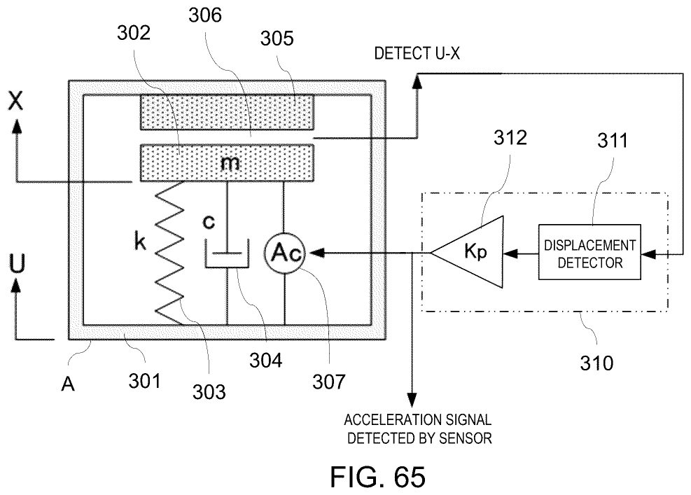

In the sensor main unit AA, reference sign 11 denotes a main unit that houses each member of the sensor, reference sign 12 denotes a mass body, reference sign 13 denotes a spring that mechanically supports the mass body 12 with respect to a vibration measurement surface A, and reference sign 14 denotes a damper (mechanical damping coefficient C_{M}). The mass body 12 also serves as a movable-side electrode of the capacitive sensor. Reference sign 15 denotes a fixed-side electrode disposed on the opposing face side of the movable-side electrode (mass body 12), and reference sign 16 denotes a void portion between the two electrodes. Reference sign 17 denotes an electromagnetic actuator that drives the mass body 12 in a direction perpendicular to the vibration measurement surface A. A capacitance C is determined by the size of the clearance of the void portion 16. Thus, similarly to the conventional type (FIG. 65), measurement of the capacitance C makes it possible to detect a relative displacement U-X, which is the difference between ground motion absolute displacement U and absolute displacement X of the mass body.

In the displacement detection unit BB, when a clearance h₀ of the void portion 16 between the two electrodes changes, a dynamic pressure (squeeze pressure) due to the viscosity of air is generated. The damping effect of the squeeze fluid pressure functions as the damper 14 in the sensor main unit AA. In order to reduce the damping effect, a circumferential groove 18 (referred to as a flow groove or a microgroove) is formed at the electrode surface of the present embodiment. A through-hole 19 connecting the outside (atmospheric pressure) is formed at the circumferential groove. Since the groove depth of the circumferential groove 18 is sufficiently deeper than the clearance h₀ of the void portion 16, the inside of the circumferential groove (microgroove) 18 is under atmospheric pressure on the entire circumference.

The control circuit unit CC includes a displacement detector 20, a proportional amplifier 21, and an electrical damping circuit 22. The proportional amplifier 21 and the electrical damping circuit 22 are provided in parallel. The relative displacement signal U-X detected by the displacement detector 20 flows there through and is amplified by the proportional amplifier 21 using a proportional gain K_{P}. The electrical damping circuit 22 includes a derivative gain 23 (electrical damping coefficient C_{E}) and a pseudo-differential circuit 24. The electrical damping circuit is provided so as to compensate for a reduction in mechanical damping effect due to the circumferential groove 18 and the through-hole 19. When the electromagnetic actuator 17 is driven by the signal obtained by the parallel sum of the output signals of the proportional amplifier 21 and the electrical damping circuit 22 to detect a current flowing through the actuator, the acceleration of the mass body 12 can be approximately obtained.

As will be made clear from theoretical analysis to be described later, ideal characteristics can be obtained for the sensor dynamic characteristics (gain/phase characteristics) of the present embodiment. That is, the present embodiment can provide a sensor that can independently set the following three conditions (1) to (3), which have been conventionally in a conflicting relationship (trade-off relationship): (1) improvement in sensor sensitivity, (2) improvement in responsiveness (reduction in phase delay), and (3) reduction in resonance peak value.

### [2] Specific Structure of Present Embodiment (Hereinafter, MC Type or MC)

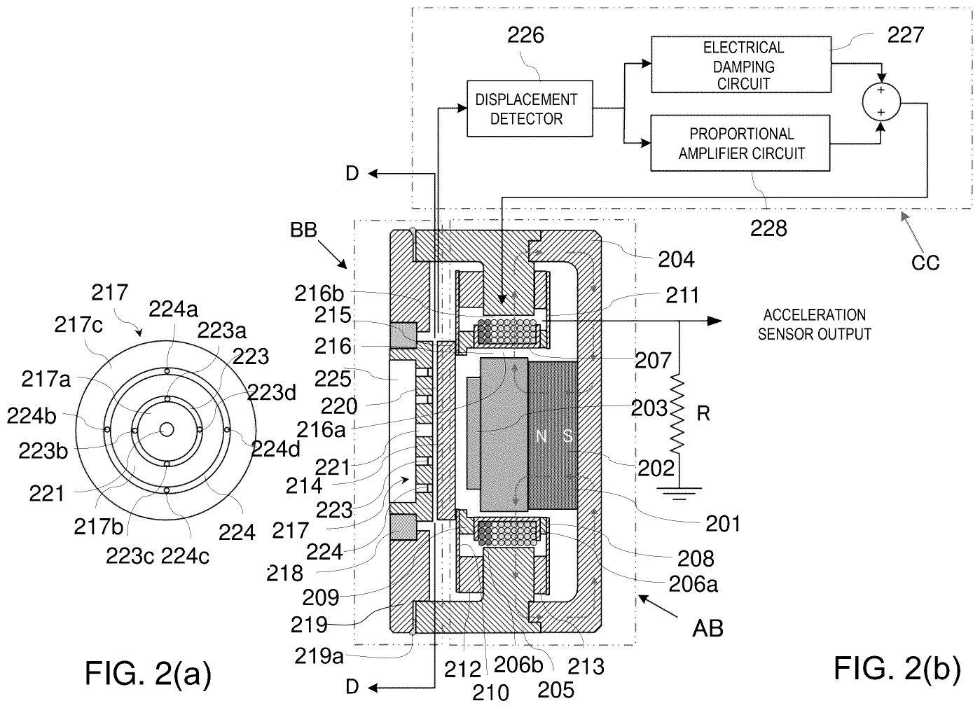

FIG. 2 illustrates an example of a servo-type acceleration sensor according to Embodiment 1 of the present invention, in which FIG. 2(a) is a view taken along a line DD in FIG. 2(b) and viewed in a direction of arrows DD, and FIG. 2(b) is a front sectional view of a sensor main body. A two-dot chain line AB section in FIG. 2(b) illustrates a moving-coil (MC) actuator unit that drives the movable portion in the axial direction. A two-dot chain line BB section illustrates a displacement detection unit that detects capacitance. A two-dot chain line CC section illustrates the outline of a control circuit unit in which a servo amplifier that drives an actuator is built. As described above, the MC actuator unit has a publicly known structure. Hereinafter, a specific structure of the present embodiment will be described separately for the actuator unit, the displacement detection unit, and the control circuit unit, similarly to the model diagram of FIG. 1.

### [2-1] Actuator Unit

In the actuator unit (two-dot chain line AB section) in FIG. 2(b), reference sign 201 denotes a permanent magnet, reference sign 202 denotes a pole piece portion, reference sign 203 denotes a pole piece protrusion, reference sign 204 denotes a permanent magnet-side yoke member, reference sign 205 denotes a coil-side yoke member, reference sign 206a denotes a force coil, reference sign 206b denotes a verification coil, reference sign 207 denotes a coil bobbin, and reference signs 208 and 209 denote coil bobbin support members made of a non-magnetic and non-conductive material. Reference sign 210 denotes a front disc-shaped spring, reference sign 211 denotes a rear disc-shaped spring, reference sign 212 denotes a front coupling member for coupling the front disc-shaped spring and the coil-side yoke member, reference sign 213 denotes a rear coupling member for coupling the rear disc-shaped spring and the coil-side yoke member, reference sign 214 denotes a movable-side electrode, and reference sign 215 denotes a junction of the movable-side electrode and the front disc-shaped spring 210.

A magnetic void portion 216 in the radial direction is formed between the outer peripheral portion of the pole piece portion 202 and the inner peripheral portion of the coil-side yoke member 205. Reference sign 216a denotes a permanent magnet-side void portion, and reference sign 216b denotes a yoke member-side void portion. A closed-loop magnetic circuit B_{M} is formed by “the permanent magnet 201→the pole piece portion 202→the magnetic void portion 216→the coil-side yoke member 205→the permanent magnet-side yoke member 204”. When a current flows through the force coil 206a disposed in the space of the magnetic void portion 216, a Lorentz force that moves the movable-side electrode 214 in the axial direction is generated.

### [2-2] Displacement Detection Unit

In the displacement detection unit (two-dot chain line BB section) in FIG. 2(b), reference sign 217 denotes a fixed-side electrode, reference sign 218 denotes an insulating ring, and reference sign 219 denotes a fixing ring. The fixed-side electrode 217 is held by the fixing ring with the insulating ring interposed therebetween. Reference sign 218 denotes a portion on which an adhesive is applied for fixing the fixing ring 219 to the coil-side yoke member 205. Reference sign 220 denotes a void portion between the fixed-side electrode and the movable-side electrode. In the assembly adjusting step, the position of the fixing ring 219 with respect to the coil-side yoke member 205 is adjusted so that a gap d of the void portion 220 reaches a target value.

A ring-shaped groove and a through-hole are formed at a face of the fixed-side electrode 217 opposing the movable-side electrode 214. Reference sign 221 denotes a center through-hole, reference sign 223 denotes a first ring-shaped groove, and reference sign 224 denotes a second ring-shaped groove. The first ring-shaped groove and the second ring-shaped groove are formed for reducing the dynamic pressure (squeeze pressure) of the air-viscous fluid generated between the electrodes.

Hereinafter, grooves formed at the electrode surface in order to reduce squeeze pressure (the first and second ring-shaped grooves) will be collectively referred to as microgrooves. Reference signs 223a, 223b, 223c, and 223d denote through-holes formed inside the first ring-shaped groove 223. Reference signs 224a, 224b, 224c, and 224d denote through-holes formed inside the second ring-shaped groove 224. Reference sign 225 denotes a recess open to the atmosphere.

The first and second ring-shaped grooves and the through-holes formed in the grooves and communicating with the atmosphere divide an electrode surface having a wide area into a plurality of independent electrode surfaces. An electrode surface between the center through-hole 221 and the first ring-shaped groove 223 is referred to as a first electrode 217a, an electrode surface between the first ring-shaped groove 223 and the second ring-shaped groove 224 is referred to as a second electrode 217b, and an electrode surface between the second ring-shaped groove 224 and the outer peripheral portion of the fixed-side electrode 217 is referred to as a third electrode 217c. The above-described the three independent electrode surfaces 217a, 217b, and 217c may be configured by, for example, a method of mounting three ring-shaped members on or above a flat plate. Note that in the sensor structure of the present embodiment, a method of forming them by lathing, etching, or the like is easy. For formation of the plurality of electrodes, it suffices to select the best method in accordance with the form of the sensor.

In the present embodiment, the groove widths of the first ring-shaped groove and the second ring-shaped groove are h_{G}=0.1 mm, and as described above, four through-holes communicating with the atmosphere are formed at each groove. The grooves are each formed to have a depth sufficiently greater than that of the assumed inter-electrode gap h₀ (10 to 50 μm), each groove can maintain atmospheric pressure regardless of the size of the inter-electrode gap h₀.

In the present embodiment, the center through-hole diameter ΦD₁ is 0.8 mm, and an electrode outer diameter ΦD₂ is 13 mm. An inner peripheral side of the first ring-shaped groove 223 is formed at a position of a radius r₁=2.1 mm, and an inner peripheral side of the second ring-shaped groove 224 is formed at a position of a radius r₂=4.5 mm. A total groove area of the first and second ring-shaped grooves 223 and 224 is Sₘ=6.15 mm², and an electrode area without the above-described two grooves is S_{T}=132 mm². Accordingly, the proportion of the area of the ring-shaped grooves 223 and 224 to the total electrode area is 4.66%. In summary, a decrease in capacitance due to the ring-shaped groove is about 5%. Therefore, when the electrode outer diameter is set to be slightly large, in this embodiment, set as ΦD₂=13 mm→13.2 mm, the decrease in capacitance can be compensated for.

### [2-3] Control Circuit Unit

The two-dot chain line CC section in FIG. 2(b) illustrates the outline of the control circuit unit. Reference sign 226 denotes a displacement detector, reference sign 227 denotes an electrical damping circuit, and reference sign 228 denotes a proportional amplifier circuit. A capacitance C is determined by the clearance of the void portion 220 formed by the movable-side electrode 214 and the fixed-side electrode 217. Thus, the measurement of the capacitance C makes it possible to detect the relative displacement, which is the difference between the ground motion absolute displacement U and the absolute displacement X of the mass body. The current i₀ of the actuator is controlled by flowing through the electrical damping circuit 227 and the proportional amplifier circuit 228 so that the relative displacement U-X remains zero. The acceleration acting on the movable portion can be obtained by detecting the current i₀ flowing through the force coil 206a.

### [3] Theoretical Analysis

The present embodiment finds an effect obtained by combining the following (1) and (2):
(1) To form a microgroove (flow groove) connecting the void portion and the outside at the relative movement surface of two electrodes so as to reduce a damping effect of the squeeze fluid pressure generated at the void portion of the displacement detection unit; and
(2) To provide a damping unit based on an electrical circuit into the servo amplifier so as to compensate for the reduction in the damping effect due to the microgroove.

In order to grasp the actions and effects of the above (1) and (2) specifically and quantitatively, theoretical analysis is performed as follows.

### [3-1] Viscous Fluid Analysis of Displacement Detection Unit

When a viscous fluid (air) is interposed in a narrow gap (inter-electrode gap) between planes disposed opposite to each other and the clearance of the gap sharply changes with time, a dynamic fluid pressure (squeeze pressure) due to viscosity of the air is generated. The impact of the squeeze pressure on the function as the capacitive acceleration sensor will be elucidated by solving the following Reynolds equation.

$$\begin{matrix}[ Mathematical Expression 8 ] & \\ \frac{1}{r} \frac{d}{dr} ( r \frac{{h}^{3}}{12 μ} \frac{dP}{dr} ) = \frac{dh}{dt} & ( 8 )\end{matrix}$$

P=Pressure (Pa)
μ=Viscosity (Pas)
h=Inter-electrode gap (m)
r=Position in radial direction (m)

### (1) Assumption of Sinusoidal Input Waveform

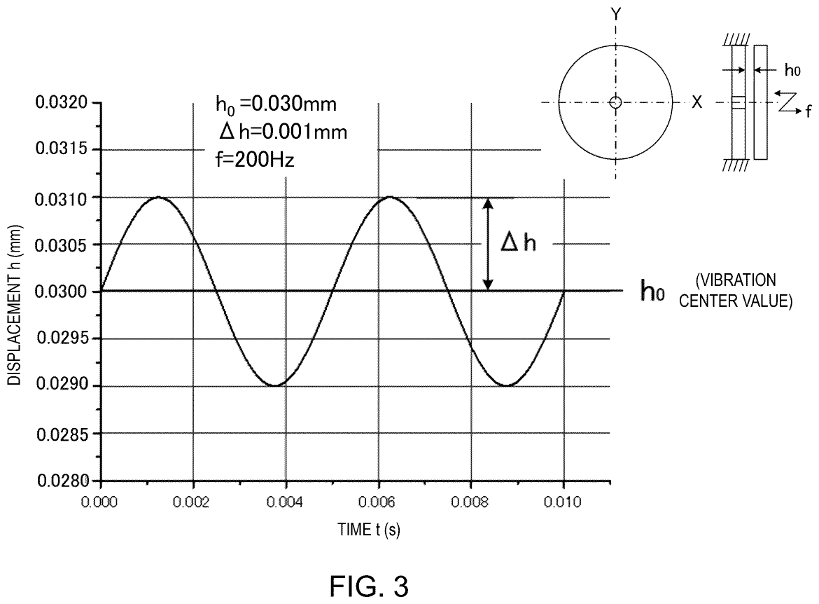

FIG. 3 indicates an input waveform applied to an inter-electrode gap. It is assumed that the inter-electrode gap vibrates in the form of a sine wave. Here, assume that a vibration center value h₀=0.030 mm, a vibration amplitude Δh=0.001 mm, and a frequency f=200 Hz.

$$\begin{matrix}[ Mathematical Expression 9 ] & \\ h = Δ h \cdot sin ( 2 π t ) + h , & ( 9 )\end{matrix}$$

### (2) Distribution of Squeeze Pressure in Radial Direction

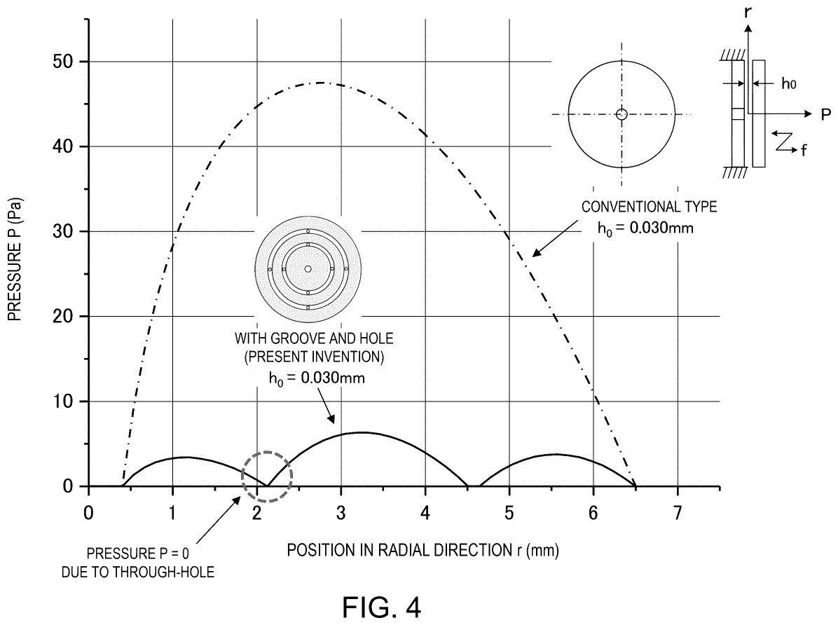

FIG. 4 indicates squeeze pressure when a maximum load is generated with respect to a position of the electrode in the radial direction. Comparison is made between the conventional type with no microgroove being formed and the present invention with a microgroove being formed. As a boundary condition of the numerical analysis, a pressure (gauge pressure) is atmospheric pressure P=0 at a position of a center through-hole outer peripheral portion: r=0.4 mm, and an electrode outer peripheral portion: r=6.5 mm. In the case of the conventional type, the squeeze pressure exhibits a maximum value Pₘₐₓ=47 Pa at the position of r=2.5 mm.

In the case of the present invention with a microgroove being formed, the pressure is atmospheric pressure P=0 at the portion where the first ring-shaped groove 223 is formed (radius r₁=2.1 mm) and the portion where the second ring-shaped groove 224 is formed (radius r₂=4.5 mm). As is apparent from a comparison between both cases, the generated pressure is significantly reduced due to the formation of the microgrooves.

### (3) Sinusoidal Response of Generated Load

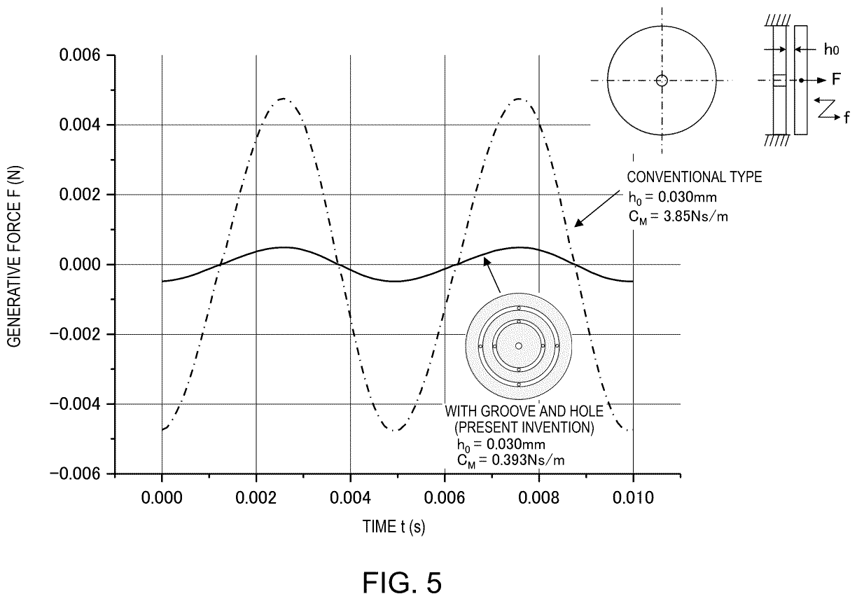

FIG. 5 indicates the obtained sinusoidal response of a generated load applied to the electrode. Comparison is made between the conventional type with no microgroove being formed and the present invention with a microgroove being formed. Due to the formation of the microgrooves, the maximum value of the generated load decreases to approximately 1/10.

### (4) Relationship Between Damping Coefficient and Inter-Electrode Gap

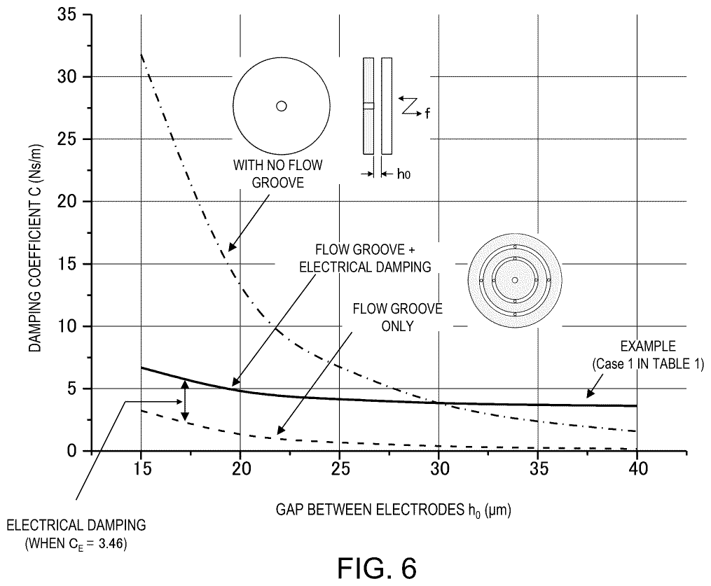

FIG. 6 indicates the obtained relationship between a damping coefficient and an inter-electrode gap. The graph provides comparison between the conventional type with no microgroove being formed (one-dot chain line) and the present invention with a microgroove being formed (chain line). Here, assume that the mechanical damping of the electrode with a microgroove being formed is C_{M}, and the electrical damping provided in the electrical circuit of the servo amplifier is C_{E}. Hybrid damping C_{T}=C_{M}+C_{E}, obtained by adding the electrical damping C_{E} to the mechanical damping C_{M} is indicated by a solid line.

The value of the electrical damping C_{E} is determined by an electrical circuit (to be described later) irrespective of the inter-electrode gap h₀. The hybrid damping C_{T} is set such that the mechanical damping C_{M}=0.393 Ns/m, the electrical damping C_{E}=3.46 Ns/m, and C_{T}=C_{M}+C_{E}=3.85 Ns/m hold at a vibration center value (inter-electrode gap) h₀=30 μm. The value of the above C_{T} at h₀=30 μm is identical to that of the conventional type (one-dot chain line). While the damping coefficient of the conventional type largely depends on the gap h₀, the hybrid damping C_{T} maintains a substantially constant value when h₀>20 μm.

### [3-2] Theoretical Analysis of Control Circuit

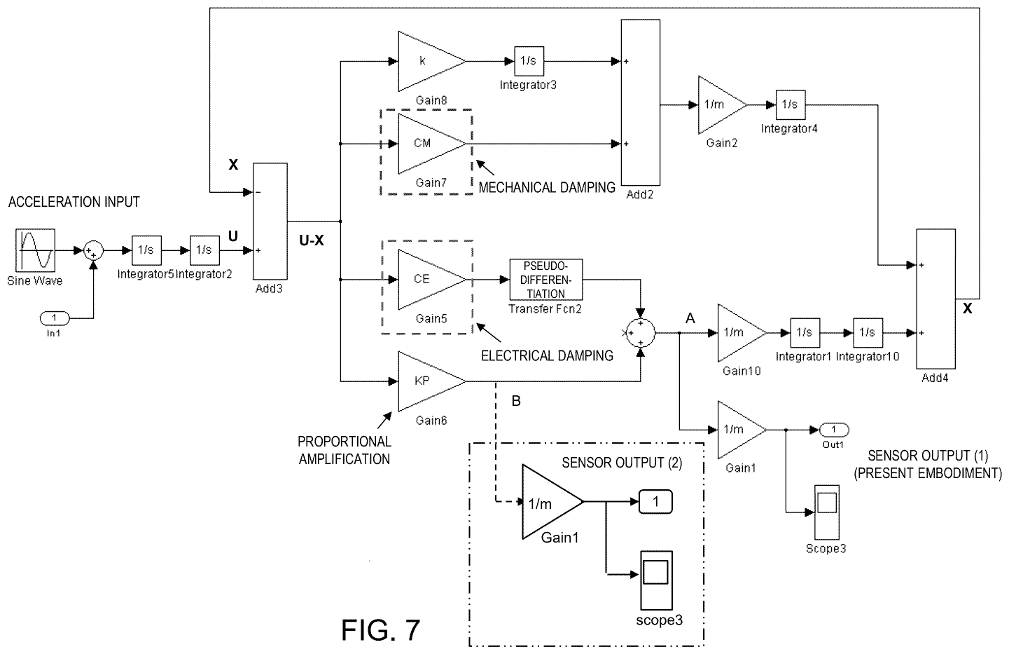

Analysis for obtaining the dynamic characteristics of the servo-type acceleration sensor will be performed using the result obtained from the viscous fluid analysis of the displacement detection unit. FIG. 7 is a control block diagram including the displacement detection unit and the control circuit unit of the present embodiment.

### (1) Equation of Motion of Movable Body

An equation of motion is as follows, where U(s) is a ground motion absolute displacement, X(s) is a displacement of the movable body (movable-side electrode of the sensor), U(s)-X(s) is a relative displacement, and F(s) is a driving force of the actuator.

$$\begin{matrix}[ Mathematical Expression 10 ] & \\ {ms}^{2} X = ( {C}_{M} s + k ) ( U - X ) + F ( s ) & ( 10 )\end{matrix}$$

In the above expression, Laplace operators s and s² are s=d/dt and s²=d²/dt². The driving force F(s) of the actuator is as follows:

$$\begin{matrix}[ Mathematical Expression 11 ] & \\ F ( s ) = [ {K}_{P} + {C}_{E} s ] ( u - X ) & ( 11 )\end{matrix}$$

In Expressions (10) and (11), k is a support spring rigidity, C_{M} is the mechanical damping coefficient determined by the groove shape formed at the electrode, K_{P} is the proportional gain, and C_{E} is the electrical damping coefficient.

### (2) Transfer Function of Movable Body Displacement Relative to Relative Displacement

A transfer function of the movable body displacement X(s) with respect to a relative displacement E(s) [=U(s)−X(s)] is as follows:

$$\begin{matrix}[ Mathematical Expression 12 ] & \\ \frac{X ( s )}{E ( s )} = \frac{( {C}_{M} + {C}_{E} ) s + k + {K}_{P}}{{ms}^{2}} & ( 12 )\end{matrix}$$

$$\begin{matrix}[ Mathematical Expression 13 ] & \\ E ( s ) = U - X = \frac{{ms}^{2} X}{k + {K}_{P} + ( {C}_{M} + {C}_{E} ) s} & ( 13 )\end{matrix}$$

$$\begin{matrix}[ Mathematical Expression 14 ] & \\ U = [ \frac{{ms}^{2} + ( {C}_{M} + {C}_{E} ) s + k + {K}_{P}}{k + {K}_{P} + ( {C}_{M} + {C}_{E} ) s} ] X & ( 14 )\end{matrix}$$

When the input acceleration to be detected is designated as A, with U=Λ/s²,

$$\begin{matrix}[ Mathematical Expression 15 ] & \\ X = \frac{( {C}_{M} + {C}_{E} ) s + k + {K}_{P}}{{ms}^{2} + ( {C}_{M} + {C}_{E} ) s + k + {K}_{P}} \frac{Λ}{{s}^{2}} & ( 15 )\end{matrix}$$

### (3) Proposal of Deriving Method for Sensor Output

Here, a method of extracting an acceleration sensor output signal from a sum of two signal outputs of a proportional amplifier circuit and an electrical damping circuit is proposed. That is, when a sensor output Z=“proportional amplifier circuit output+electrical damping circuit output”, a point A in the control block diagram of FIG. 7 is the extraction point of a sensor output (1). In this case, it is found that a dramatic improvement effect of the sensor dynamic characteristics can be obtained. The theoretical grounds are described below.

$$\begin{matrix}[ Mathematical Expression 16 ] & \\ Z ( s ) = [ ( U - X ) {C}_{E} s + ( U - X ) {K}_{P} ] / m = ( U - X ) ( {C}_{E} s + {K}_{P} ) / m & ( 16 )\end{matrix}$$

When U in Expression (14) and X in Expression (15) are substituted, the sensor signal output Z below having the sum of the mechanical damping C_{M} and the electrical damping C_{E} in the denominator and having only the electrical damping C_{E} in the numerator is obtained.

$$\begin{matrix}[ Mathematical Expression 17 ] & \\ Z ( s ) = \frac{( {C}_{E} s + {K}_{P} )}{{ms}^{2} + ( {C}_{M} + {C}_{E} ) s + k + {K}_{P}} Λ & ( 17 )\end{matrix}$$

As described above, the characteristics of the sensor of the present invention obtained by Expression (17) can be achieved by combining the following (1) and (2): (1) microgrooves are formed at the electrode surface, and (2) a “damping unit based on an electrical circuit” for compensating for the reduction in the damping effect according to the above (1) is provided. The denominator of the transfer characteristics includes a differential (C_{M}+C_{E}) s that delays the phase, and the numerator includes a differential CES that advances the phase.

### (4) Transfer Function of Conventional Sensor and Sensor of Present Invention (Ideal)

### (i) Sensor Output of Conventional Sensor

$$\begin{matrix}[ Mathematical Expression 18 ] & \\ Z ( s ) = \frac{{K}_{P}}{{ms}^{2} + {C}_{M} s + k + {K}_{P}} Λ & ( 18 )\end{matrix}$$

The above expression is well-known transfer characteristics of a second-order delay element, and is characteristics of a conventional sensor in which no microgroove is formed at the electrode and the electrical damping is set to C_{E}=0 in Expression (17).

### (ii) Sensor Output of Sensor of Present Invention (Ideal)

$$\begin{matrix}[ Mathematical Expression 19 ] & \\ Z ( s ) = \frac{( {C}_{E} s + {K}_{P} )}{{ms}^{2} + {C}_{E} s + k + {K}_{P}} Λ & ( 19 )\end{matrix}$$

The above expression is an ideal sensor output in which the microgrooves are formed at the electrodes to achieve C_{M}=0 in Expression (17), and the electrical damping C_{E} is introduced into the servo amplifier. Note that the mechanical damping does not completely reach C_{M}=0, the sensor output is obtained by giving the mechanical damping C_{M} (≈0) and the electrical damping C_{E} to Expression (17).

### [4] Analysis Result of Sensor Dynamic Characteristics

Hereinafter, in a case in which the sensor of the present invention is configured in accordance with the specifications of Table 1, the gain/phase characteristics are obtained on the basis of comparison with the conventional sensor. As described above, to evaluate the performance of the servo-type acceleration sensor, the following three items are used: (1) peak value at resonance point, (2) responsiveness: phase delay at f=100 Hz, and (3) sensor sensitivity.

TABLE 1
Specification of acceleration sensor (Inter-electrode gap h₀ = 30 μm)

| | | | | Conventional | Sensor of present invention | | |
|---|---|---|---|---|---|---|---|
| | | Symbol | Unit | sensor | Case 1 | Case 2 | Case 3 |
| Inertial mass of movable portion | | m | Kg | 1.25 × 10⁻³ | ← | | |
| Mechanical spring constant | | k | N/m | 79.0 | ← | | |
| Proportional gain | | K_{P} | N/m | 9.97 × 10³ | ← | | |
| Damping | (i) Mechanical | C_{M} | Ns/m | 3.85 | 0.393 | | |
| coefficient | damping coefficient | | | | | | |
| | (ii) Electrical | C_{E} | | 0.0 | 3.46 | 3.46 × 2 | 3.46 × 3 |
| | damping coefficient | | | | | | |
| | (i) + (ii) | C_{M} + C_{E} | | 3.85 | 3.85 | 7.31 | 10.8 |

### (1) Comparison Between Sensor of Present Invention and Conventional Sensor

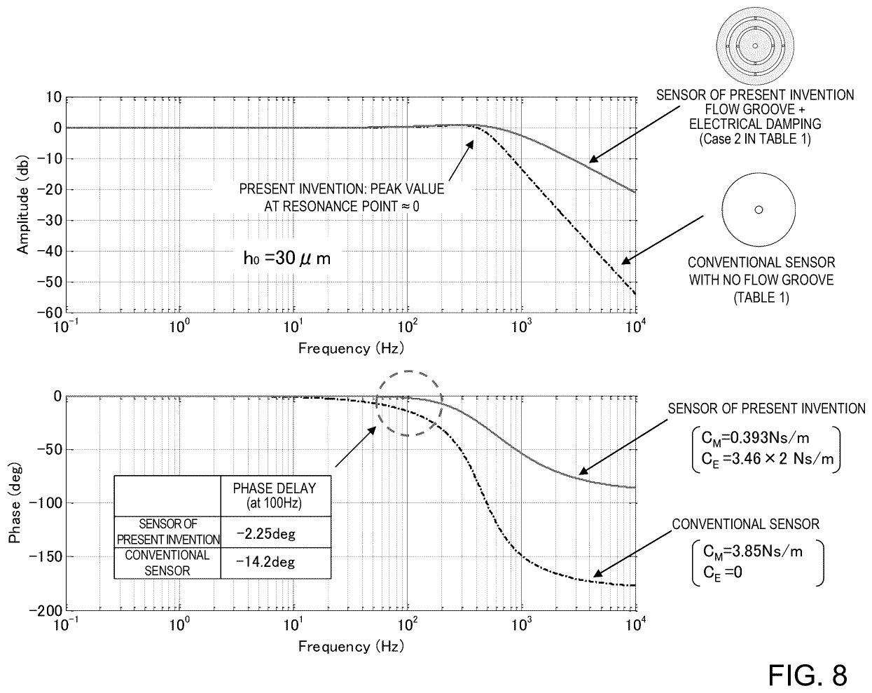

Graphs of FIG. 8 makes comparison between the sensor of the present invention configured as in Case 2 in Table 1 and the conventional sensor, at the inter-electrode gap h₀=30 μm. In the specifications of Table 1, the mechanical damping coefficient of the conventional sensor is C_{M}=3.85 Ns/m, whereas the sensor of the present invention has the microgroove formed at the electrode, and thus the mechanical damping coefficient is reduced to C_{M}=0.393 Ns/m, which is 1/10 times that of the conventional sensor.

Note that in the sensor of the present invention, the electrical damping coefficient is set to C_{E}=3.461×2 Ns/m so as to compensate for the reduction in the damping effect of the microgroove.

From the graphs of FIG. 8, the peak value at the resonance point≈0 in both the sensor of the present invention and the conventional sensor. Note that the phase delay at f=100 Hz is Δθ=−14.3 deg in the conventional sensor, whereas Δθ=−2.25 deg in the sensor of the present invention. Therefore, it can be seen that the sensor of the present invention satisfies ideal conditions for both of the following a. and b.: a. peak value at resonance point, and b. responsiveness: phase delay at f=100 Hz.

Here, it is assumed that a sensor output (2) is extracted from a point B in the control block diagram of FIG. 7. That is, the sensor output Z is proportional amplifier circuit output. In this case, the effect of improving the dynamic characteristics as described above cannot be obtained, and the characteristics thereof are merely such that the electrical damping C_{E} provided in the control circuit is replaced with the mechanical damping C_{M}. That is, the characteristics are equivalent to those of the conventional sensor in the graphs of FIG. 8.

### (2) Sensor of Present Invention: Comparison Among Inter-Electrode Gaps h₀ of 20 to 40 μm

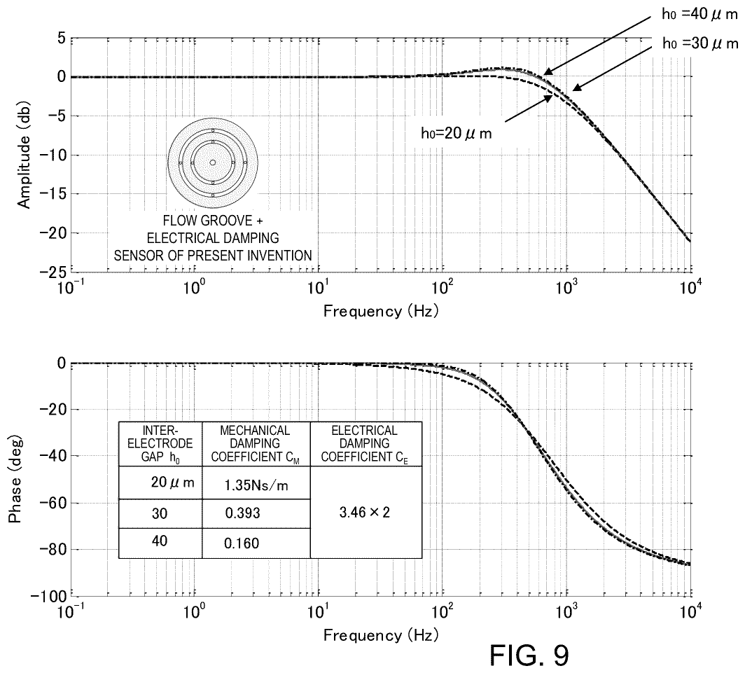

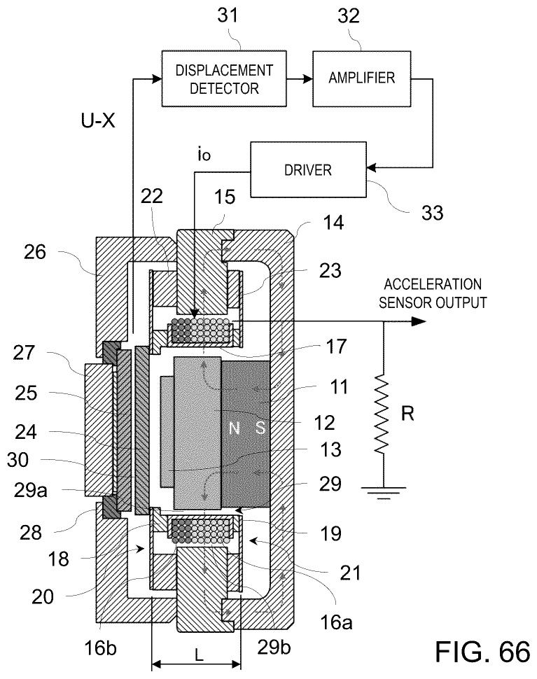

Graphs of FIG. 9 compares gain/phase characteristics at the inter-electrode gaps h₀ of 20 to 40 μm in the sensor of the present invention configured as in Case 2 in Table 1. The value of the mechanical damping coefficient C_{M} in each gap h₀ is indicated in the graphs of FIG. 9. The electrical damping coefficient C_{E}=3.46× 2. Here, the characteristics of the sensor of the present invention (FIG. 9) and the conventional sensor (FIG. 66) are compared from three viewpoints of (1) peak value at resonance point, (2) responsiveness: phase delay at f=100 Hz, and (3) sensor sensitivity. When the gap h₀ is changed in the range of 20 to 40 μm, in the conventional sensor (FIG. 66), the above (1) to (3) are in a trade-off relationship as described above. However, in the case of the sensor of the present invention (FIG. 9), even when the gap h₀ is changed in the range of 20 to 40 μm, the above (1) and (2) are hardly changed. The sensor sensitivity (capacitance) in (3) is inversely proportional to the gap h₀ (=d) as described in Expression (7). Therefore, in the sensor of the present invention, the trade-off relationship of the above (1) to (3) is raveled out, and individual specifications can be set independently. In summary, the present invention can provide ideal sensor dynamic characteristics and achieve sensor sensitivity improvement simultaneously.

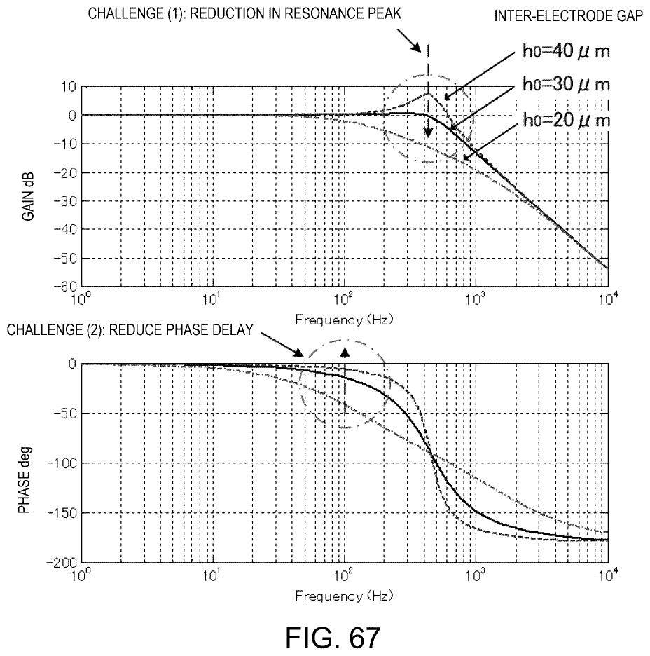

Furthermore, in the mass production process of the conventional acceleration sensor, “how to adjust the inter-electrode gap h₀ with high accuracy” has been an important problem. This is because, as indicated in the graphs of FIG. 67, a slight variation in the inter-electrode gap h₀ at the time of assembly greatly affects the sensor dynamic characteristics. With the sensor of the present invention, assembly accuracy in mass production can be greatly reduced.

### (3) Sensor of Present Invention: Comparison in Case of Changing Electrical Damping Coefficient C_{E}

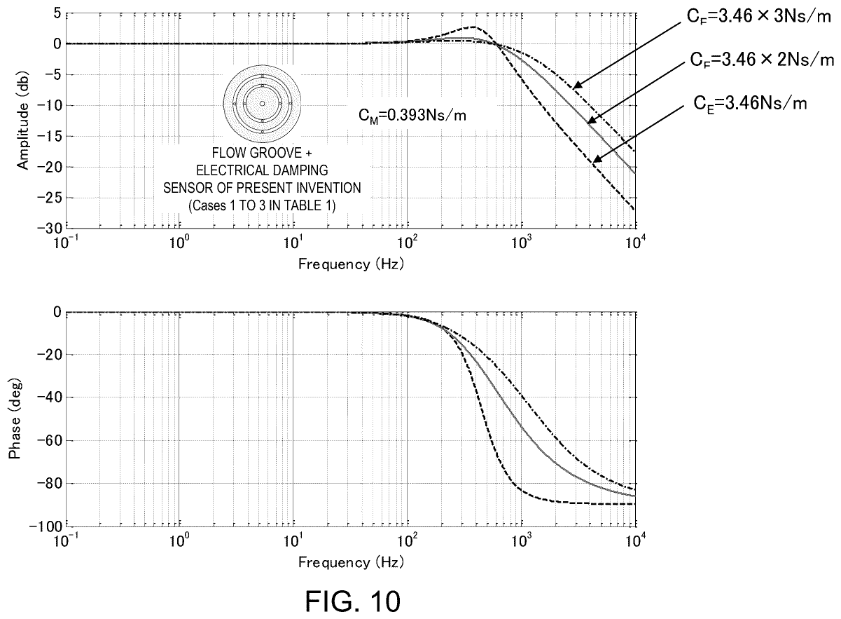

Graphs of FIG. 10 compares gain/phase characteristics of the sensors of the present invention configured as in Cases 1 to 3 in Table 1. In Case 1, the mechanical damping C_{M}=0.393 Ns/m, the electrical damping C_{E}=3.46 Ns/m, and the hybrid damping C_{T}=C_{M}+C_{E}=3.85 Ns/m. Therefore, the mechanical damping C_{M} (=3.85 Ns/m) in a case in which no microgroove is formed (FIG. 8) and the above C_{T} have the same value. In the above Case 1, the resonance peak value at or near the resonance point f=400 Hz is 2.5 dB.

The electrical damping C_{E} is increased while the mechanical damping remains identical to the above C_{M}. When C_{E}=3.46×2 Ns/m (Case 2 in Table 1) and C_{E}=3.46×3 Ns/m (Case 3 in Table 1), the resonance peak value is reduced to nearly 0 at or near the resonance point f=400 Hz. From the above-described results, the following matters can be seen.
(i) Mechanical damping in a case in which no microgroove is formed is defined as C_{M0}.
(ii) Mechanical damping in a case in which a microgroove is formed is defined as C_{MG}.
(iii) Electrical damping C_{E0} is determined so as to achieve C_{E0}+C_{MG}=C_{M0}.
(iv) When the electrical damping C_{E} is set to be twice or more of CEO in the above (iii), the resonance peak value can be reduced.

Therefore, by obtaining the electrical damping C_{E} in the above steps (i) to (iv), more ideal gain/phase characteristics of the sensor can be obtained.

### (4) Other Damping Effects

The acceleration sensor has a damping element other than the air-viscous fluid interposed in the inter-electrode gap. For example, in FIG. 2(b), when a conductor (aluminum) is used for the coil bobbin 207, damping C_{ME} due to eddy current occurs. This damping C_{ME} does not depend on the inter-electrode gap.

The damping C_{ME} is sufficiently smaller than the damping due to the viscous fluid in the inter-electrode gap, and is generally a negligible value. If it is difficult to theoretically obtain the damping C_{ME}, for example, it is sufficient that the actuator be driven with the electrode being removed, and C_{ME} be actually measured from the dynamic characteristics thereof.

Provided, however, that with the damping C_{ME}, it is not possible to obtain the effect of improving dynamic characteristics as in the case in which the sensor output (1) is extracted at the point A in the control block diagram of FIG. 7. Therefore, the dynamic characteristics of the sensor of the present invention is equivalent to that in a case in which the air-viscous damping C_{M0} is added to the above actual measurement value C_{ME} to obtain the mechanical damping C_{M} (=C_{M0}+C_{ME}).

### [5] Comprehensive Evaluation of Present Invention and Conventional Type

Hereinafter, in order to comprehensively evaluate the characteristics and effects of the present invention on the basis of comparison with those of conventional sensors, the expressions are rewritten by making the axis of the frequency f dimensionless, and replacing a damping coefficient C, an inertial mass m, and a proportional gain K with a mechanical damping ratio ζ_{M} and an electrical damping ratio ζ_{E}, both of which can also be called representative physical quantities.

A transfer function G(=Z/Λ) in Expression (17) can be expressed as follows:

$$\begin{matrix}[ Mathematical Expression 20 ] & \\ G ( s ) = \frac{{C}_{E} s + {K}_{P}}{{ms}^{2} + ( {C}_{M} + {C}_{E} ) s + k + {K}_{P}} = \frac{\frac{{C}_{E}}{m} s + \frac{{K}_{P}}{m}}{{s}^{2} + \frac{{C}_{M} + {C}_{E}}{m} s + \frac{k + {K}_{P}}{m}} \frac{2 {ς}_{{E}_{}} {ω}_{n} s + {ω}_{n}^{2}}{{s}^{2} + 2 ( {ς}_{M} + {ς}_{E} ) {ω}_{n} s + {ω}_{n}^{2}} & ( 20 )\end{matrix}$$

Here, an electrical gain is defined as K_{P}, and a mechanical spring rigidity is defined as k. Generally, K_{P}>>k, and thus a resonance frequency ωₙ can be approximated as the following expression.

$$\begin{matrix}[ Mathematical Expression 21 ] & \\ {ω}_{n} = \sqrt{( {K}_{P} + k ) / m} \sqrt{{K}_{P} / m} & ( 21 )\end{matrix}$$

The mechanical damping ratio ζ_{M} and the electrical damping ratio ζ_{E} are expressed by the following equations.

$$\begin{matrix}[ Mathematical Expression 22 ] & \\ {ς}_{M} = \frac{{C}_{M}}{2 \sqrt{{mK}_{P}}} & ( 22 )\end{matrix}$$

$$\begin{matrix}[ Mathematical Expression 23 ] & \\ {ς}_{E} = \frac{{C}_{E}}{2 \sqrt{m {K}_{P}}} & ( 23 )\end{matrix}$$

In the above equation, when the value of the mechanical spring rigidity k cannot be ignored, it suffices to define the proportional gain K_{P} as K_{P}+k→K_{P}. Hereinafter, when the frequency axis is made dimensionless, the gain/phase characteristics of the following (i) and (ii) are obtained:
(i) a case in which no microgroove is formed and the electrical damping ratio is set to ζ_{E}=0; and
(ii) a case in which a microgroove is formed to achieve ζ_{M}=0, and the electrical damping ratio ζ_{E} is set

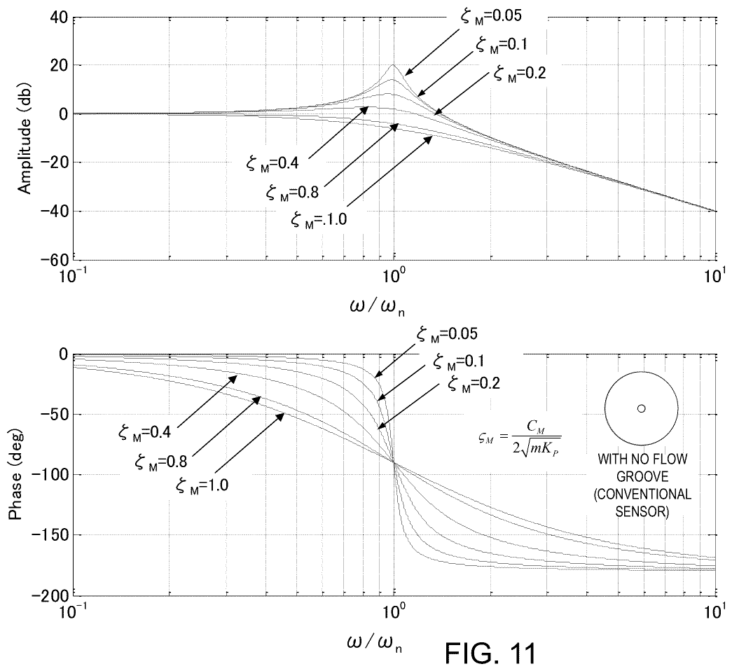

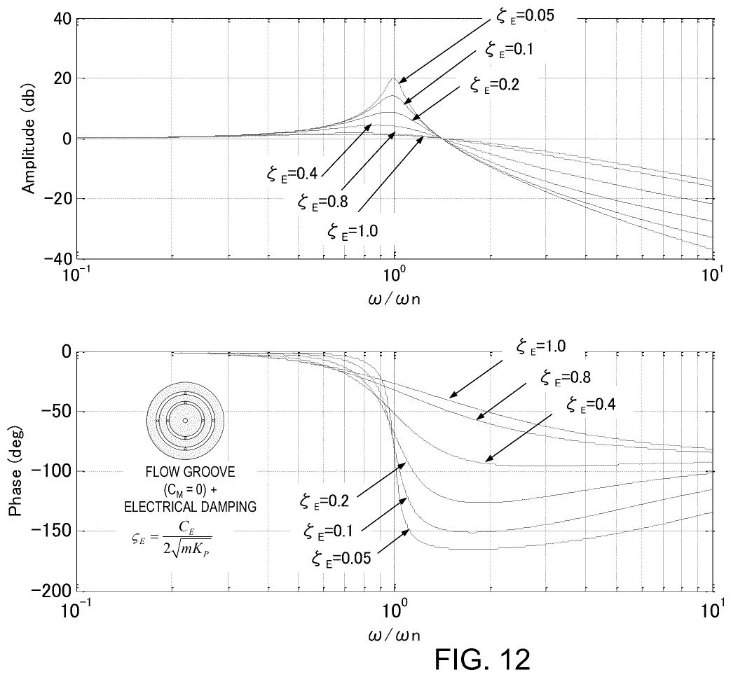

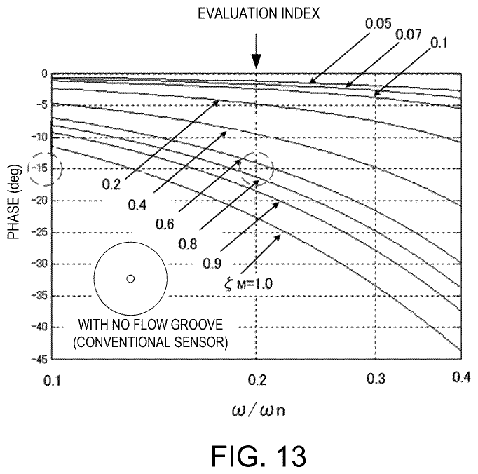

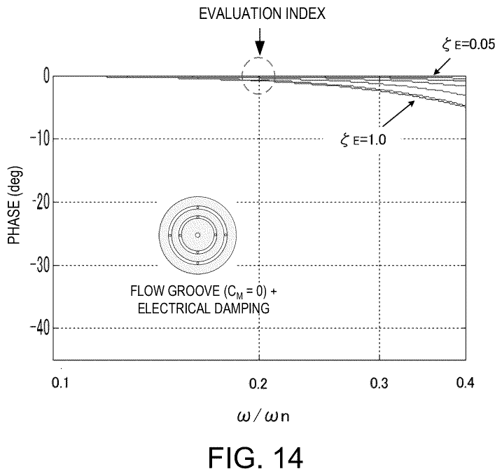

FIG. 11 indicates the characteristics of the above (i), and a case in which ζ_{E}=0 in Expression (15). FIG. 12 indicates the characteristics of the above (ii), and a case in which ζ_{M}=0 in Expression (15). FIG. 13 indicates phase characteristics limited to a range of 0.1<ω/ωₙ<0.4 in FIG. 11. FIG. 14 indicates phase characteristics limited to a range of 0.1<ω/ωₙ<0.4 in FIG. 12.

From the gain/phase characteristics of the above (i) and (ii), the following conditions required for the servo-type acceleration sensor are evaluated. That is, the ranges of ζ_{E} and ζ_{M} satisfying the following conditions (1) and (2) are obtained.
(1) A peak value at the resonance point is 10 dB or less.
(2) The phase delay Δθ at ω/ωₙ=0.2 is 10 deg or less.

The evaluation index in the above (2) was set on the basis of the following assumption. When an upper limit value of the resonance frequency of the servo-type acceleration sensor is fₙ=500 Hz, a phase delay at f=100 Hz, that is, at ω/ωₙ=0.2 is used as an evaluation index. Since a possible resonance frequency of the actual servo-type acceleration sensor is fₙ=500 Hz or less, the above (2) is a sufficient condition for satisfying ideal sensor dynamic characteristics.

From graphs of FIGS. 11 and 12, conditions of ζ_{M} and ζ_{E} satisfying the above (1) are C_{M}≥0.2 and C_{E}≥0.2. That is, the peak value at the resonance point is determined only by the magnitude of damping, irrespective of electrical and mechanical damping. This is because the peak value at the resonance point is determined by the magnitude of the damping that causes the phase delay, that is, the damping term (ζ_{M}+ζ_{E})ωₙ of the transfer function denominator in Expression (17). Therefore, the condition for satisfying the above (1) is the following expression.

$$\begin{matrix}[ Mathematical Expression 24 ] & \\ {ζ}_{M} + {ς}_{E} ≧ 0.2 & ( 24 )\end{matrix}$$

Conditions of ζ_{E} and ζ_{M} that satisfy the condition of the phase delay of the above (2) are as follows. From the graph of FIG. 14, the impact of the electrical damping ratio ζ_{E} on the phase delay is insubstantial. From the graph of FIG. 13, the mechanical damping ratio ζ_{M} under the condition of 15 deg or less of the phase delay at ω/ωₙ=0.2 is as follows:

$$\begin{matrix}[ Mathematical Expression 25 ] & \\ {ζ}_{M} ≦ 0.6 & ( 25 )\end{matrix}$$

The reason why the electrical damping ratio ζ_{E} does not affect the condition of the phase delay is that the damping ratio ζ_{E} has an effect of delaying a phase and simultaneously advancing the phase.

In Expressions (22) and (23), assuming that m=K_{P}/ω²ₙ, it may be evaluated as ζ_{M}=C_{Mωn}/2K_{P} and ζ_{E}=C_{Eωn}/2K_{P}. If the mass m cannot be easily obtained as in a swing motion sensor to be described later, it suffices to use the above expressions.

### [Embodiment 2] (MM Acceleration Sensor)

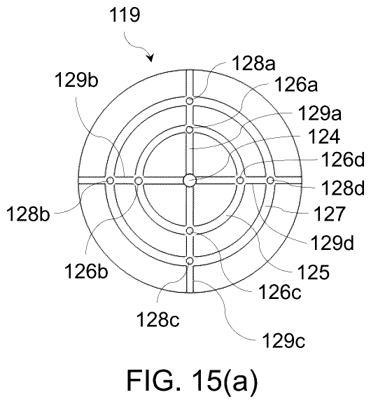

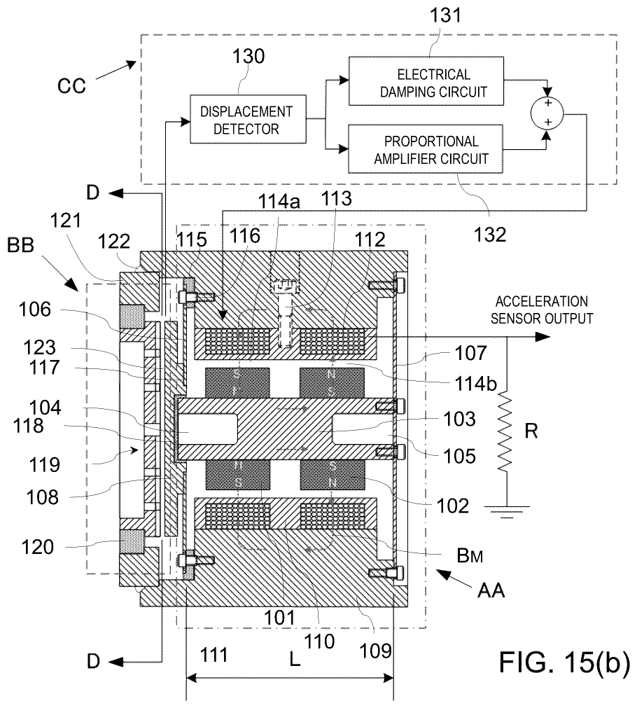

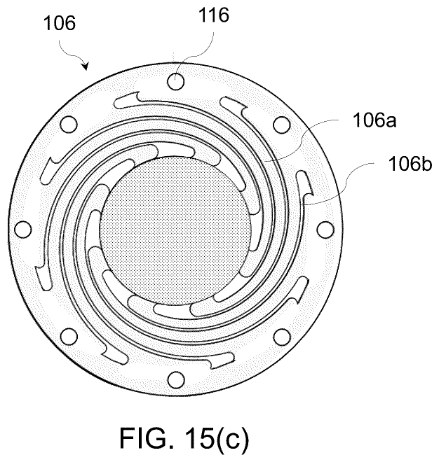

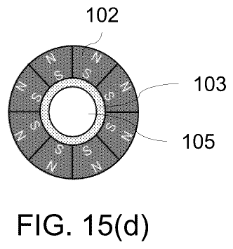

FIG. 15 illustrates an example of an MM servo-type acceleration sensor according to Embodiment 2 of the present invention, and the sensor sensitivity is improved by doubling the electrode area as compared with Embodiment 1. As described above, the sensor sensitivity determined by the electrode area and the inter-electrode gap and the sensor dynamic characteristics depending on the damping characteristics have been conventionally in trade-off relationship. By applying the present invention, the sensor sensitivity and the sensor dynamic characteristics can be independently set. However, when the present invention is applied to the conventional MC sensor (FIG. 65), the following matter has been a problem in practical application. The problem is the dynamic stability of the sensor main body when the diameter of the movable-side electrode is increased for increasing the capacitance, that is, when a movable electrode having a large mass is disposed at the end portion of the axis. In view of the above, attention is paid to the MM type (moving magnet type) as a sensor structure that can achieve the following.
(1) Both ends in the axial direction have an open structure, and a support span L of the movable portion can be set large.
(2) Division and cutting of the disc-shaped spring supporting the movable portion is not necessary. Accordingly, a torsional rigidity can be set large. The torsional rigidity is a rigidity in an X_{θ} direction, where the moving direction of the movable portion is defined as the X-axis.

According to the above (1) and (2), the MM type can have a dynamically stable movable portion support structure as compared with the MC type.

### [1] MM Servo-Type Acceleration Sensor

The above-described servo-type acceleration sensor (FIG. 65) has a problem in an aspect of production technology related to yield and reliability in mass production. The problem is attributable to a basic operation principle of a moving coil type (hereinafter referred to as an MC type or MC) in which a sensor signal needs to be transmitted and received between a coil and a fixed side because the coil (16a and 16b) as a movable portion moves. A conductive path that couples the movable portion and the fixed side and through which a plurality of signals flow needs to be formed by using an elastic member (disc-shaped springs 20 and 21) coupling the movable portion and the fixed side. As a result, (1) division by cutting a disc-shaped spring for formation of a plurality of conductive paths, (2) insulation of a signal line, and (3) a complicated production method involving an extra-fine wire soldering process, and the like are required. These requirements are major factors that lower yield and reliability in mass production.

The inventors of the present invention have proposed and filed an application of a moving-magnet (MM) servo-type acceleration sensor that does not require an ultrafine wire processing by fixing a coil and making a permanent magnet movable. The filed application is pending. The MM servo-type acceleration sensor has no precedent in the past. This seems to be attributable to a stereotype (blind spot) of “disadvantageous transfer characteristics and responsiveness of the MM type in a high frequency range due to the increased inertial mass of the movable portion”, which can also be regarded as an implicit premise. The already-proposed invention re-examines and takes advantages of this “blind spot” by the ingenuity described as follows. That is, with the following methods including
(i) a magnetic circuit configuration that reduces the weight of the movable portion,
(ii) a magnetic pole shape for reducing the impact of leakage flux, and
(iii) finding out a coil specification (the number of turns and the wire diameter) that can achieve both the increase of generative force and the reduction in heat generation by devising an electromagnet structure capable of increasing the coil volume,
disadvantages of the MM type are eliminated, and the sensor performance greatly exceeding that of the MC type can be provided by utilizing the characteristics of the MM type. The inertial mass of the movable portion is larger than in the MM type than in the MC type. This is a disadvantage but also functions as an advantage that the movable portion is easily moved even with a minute acceleration. Elimination of the disadvantage turns out to be an advantage of improved sensor sensitivity particularly in a low frequency range. As also described above, since the MM type can have a dynamically stable movable portion support structure as compared with the MC type, the electrode outer diameter and the sensor output can be increased. Hereinafter, specific structures and structural features of the present embodiment will be described in [2] below.

### [2] Description of Embodiment 2

FIG. 15a is a sectional view taken along a line DD in FIG. 15b and viewed in a direction of arrows DD, and FIG. 15b is a front sectional view of the sensor main body. FIG. 15c is an external view of a front disc, and FIG. 15d is an external view of a rear permanent magnet.

A one-dot chain line AA section in FIG. 15b illustrates a moving-magnet (MM) actuator unit that drives the movable portion in the axial direction. A two-dot chain line BB section illustrates a displacement detection unit that detects capacitance. A two-dot chain line CC section illustrates the outline of a control circuit unit in which a servo amplifier that drives an actuator is built. As described above, an application of the MM servo-type acceleration sensor has been filed by the inventors of the present invention and the application is pending. The actuator unit is further improved from that of the pending application. Hereinafter, a specific structure of the present embodiment will be described separately for the actuator unit, the displacement detection unit, and the control circuit unit.

### [2-1] Actuator Unit

In the actuator unit (one-dot chain line AA section) in FIG. 15b, reference sign 101 denotes a front permanent magnet, reference sign 102 denotes a rear permanent magnet, and reference sign 103 denotes a pole piece portion (movable-side yoke member). As illustrated in FIG. 15d, both the front permanent magnet and the rear permanent magnet include a plurality of segment permanent magnets each magnetized in the radial direction, and are mounted to the pole piece portion 103. The magnetization directions of the front permanent magnet 101 and the rear permanent magnet 102 in the radial direction are opposite to each other. Reference signs 104 and 105 denote cylindrical void portions formed on the left and right of the pole piece portion 103 in order to reduce the weight of the pole piece portion. Reference sign 106 denotes a front spiral disc spring (hereinafter, the front disc), and reference sign 107 denotes a rear spiral disc spring (hereinafter, the rear disc). A distance between the front disc and the rear disc is the support span L. The size of the support span L is sufficiently larger than that of the conventional MC sensor (FIG. 65). As illustrated in the external view of FIG. 15c, the front disc includes ridges 106a and grooves 106b, and the same applies to the rear disc. As will be described later, the front disc 106 also serves as a signal transmission path that propagates the electrical signal of the fixed-side electrode to a control circuit installed outside. The shape of the spring is not limited to this spiral curve in the present embodiment. This also applies to the embodiments to be described later. It suffices to select a spring structure and specifications with which a low rigidity and a low resonance frequency can be obtained from the characteristics required for an acceleration sensor. For example, a well-known plate spring having a cloud-shaped slit or the like can also be applied. Reference sign 108 denotes a movable-side electrode supported by the front disc, reference sign 109 denotes a coil-side yoke member, reference sign 110 denotes a coil bobbin, reference sign 111 denotes a front force coil, reference sign 112 denotes a rear force coil, and reference sign 113 denotes a coil bobbin fastening bolt (indicated by an imaginary line). The winding directions of the front force coil 111 and the rear force coil 112 are opposite to each other. Reference sign 114 denotes a magnetic void portion formed between the inner peripheral surface of the coil bobbin 110 and the two permanent magnets. Reference sign 114a denotes a front magnetic void portion, and reference sign 114b denotes a rear magnetic void portion. As indicated by chain line arrows, a closed-loop magnetic circuit B_{M} is formed by “the permanent magnet 102→the rear magnetic void portion 114b→the coil-side yoke member 109→the front magnetic void portion 114a→the permanent magnet 101→the pole piece portion 103→the permanent magnet 102”. The front disc 106 also serves as a conductive path for supporting the movable portion and detecting capacitance. In order to detect a minute capacitance signal between the movable-side electrode 108 and the fixed-side electrode (to be described later), a conductive path coupling the movable-side electrode 108 and the outside is completely electrically insulated. That is, the front disc 106 is fastened to the coil-side yoke member 109 using a bolt 116, with an outer peripheral ring 115 interposed therebetween. The outer peripheral ring 115 is made of a non-conductive material, and the front disc 106 and the outer peripheral ring 115 are fixed in advance using an adhesive. By making the diameter of the bolt hole formed at the front disc 106 larger than the bolt diameter, the bolt 116 and the front disc 106 are electrically insulated. The movable-side electrode 108 is bonded and fixed to the front disc 106 at a junction 117. The center portion of the movable-side electrode 108 is bonded and fixed to an end face of the pole piece portion with a non-conductive material 118 interposed therebetween. Although an eddy current is generated in the pole piece portion and the coil-side yoke member, the capacitance signal between the two electrodes (movable side and fixed side) can avoid the impact of the eddy current by the electrical insulation countermeasure (non-conductive materials 115 and 118). Examples of applicable non-conductive materials include mica, porcelain (ceramics), glass, and polyimide (super engineering plastic), all of which are inorganic solid insulating materials. In order to control the current flowing through the two force coils 111 and 112, the lead wires of these coils pass through the coil-side yoke member 109 and are coupled to a control circuit installed outside (not illustrated).

The movable portion of the present example includes the two permanent magnets 101 and 102, the pole piece portion 103, and the movable-side electrode 108. The fixed portion includes the coil bobbin 110 in which each coil is housed and the coil-side yoke member 109. In the acceleration sensor of the present embodiment, a moving magnet type that has been already proposed is used as the drive unit of the above-described movable portion. As is well known, when a current flows through a conductor placed in a magnetic field, Lorentz force, which is an electromagnetic force, is generated. All actuators have, regardless of the type of driving principle thereof, a relative force relationship between the fixed side and the moving side. That is, when one of the fixed side and the moving side is fixed, the other moves. In the present example, when a current flows through the force coils 111 and 112 housed in the coil bobbin 110, a reaction force of Lorentz force for moving the movable portion in the axial direction is generated.

### [2-2] Displacement Detection Unit

In the displacement detection unit (chain line BB section) in FIG. 15b, reference sign 119 denotes a fixed-side electrode, reference sign 120 denotes an insulating ring, and reference sign 121 denotes a fixing ring. The fixed-side electrode 119 is held by the fixing ring with the insulating ring interposed therebetween. Reference sign 122 denotes a portion on which an adhesive is applied for fixing the fixing ring 121 to the coil-side yoke member 109. Reference sign 123 denotes a void portion between the fixed-side electrode 119 and the movable-side electrode 108. In the assembly adjusting step, the position of the fixing ring 121 with respect to the coil-side yoke member 109 is adjusted so that a gap h₀ of the void portion 123 reaches a target value.

As in Embodiment 1, two rows of ring-shaped grooves and a plurality of through-holes are formed at the fixed-side electrode 119 that is an opposing face of the movable-side electrode 108. Reference sign 124 denotes a center through-hole, reference sign 125 denotes a first ring-shaped groove, and reference signs 126a, 126b, 126c, and 126d denote through-holes formed inside the first ring-shaped groove. Reference sign 127 denotes a second ring-shaped groove, and reference signs 128a, 128b, 128c, and 128d denote through-holes formed inside the second ring-shaped groove.

At the fixed-side electrode surface, a radial groove having a cross shape is further formed around the center through-hole 124, in addition to the above-described two-row circumferential grooves (ring-shaped grooves). In the electrode surface of the present embodiment, the microgrooves are formed in the form of both the circumferential groove and the radial groove. This is for reducing the increase in the damping effect of squeeze pressure associated with the increase in the electrode outer diameter. Reference sign 129a denotes a first radial groove, reference sign 129b denotes a second radial groove, reference sign 129c denotes a third radial groove, and reference sign 129d denotes a fourth radial groove.

### [Supplement: Decrease in Capacitance Due to Microgroove]

A groove width of each of the first ring-shaped groove, the second ring-shaped groove, and the radial groove is h_{G}=0.2 mm. The center through-hole ΦD₁ is 1.0 mm, an electrode outer diameter ΦD₂ is 18.4 mm, an inner peripheral side of the first ring-shaped groove 125 is formed at a position of a radius r₁=3.0 mm, and an inner peripheral side of the second ring-shaped groove 127 is formed at a position of a radius r₂=6.0 mm. A total groove area of the first and second ring-shaped grooves 125 and 127 is Sₘ₁=11.3 mm², a total groove area of the four radial grooves 129a, 129b, 129c, and 129d is Sₘ₂=7.36 mm², and an electrode area without the grooves is S_{T}=266 mm². Accordingly, the proportion of the area of the grooves to the total electrode area is 7.01%. In summary, a decrease in capacitance due to the ring-shaped grooves and the radial grooves is about 7%.

### [2-3] Control Circuit Unit

The chain line CC section in FIG. 15(b) illustrates the outline of the control circuit unit. Reference sign 130 denotes a displacement detector, reference sign 131 denotes an electrical damping circuit, and reference sign 132 denotes a proportional amplifier circuit. A capacitance C is determined by the clearance h₀ of the void portion 123 formed by the movable-side electrode 108 and the fixed-side electrode 119. Thus, as in the Embodiment 1, the measurement of the capacitance C makes it possible to detect the relative displacement, which is the difference between ground motion absolute displacement U and absolute displacement X of the mass body. A current i₀ of the actuator is controlled by flowing through the electrical damping circuit 131 and the proportional amplifier circuit 132 so that relative displacement U-X maintains zero. The acceleration acting on the movable portion can be obtained by detecting the current i₀ flowing through the force coils 111 and 112.

### [3] Characteristic Analysis Result

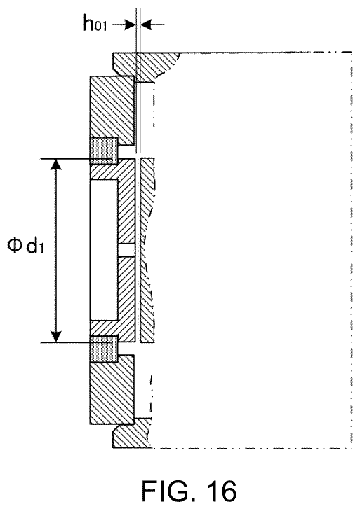

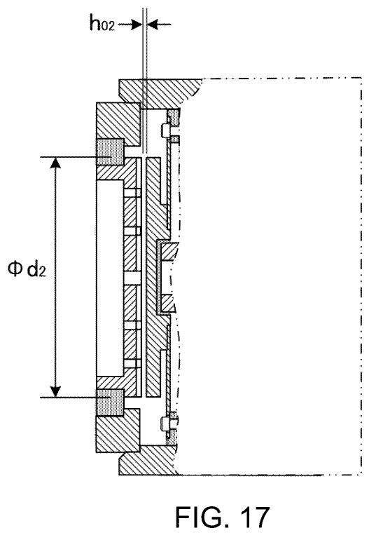

For the case in which the MM sensor of the present invention (electrode with a groove) is configured in accordance with the specifications of Tables 2 and 3, the gain/phase characteristics are obtained on the basis of comparison with the conventional electrode structure (electrode with no groove). Here, the conventional sensor compared with the sensor of the present invention in the Embodiment 1 is defined as a conventional reference sensor. FIG. 16 illustrates a conventional reference sensor, and FIG. 17 illustrates an MM sensor to which the present invention is applied, and both illustrate only an electrode portion. The conventional reference sensor of FIG. 16 has an electrode outer diameter d₁ and an inter-electrode gap h₀₁. The sensor of the present invention of FIG. 17 has an electrode outer diameter d² and an inter-electrode gap h₀₂. In order to improve sensor sensitivity, the impact on the sensor dynamic characteristics is evaluated for each of the following cases (1) and (2):
(1) the doubled electrode area and the identical inter-electrode gap with respect to the reference sensor; and
(2) the doubled electrode area and the halved inter-electrode gap with respect to the reference sensor.

As described above, to evaluate dynamic characteristics, the following three items are used: (1) peak value at resonance point, (2) responsiveness: phase delay at f=100 Hz, and (3) sensor sensitivity.

### [3-1] when Inter-Electrode Gap h₀₂=30 μm (Doubled Sensor Sensitivity)

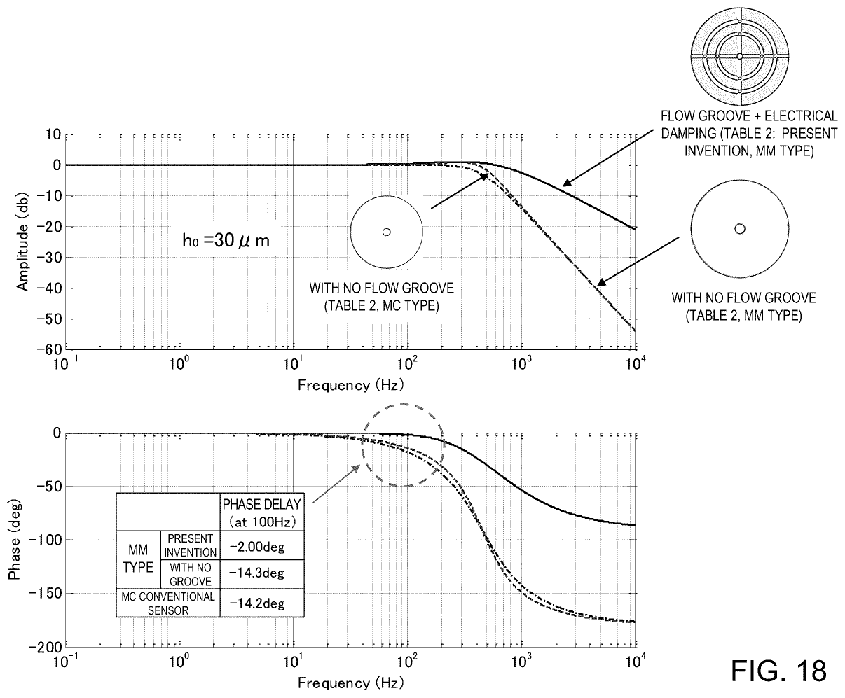

FIG. 18 indicates the obtained gain/phase characteristics of the MM sensor configured under the conditions of Table 2, and compares the MM sensor with no flow groove (one-dot chain line) and that with a flow groove (solid line: the present invention). In both cases, the electrode area is doubled with respect to that of the conventional reference sensor. The graphs also provide the characteristics of the conventional reference sensor (chain line).

From the graphs of FIG. 18, the peak value at the resonance point≈0 in both the MM type in the present invention and the conventional reference sensor. Note that the phase delay at f=100 Hz is Δθ=−14.3 deg in the MM type with no groove, whereas Δθ=−14.2 deg in the conventional reference sensor. On the other hand, Δθ=−2.00 deg in the sensor of the present invention. Therefore, in the sensor of the present invention, even though the electrode area is doubled, ideal conditions are satisfied for all of the following items a. to c.: a. peak value at resonance point, b. responsiveness: phase delay at f=100 Hz, and c. sensor sensitivity.

TABLE 2
Specification of MM acceleration sensor (Inter-electrode gap h₀ = 30 μm)

| | | | | | Electrode area is obtained by doubling | |
|---|---|---|---|---|---|---|
| | | | | Conventional | that of conventional reference sensor | |
| | | | | reference | Electrode with | Electrode with groove |
| | | Symbol | Unit | sensor | no groove | (Present invention) |
| Specification of | Outer diameter (Area) | D | mm | 13 | 18.4 | ← |
| electrode portion | Gap | h₀ | mm | 0.03 | 0.030 | ← |
| Inertial mass of movable portion | | m | Kg | 1.25 × 10⁻³ | 3.75 × 10⁻³ | ← |
| Mechanical spring constant | | k | N/m | 79.0 | 237 | ← |
| Proportional gain | | K_{P} | N/m | 9.97 × 10³ | 2.99 × 10⁴ | ← |
| Damping | (i) Mechanical | C_{M} | Ns/m | 3.85 | 14.9 | 1.09 |
| coefficient | damping coefficient | | | | | |
| | (ii) Electrical | C_{E} | | 0.0 | 0 | 10.5 × 2 |
| | damping coefficient | | | | | |
| | (i) + (ii) | C_{M} + C_{E} | | 3.85 | 14.9 | 22.1 |

### [3-2] when Inter-Electrode Gap h₀₂=15 μm (Four-Fold Increased Sensor Sensitivity)

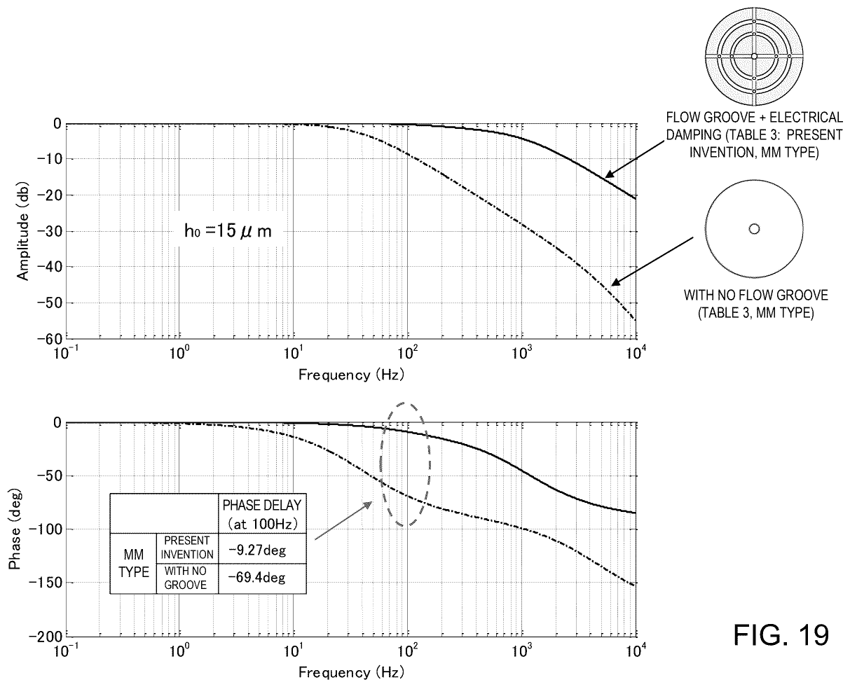

FIG. 19 indicates the obtained gain/phase characteristics of the MM sensor configured under the conditions of Table 3, and compares the MM sensor with a flow groove (solid line: the present invention) and that with no flow groove (one-dot chain line). The electrode area is doubled and the inter-electrode gap is halved with respect to the conventional reference sensor in both MM sensors. Therefore, from Expression (7), the sensor sensitivity of the sensor of the present invention is four times greater than that of the sensor with no flow groove.

From the graphs of FIG. 19, the gain at the resonance point of the sensor with no flow groove is reduced to about −20 dB as compared with the sensor with a flow groove (present invention). The phase delay at f=100 Hz is Δθ=−9.27 deg in the sensor with a flow groove (present invention), whereas Δθ=−69.4 deg in the sensor with no flow groove. The sensor with no flow groove apparently has overdamping characteristics.

Therefore, in the sensor of the present invention, even though the sensor sensitivity is four-fold increased, ideal conditions are satisfied for all of the following items a. to c.: a. peak value at resonance point, b. responsiveness: phase delay at f=100 Hz, and c. sensor sensitivity.

TABLE 3
Specification of MM acceleration sensor (Inter-electrode gap h₀ = 15 μm)

| | | | | | Electrode area is obtained by doubling that | |
|---|---|---|---|---|---|---|
| | | | | Conventional | of conventional reference sensor (MM type) | |
| | | | | reference sensor | Electrode with | Electrode with groove |
| | | Symbol | Unit | (MC type) | no groove | (Present invention) |
| Specification of | Outer diameter (Area) | D | mm | 13 | 18.4 | ← |
| electrode portion | Gap | h₀ | mm | 0.03 | 0.015 | ← |
| Inertial mass of movable portion | | m | Kg | 1.25 × 10⁻³ | 3.75 × 10⁻³ | ← |
| Mechanical spring constant | | k | N/m | 79.0 | 237 | ← |
| Proportional gain | | K_{P} | N/m | 9.97 × 10³ | 2.99 × 10⁴ | ← |
| Damping | (i) Mechanical | C_{M} | Ns/m | 3.85 | 119 | 8.7 |
| coefficient | damping coefficient | | | | | |
| | (ii) Electrical | C_{E} | | 0.0 | 0 | 10.5 × 2 |
| | damping coefficient | | | | | |
| | (i) + (ii) | C_{M} + C_{E} | | 3.85 | 119 | 29.7 |

### [3-3] Analysis of Two-Dimensional Viscous Fluid of Electrode with “Circumferential Groove and Radial Groove”

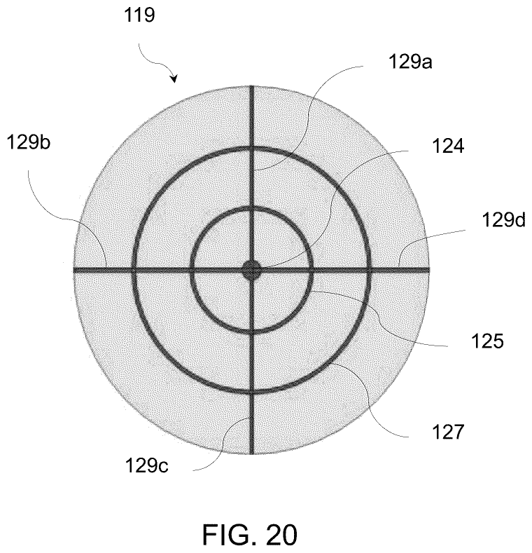

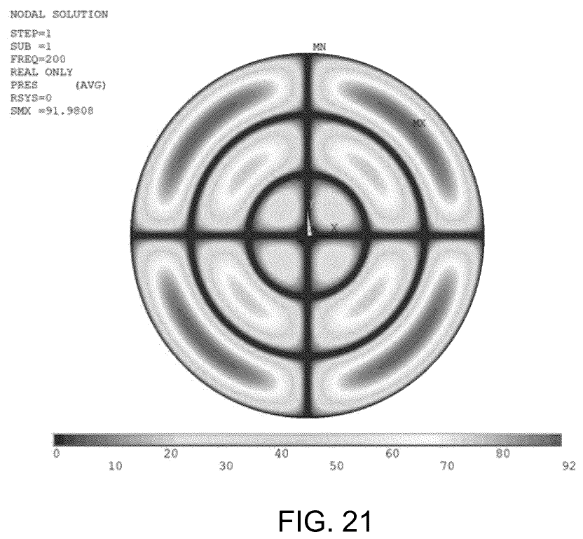

In the present embodiment, the numerical analysis result of the two-dimensional viscous fluid at the electrode void portion is given below. FIG. 20 is a two-dimensional analysis model of an electrode surface at which microgrooves including circumferential grooves and radial grooves are formed. Pressure boundary conditions of the first ring-shaped groove, the second ring-shaped groove, the radial grooves, the inside of these grooves, the through-hole 124, and the outer peripheral portion of the electrode 119 are atmospheric pressure. FIG. 21 indicates a numerical analysis result of squeeze pressure distribution.

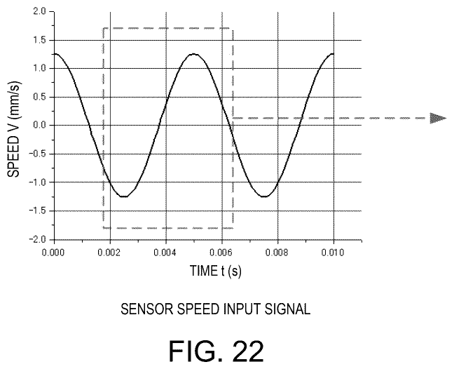

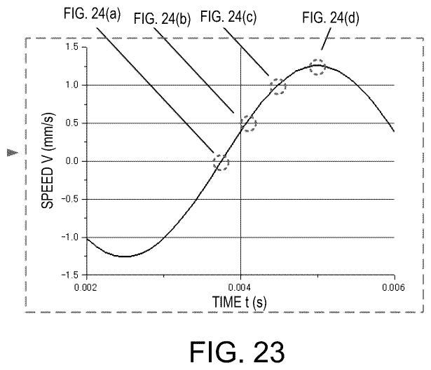

FIGS. 22 to 24 indicate the obtained transient responses of the squeeze pressure distribution generated at the inter-electrode gap when the inter-electrode gap changes in a sinusoidal waveform. A vibration center value h₀=0.015 mm, a vibration amplitude Δh=0.001 mm, and a frequency f=200 Hz. In the speed waveform in this case, as indicated in FIG. 22, a center value of a speed Vis V₀=0, and a speed amplitude ΔV=1.25 mm. FIG. 23 indicates an extracted speed waveform in the range of time of 0.002<t<0.006 seconds (FIG. 22).

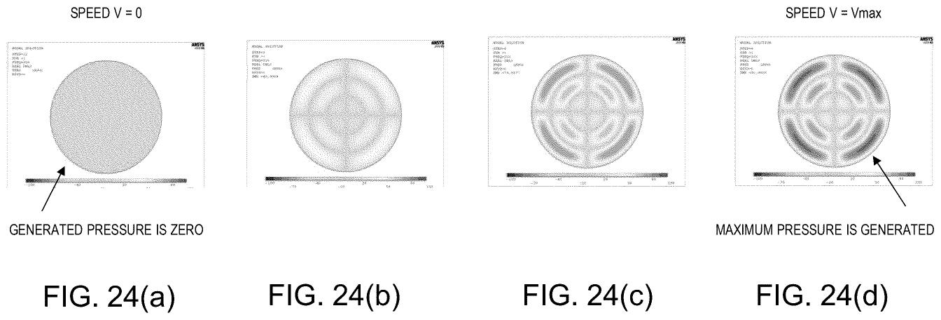

FIGS. 24(a) to 24(d) indicate squeeze pressure distributions changing depending on speed. When the speed V=0, the generated pressure is zero as indicated in FIG. 24(a).

When the speed V=Vₘₐₓ=1.25 mm/s, the generated pressure is at maximum as indicated in FIG. 24(d). The values of a mechanical damping coefficient C_{M} in Tables 2 and 3 are obtained by the above-described analysis method.

### [Embodiment 3] (Application to Differential Sensor)

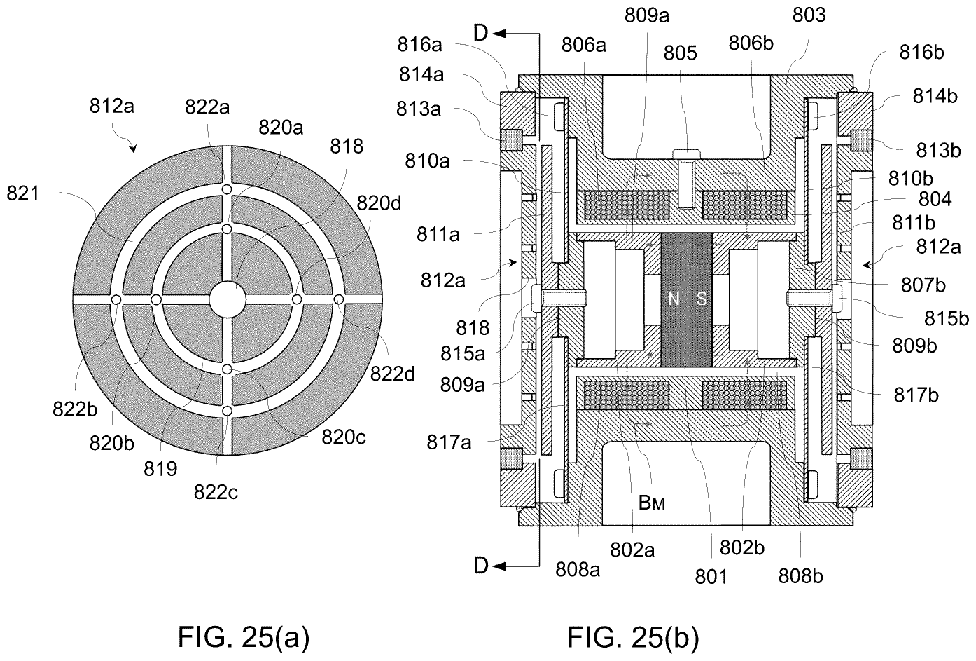

FIG. 25 illustrates an example of a differential servo-type acceleration sensor according to Embodiment 3 of the present invention, in which FIG. 25(a) is a view taken along a line DD in FIG. 25(b) and viewed in a direction of arrows DD, and FIG. 25(b) is a front sectional view. That is, focusing on the structural characteristics of the linear motion MM type in which both the left and right output shafts are open-ended, electrodes for detecting capacitance are provided at two positions on the left and right to form a differential capacitive sensor. As described in [Supplement 2], an approach to make the acceleration sensor differential can provide a high-resolution sensor in which the sensor output is unsusceptible to disturbance signals such as noise and a drift.

In the case of the differential type, the origin position of the movable member is set such that the capacitances of the above-described two sets of electrodes are equal to each other. when a relative displacement of the movable member from the origin position is detecteda servo amplifier generates a force for returning the movable member to the original position. The inventors of the present invention have proposed a differential acceleration sensor utilizing the characteristics of a linear motion MM type in which an output shaft is open-ended in an already-filed patent. It has been found that there are the following problems when the acceleration sensor is made differential.

### (1) Problem in Performance Aspect

In the case of the differential type in which two displacement sensors are disposed so that an inter-electrode gaps h₀ on the left and right sides are under the same condition, mechanical damping C_{M} of the electrode portion is two-fold increased. In order to maintain the sensor dynamic characteristics, that is, the following items (i) and (ii): (i) reduction in resonance peak, (ii) improvement of responsiveness, it is assumed that, for example, the left and right inter-electrode gaps are increased to h₀=30→40 μm. In this case, from Expression (2), since a damping constant D increases in inverse proportion to the cube of the gap h₀, the mechanical damping C_{M} can be reduced to the degree of the mechanical damping in one displacement sensor. However, sacrifice of the sensor sensitivity cannot be avoided.

### (2) Problem in Production Aspect

In the case of a typical sensor (FIG. 65) in which electrodes are installed only on one side, a gap generally has an error Δδ=δ_{X}−δ₀, where δ_{X} is a gap set through the inter-electrode gap adjustment process, and do is a target gap. This error is attributable to factors in a production aspect, such as part processing accuracy, assembly accuracy, and variation in thickness of an adhesive in adhesion between parts. However, this error can be readjusted to ensure the target gap do by causing the bias current I₀ to flow through the coil. That is, the error can be corrected with the bias current so that the error Δδ→0.

The following case is assumed: the linear motion acceleration sensor is made differential, the inter-electrode gap adjustment is finished, and left and right gaps are set to δ_{L} and δ_{R}. This case has a difficulty in adjusting both the above-described gaps δ_{L} and δ_{R} with the bias current I₀ so as to be the target value δ₀. This is because, in the case of the differential type, the gaps δ_{L} and δ_{R} are constrained to satisfy “δ_{L}+δ_{R}=constant value” when the adjustment of the inter-electrode gap is finished. Since the inter-electrode gap greatly affects the sensor dynamic characteristics on the order of several microns, maintaining the sensor dynamic characteristics of the above (i) and (ii) is difficult.

In the case of the present invention with a microgroove being formed at the left and right electrodes, the mechanical damping can be set to satisfy C_{M}≈0. That is, the size and accuracy of the left and right inter-electrode gaps δ_{L} and δ_{R} do not affect the sensor dynamic characteristics. It suffices to replace the necessary damping effect with electrical damping C_{E}, the above-described problems (1) and (2) of the differential type in which two capacitive sensors are disposed are resolved at the same time.

The application target from which the above-described effect can be obtained may be any form as long as the target is a differential sensor having two electrodes. In summary, it is sufficient that two sets of displacement detection units including the movable-side electrode and the fixed-side electrode be provided, and gaps of the void portions of the two sets of displacement detection units be configured to change in opposite phases.

In the present embodiment, the differential type is applied to the linear motion MM type in which the movable portion is open-ended. As a result, effects of the following (1) to (4), and the like can be simultaneously obtained: (1) a dynamic characteristic improvement effect obtained by a combination of microgrooves and electrical damping, (2) improvement of sensitivity in the low-frequency range due to the increased inertial mass of the MM type, (3) noise/drift cancelling effect provided by a differential type, and (4) productivity improvement due to relaxation of the requirement on gap accuracy between both electrodes. In summary, the present embodiment has the features of the above (1) to (4) at the same time, and offers a new sensor, so-called an “ultimate servo type” that has never been seen in the past.

### (i) Description of Structure

Unlike Embodiment 2 using the permanent magnet magnetized in the radial direction, the acceleration sensor of FIG. 25 forms a closed-loop magnetic circuit by disposing the permanent magnet magnetized in the axial direction at the central portion of the pole piece portion. In addition, the areas of both electrodes are set twice as large as those of the MM type of Embodiment 2. Taking into consideration that the inertial mass of the movable portion is increased to three times that of the conventional MC type (FIG. 65), the sensor sensitivity can be improved to six times as compared therewith.

Reference sign 801 denotes a permanent magnet magnetized in the axial direction, reference sign 802a denotes a front pole piece portion, reference sign 802b denotes a rear pole piece portion, reference sign 803 denotes a coil-side yoke member, reference sign 804 denotes a coil bobbin, reference sign 805 denotes a fastening bolt for fastening the coil bobbin and the coil-side yoke member, reference sign 806a denotes a front coil, and reference sign 806b denotes a rear coil. Reference signs 807a and 807b are void portions formed at the center portions of the front and rear pole piece portions 802a and 802b. Reference sign 808a denotes a front magnetic void portion, and reference sign 808b denotes a rear magnetic void portion, each of which indicates a void in the radial direction between respective one of the two pole piece portions and the coil-side yoke member. A closed-loop magnetic circuit B_{M} is formed by “the permanent magnet 801 the front pole piece portion 802a→the front magnetic void portion 808a→the coil-side yoke member 803→the rear magnetic void portion 808b→the permanent magnet 801”. Reference sign 809a denotes a front inner peripheral support member of the pole piece portion, reference sign 809b denotes a rear inner peripheral support member, reference sign 810a denotes a front disc, and reference sign 810b denotes a rear disc. Reference sign 811a denotes a front movable electrode, reference sign 811b denotes a rear movable electrode, reference sign 812a denotes a front fixed electrode, reference sign 812b denotes a rear fixed electrode, reference sign 813a denotes a front insulating ring, reference sign 813b denotes a rear insulating ring, reference sign 814a denotes a front ring for fastening, reference sign 814b denotes a rear ring for fastening, reference signs 815a and 815b denote fastening bolts for fastening the movable-side electrodes 811a and 811b on the front side and the rear side and the inner peripheral support members 809a and 809b. Reference signs 816a and 816b denote bolts for fastening the two discs 810a and 810b and the coil-side yoke member 803 on the outer peripheral side. The inner peripheral sides of the two discs 810a and 810b are bonded and fixed to the inner peripheral support members 809a and 809b at support portions 817a and 817b.

On the front side, two rows of ring-shaped grooves, cross-shaped radial grooves, and a plurality of through-holes are formed at the fixed-side electrode 812a, which is the opposing face of the movable-side electrode 811a, in the same specification as in Embodiment 2. The same applies to the fixed-side electrode 812b on the rear side. Reference sign 818 denotes a center through-hole, reference sign 819 denotes a first ring-shaped groove, and reference signs 820a, 820b, 820c, and 820d denote through-holes formed inside the first ring-shaped groove. Reference sign 821 denotes a second ring-shaped groove and reference signs 822a, 822b, 822c, 822d denote through-holes formed inside the second ring-shaped groove.

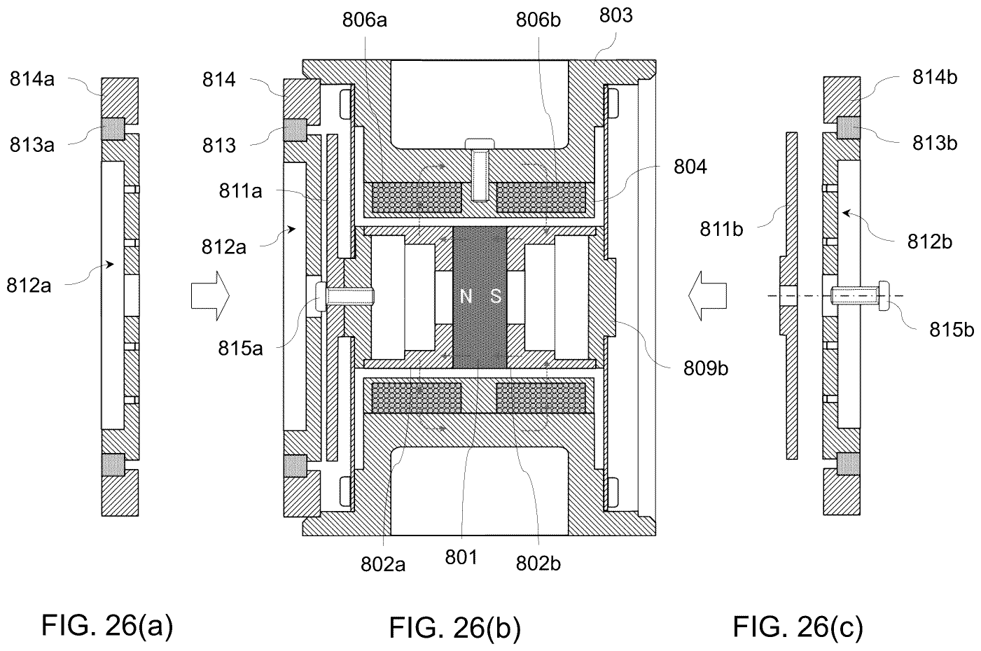

FIG. 26 is a view illustrating that the MM servo-type acceleration sensor applied to the present embodiment can be easily changed to a differential type only by replacing the left or right fixed-side electrode unit with a fixed-side electrode unit having the microgrooves and by mounting the fixed-side electrode unit having the microgrooves on the remaining side. FIG. 26(a) illustrates a front fixed-side electrode unit, FIG. 26(b) is a front sectional view of a non-differential MM sensor with no microgroove, and FIG. 26(c) illustrates a rear fixed-side electrode unit. On the left side of the sensor main body in FIG. 26(b), the front fixed-side electrode unit includes a front fixed electrode 812, a front insulating ring 813, and a front ring 814 for fastening. When this unit is replaced with the front fixed electrode 812a, the front insulating ring 813a, and the front fastening ring 814a illustrated in FIG. 26(a), the unit is changed to that with microgrooves. Similarly, it is sufficient that the rear movable electrode 811b be fastened to the rear inner peripheral support member 809b, and then the rear fixed-side electrode unit with microgrooves be mounted on the right side of the sensor main body to which the electrodes are not mounted.

Therefore, in the present invention, options of “the change from the electrode unit with no microgroove to that with microgroove” and “the change from non-differential type to the differential type” do not lead to a significant increase in cost. Further, the adjustment of the inter-electrode gap performed at the final stage of mass production, that is, the adjustment of the gap between the rear movable-side electrode 811b and the rear fixed-side electrode 812b can be performed independently of that for the front side. For example, it suffices to adjust the rear side after the adjustment of the front side is completed.

The noise/drift cancelling effect by the differential sensor of the present embodiment and the effect upon application of the present embodiment to the active vibration isolator will be described in detail in [Supplement 2].

### [Embodiment 4] (Application to Swing Sensor)

The specific structure in use of the servo-type acceleration sensor is roughly classified into the following two types: (1) a type in which the mass portion linearly moves, and (2) a type in which the mass portion swings. All the embodiments of the present invention described above fall under a case in which the present invention is applied to the linear motion type of the above (1).

However, even when the present invention is applied to the swing motion type of the above (2), the same effect can be obtained. As exemplified in Patent Literature (4), a swing motion servo-type acceleration sensor is publicly known.

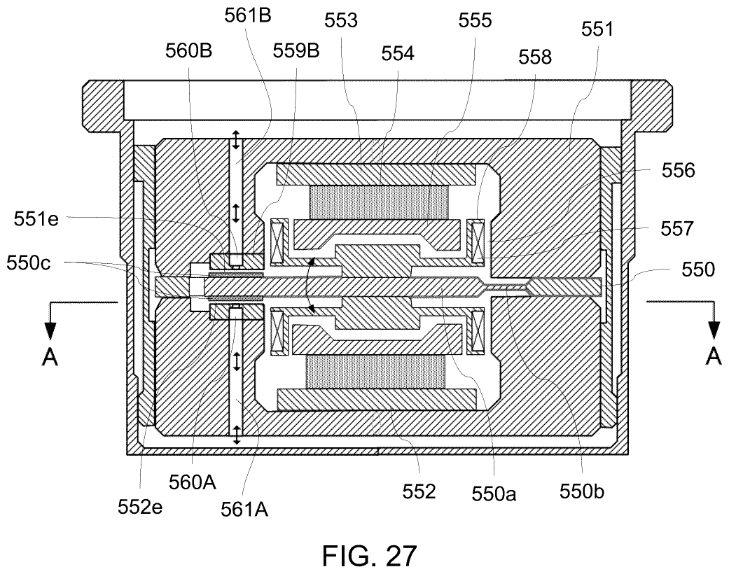

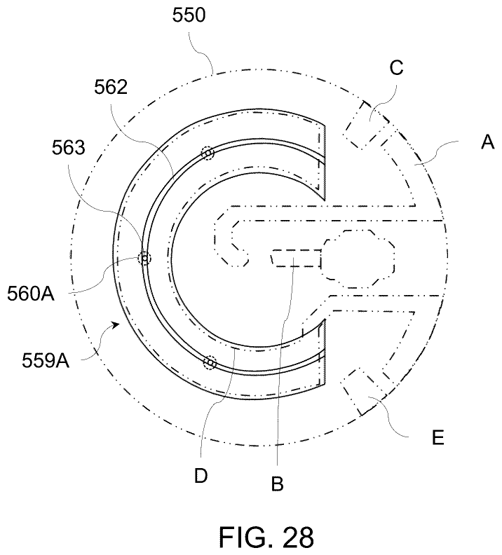

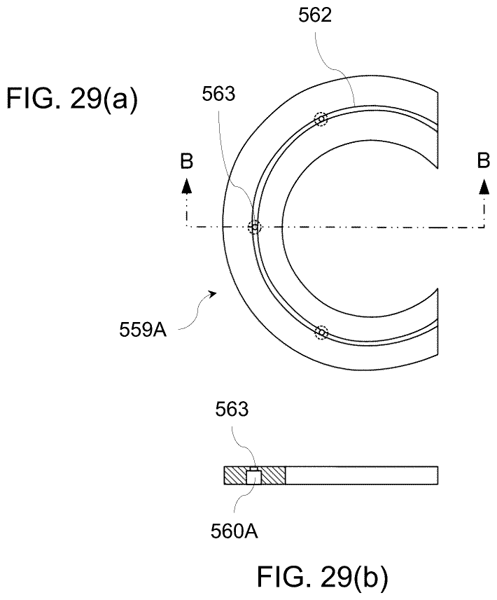

FIG. 27 is a front sectional view of a swing motion servo-type acceleration sensor according to Embodiment 4 of the present invention, and FIG. 28 is a view taken along a line AA in FIG. 27 and viewed in a direction of arrows AA, and illustrating a specific shape of a microgroove attached to a pendulum. FIG. 29 is a view illustrating a semi-arc shaped ring formed with microgrooves, in which FIG. 29(a) is a top view, and FIG. 29(b) is a sectional view taken along a line BB in FIG. 29(a).

### (1) Structure of Swing Motion Sensor

Reference sign 550a denotes a pendulum positioned in the frame of a disc-shaped frame body 550. The pendulum 550a is formed in a tongue shape in which a part of the circumference is cut out, and is supported by the frame body 550 via a hinge 550b. The frame body 550, the pendulum 550a, and the hinge 550b are integrally formed of, for example, quartz glass. The hinge 550b is thin and elastically deformable, and the pendulum 550a can be displaced in the vertical direction in the same drawing by the input acceleration.

Reference signs 551 and 552 denote a pair of magnetic yokes, reference sign 553 denotes a pole piece bottom, reference sign 554 denotes a permanent magnet, and reference sign 555 denotes a pole piece top. The permanent magnet 554 is magnetized in the plate thickness direction thereof. An annular magnetic void 556 is formed between the inner peripheral surface of the open end of each of the magnetic yokes 551 and 552 and the outer peripheral surface of the pole piece top 555. A torquer coil 557 is wound around a coil bobbin 558 so that the coil bobbin 558 is positioned in respective one of the annular magnetic voids 556. The coil bobbins 558 are respectively attached to both plate surfaces of the pendulum 550a. At both plate surfaces of the pendulum 550a, capacitance electrodes 550c are formed in an arc shape along the outer periphery on the tip side of the tongue shape. Reference signs 551e and 552e denote electrode surfaces opposing the respective capacitance electrodes 550c with a predetermined interval. The permanent magnet, the pole piece top, the pole piece bottom, the torquer coil, and the like are disposed vertically symmetrically as illustrated in the same drawing (detailed description is omitted).

In the servo-type acceleration sensor having such a configuration, the displacement of the pendulum 550a due to the acceleration input is detected as a change in capacitance between the capacitance electrodes 550c and the electrode surfaces 551e and 552e. The electrode surfaces 551e and 552e on the fixed side are set to a common potential, detection signals of the capacitance electrodes 550c on both plate surfaces of the pendulum 550a are differentially amplified by a servo amplifier (not illustrated), and a torquer current based on a capacitance difference flows through the pair of torquer coils 557. By the interaction between the torquer current and the magnetic field generated by the permanent magnet 554, the displaced pendulum 550a returns to the original position and is balanced at the neutral point. Since the torquer current at this time is proportional to the acceleration applied to the pendulum 550a, the input acceleration can be obtained from this current. A coil terminal of the torquer coil 557 is bonded and electrically joined to a metal conductor on or above the pendulum 550a.

The servo amplifier includes the electrical damping circuit and the proportional amplifier circuit described in Embodiment 1 of the linear motion acceleration sensor. The electrical damping circuit is provided so as to compensate for a reduction in the mechanical damping effect due to the microgrooves to be described later (not illustrated).

Reference sign 559A denotes a semi-arc shaped ring A mounted to the magnetic yoke 552. Reference sign 559B denotes a semi-arc shaped ring B mounted to the magnetic yoke 551. The semi-arc shaped ring A and the semi-arc shaped ring B are each formed with a microgroove that reduces dynamic pressure (squeeze pressure) due to air viscosity. Each of the semi-arc shaped rings also serves as a fixed-side electrode, and is disposed opposing the capacitance electrode 550c on the movable side.

Reference signs 560A and 560B denote through-holes formed at the semi-arc shaped ring A and the semi-arc shaped ring B, respectively. Reference signs 561A and 561B are through-passages formed at the magnetic yokes 551 and 552, respectively. One of through-passages communicates with the through-hole and the other is open to the atmosphere.

### (2) Structure of Pendulum and Semi-Arc Shaped Ring

In FIG. 28, a conductor portion formed at the pendulum is indicated by imaginary lines, and solid lines indicate a shape of the semi-arc shaped ring 559A in which the microgroove is formed. An arc-shaped pendulum conductor A constitutes one input/output end portion of a torquer current. A pendulum conductor B connects two left and right torquer coils 557 in series, and an arc-shaped pendulum conductor C constitutes the other input/output end of the torquer current. A capacitance detection electrode D is formed in an arc shape along the outer edge of the pendulum 550a on one surface of the pendulum 550a. A capacitance detection electrode E is formed on the other surface of the pendulum 550a in the same manner as the capacitance detection electrode D. End portions of the capacitance detection electrodes D and E are connected to a servo amplifier (not illustrated). Each of the above-described pendulum conductors includes: the frame body 550, the pendulum 550a, and the hinge 550b, all of which are made of quartz glass; and a thin film formed by sputtering or vacuum-depositing gold (Au) on the surfaces of the frame body 550, the pendulum 550a, and the hinge 550b.

In FIG. 28 that is a view taken along a line AA in FIG. 27 and viewed in a direction of arrows AA, the semi-arc shaped ring 559A is disposed at a position surrounding the outer periphery of the capacitance detection electrode D. FIG. 29 illustrates a view of the semi-arc shaped ring 559A alone. Reference sign 562 denotes a microgroove formed at the surface of the semi-arc shaped ring 559A, and reference sign 563 denotes a flow hole formed inside the microgroove. The flow hole 563 of the present embodiment is formed in a circle having the same diameter as the groove width of the microgroove 562, and the air flow path communicates with the through-hole 560A. The flow hole 563 and the through-hole 560A having the same shape are formed at three places in the microgroove 562. That is, similarly to the above-described embodiment, due to the air flow path of “the space inside the microgroove ⇔the flow hole 563⇔the through-hole 560A⇔the through-passage 561A⇔atmospheric pressure”, the spatial pressure inside the microgroove is not affected by the change in the inter-electrode gap and is maintained at atmospheric pressure at any time. As a result, mechanical damping C_{M} between the electrodes is significantly reduced. In the present embodiment, the groove width of the microgroove 562 is formed to be 0.1 to 0.2 mm. Since a total area Sₘ of the groove width is sufficiently smaller than a total area S_{T} of the semi-arc shaped ring 559A in a case in which the microgroove is not formed, the impact on the capacitance is insubstantial.

In the present embodiment, a case in which one microgroove (arc-shaped flow groove) is formed at the semi-arc shaped ring has been described. The measure for reducing squeeze pressure is not limited to this structure. As described in the example of the linear motion servo-type acceleration sensor, the microgroove may be a radial groove. Alternatively, a large number of small-diameter holes may be formed at the semi-arc shaped ring, a space connected to the atmosphere may be provided at the bottom face, and this space and the small-diameter holes may communicate with each other (not illustrated). When the shape of the microgroove is complicated, a pattern of the microgroove is formed at a thin plate by etching. This thin plate may be mounted to a relative movement surface between the movable-side electrode and the fixed-side electrode (not illustrated). Any shape, structure, and processing method can be applied as long as the squeeze pressure generated at the void portion between the electrodes can be reduced.

In the present embodiment, a through-passage is formed at the magnetic yoke as a structure connecting the microgroove and the atmosphere. Instead of this through-passage, a groove (trench) is formed along the outer peripheral side of the semi-arc shaped ring. The trench may be communicated with the atmosphere (not illustrated). The above-described measures can be applied not limited to the linear motion sensor and the swing motion sensor.

### (3) Effects of Present Embodiment

Even in the case of the present embodiment applied to the swing motion type, the same effects as that of the linear motion type described above can be obtained. That is, the following effects can be obtained: (1) a dynamic characteristic improvement effect obtained by a combination of microgrooves and electrical damping, (2) productivity improvement due to relaxation of the requirement on gap accuracy between two electrodes, and the like.

Furthermore, in the case of the swing motion type, when the swing direction of the movable portion is defined as the Z-axis, and the X-axis orthogonal to the Z axis is set, each part constituting the sensor is not “mirror-symmetric” with respect to the center portion of the X-axis. The electrode shape is not “axisymmetric” with respect to the center axis of the electrode surface formed at the pendulum. It has been pointed out that the swing motion type is susceptible to thermal expansion of members due to the asymmetry. However, by setting the mechanical damping to satisfy C_{M}≈0 by using the microgrooves formed at the relative movement surface between the electrodes, it is possible to reduce the impact of a minute change in the inter-electrode gaps due to thermal expansion on the sensor characteristics.

### [Additional Information] Brownian Noise Cancelling Effect

The above-described effect of the present invention is that ideal sensor dynamic characteristics (gain/phase characteristics) can be obtained when the present invention is applied to, for example, a servo-type acceleration sensor as a control element of an active vibration isolator. The principle of this effect has been able to be explained in the scope of viscous hydrodynamics, control engineering, and dynamics of machinery. However, from the perspective of a micro world requiring explanation based on molecular dynamics, it has been found that the present invention has an effect in a different aspect. That is, the present invention has an effect that can maintain, or rather, further improve sensor sensitivity (capacitance) even though the mechanical damping at the inter-electrode gap can be set to C_{M}≈0; thus, this effect is very effective for reducing mechanical noise due to Brownian motion of gas molecules.

### (1) Mechanical Noise Due to Brownian Motion

According to the academic document, the capacitance C that can be set in the capacitive sensor is constrained due to mechanical noise (Brownian noise) resulting from Brownian motion of gas molecules generated from the displacement detector. The magnitude of this noise can be obtained by the following expression.

$$\begin{matrix}[ Mathematical Expression 26 ] & \\ {N}^{2} = \frac{4 KTD}{{M}^{2} {g}^{2}} & ( 26 )\end{matrix}$$

N=Noise power spectrum (g²/Hz)
K=Boltzmann constant (J/K)
T=Absolute temperature (K)
D=Damping constant (Kg/s)
M=Mass (Kg)
g=Acceleration of gravity (m/s²)

The damping constant D in Expression (26) is as follows:

$$\begin{matrix}[ Mathematical Expression 27 ] & \\ D = \frac{3 {μA}^{2}}{8 π {d}^{3}} & ( 27 )\end{matrix}$$

μ=Viscosity (Pas)
A=Area of electrode (m²)
d=Gap between conductor plates (m)

Expression (27) is the same as Expression (6) described above. When the electrode area is increased and the clearance is made small in order to increase the capacitance, the damping constant D increases in proportion to the square of the electrode area A and in inverse proportion to the cube of the clearance d. The increase in the damping constant D increases mechanical noise N in Expression (26). That is, the conventional measure for improving the sensor sensitivity is constrained in an aspect of mechanical noise resulting from Brownian motion (Brownian noise). This is in common with the above-described effect of the present invention (dynamic characteristic improvement) in that the sensor performance is improved without being adversely affected. That is, by applying the present invention, the sensor sensitivity can be improved without increasing the Brownian noise.

### (2) Brownian Noise Reduction Effect of Present Invention

Here, a damping constant of the reference acceleration sensor is defined as Do, a mass of the sensor movable portion thereof is defined as M₀, and a reference value of the noise power spectrum in Expression (26) is defined as N₀.

$$\begin{matrix}[ Mathematical Expression 28 ] & \\ {N}_{0} = \frac{2 \sqrt{{KTD}_{0}}}{{M}_{0} g} & ( 28 )\end{matrix}$$

In order to compare with a sensor having a different damping constant and a different mass of the movable portion, a relative ratio η of the noise power spectrum is defined.

$$\begin{matrix}[ Mathematical Expression 29 ] & \\ η = \frac{2 \sqrt{KTD} / Mg}{2 \sqrt{{KTD}_{0}} {M}_{0} g} = \frac{{M}_{0}}{M} \sqrt{\frac{D}{{D}_{0}}} & ( 29 )\end{matrix}$$

Table 4 provides an example in which the relative ratio η of the noise power spectrum and the relative ratio of the sensor sensitivity between the conventional sensor and the sensors of the present invention are arranged. Note that, instead of the damping constant D, a damping coefficient C that has a unit different from the damping constant D is used.

TABLE 4
Relative ratio of noise power spectrum (Example)

| | | | Conventional | | |
|---|---|---|---|---|---|
| | | | sensor | Sensor of present invention | |
| | | | MC type | MC type (Table 1) | MM type (Table 2) |
| | Symbol | Unit | (Table 1) | (Embodiment 1) | (Embodiment 2) |
| Damping coefficient | C | Ns/m | 3.85 | 0.393 | 1.09 |
| (Damping constant) | | | | | |
| Mass of movable portion | m | Kg | 1.25 × 10⁻³ | ← | 3.75 × 10⁻³ |
| Ratio of sensor sensitivity | | | 1.0 | ← | 4.0 |
| Relative ratio of noise | η | | 1.0 | 0.32 | 0.18 |
| power spectrum | | | | | |

### [Supplement 1] Drift/Noise Reduction Effect by Differential Type

### (1) Case of Conventional Acceleration Sensor

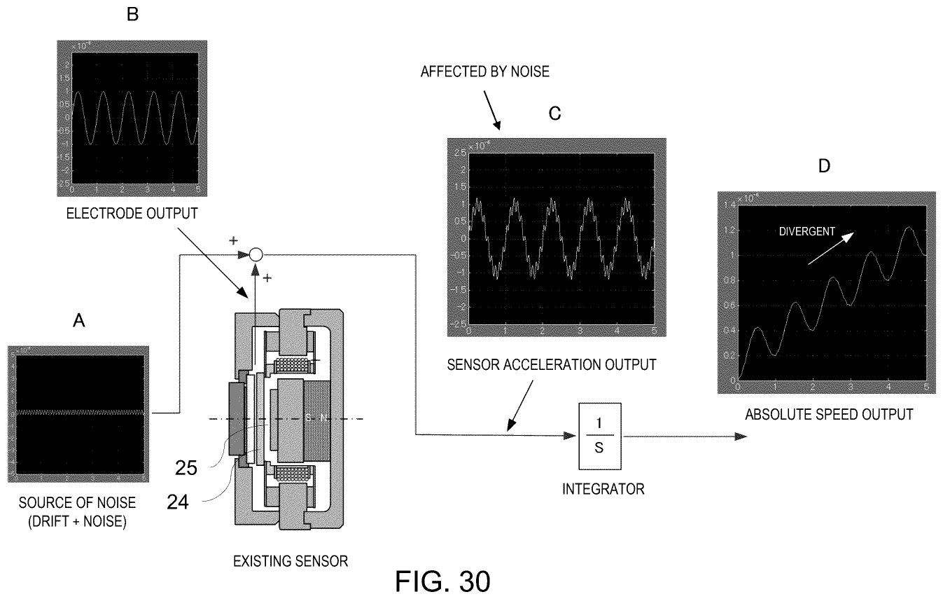

Hereinafter, the drift/noise reduction effect of the sensor of the present embodiment will be described on the basis of comparison with the conventional type. FIG. 30 indicates a relationship between an electrode output, noise and a drift, and a sensor acceleration output in the case of a conventional acceleration sensor (see FIG. 65). The electrode output is obtained by detecting capacitance determined by a gap between the movable-side electrode 24 and the fixed electrode 25. A graph A of noise and a drift is obtained by adding a minute positive bias value to a sine wave. The sensor acceleration output (graph C) is a result of applying noise and a drift (graph A) to the electrode output (graph B).

In the active vibration isolator, absolute speed feedback and absolute displacement feedback are performed in order to obtain vibration isolation performance in a low frequency range. For obtaining an absolute speed signal, an acceleration signal needs to be integrated once. For obtaining an absolute displacement signal, an acceleration signal needs to be integrated twice. A graph D of FIG. 30 indicates an absolute speed output obtained by integrating the sensor acceleration output (graph C) once by complete integration. The speed signal on which the noise is superimposed diverges due to the impact of the drift. In order to solve the above-described problem, in an actual active vibration isolator, a complete integral 1/s cannot be used, and the output of the acceleration sensor is integrated using an incomplete integral 1/(s+a) to obtain an approximate absolute speed signal. Furthermore, a method of integrating the speed signal by a similar integrator to obtain an approximate absolute displacement signal is adopted. However, since the phase characteristics in the low frequency region of the incompletely integrated signal is different from that in the case of the above-described complete integration, an accurate negative feedback signal cannot be obtained. This results in such a problem that sufficient vibration isolation characteristics cannot be obtained because the phase is delayed in the low frequency region and the gain is increased.

### (2) Case of Acceleration Sensor of Present Invention

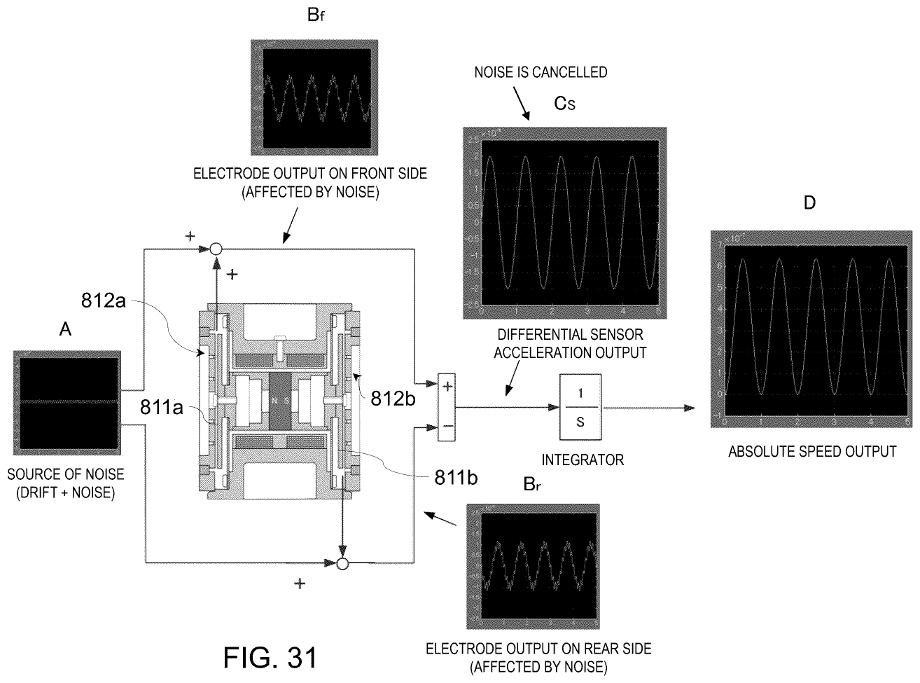

FIG. 31 indicates a relationship between two electrode outputs, noise and a drift, and a sensor acceleration output in the case of the differential acceleration sensor according to Embodiment 3.

An electrode output B_{f} on the front side is obtained by detecting the capacitance determined by the gap between the movable-side electrode 811a and the fixed electrode 812a, and an electrode output Bᵣ on the rear side is obtained by detecting the capacitance determined by the gap between the movable electrode 811b and the fixed electrode 812b. The front electrode output B_{f} and the rear electrode output Bᵣ are obtained by adding noise and a drift to these electrode outputs in common. As a result, an acceleration output Cₛ of the differential sensor has a waveform in which noise and a drift are canceled. An absolute speed signal D and the absolute displacement signal (not illustrated) obtained by completely integrating the acceleration output do not diverge. Therefore, when the acceleration sensor of the present embodiment is applied to the active vibration isolator, the effect of significantly improving vibration isolation characteristics in the low frequency region can be obtained, in addition to the effect resulting from improvement of sensor sensitivity (e.g., improvement of the positioning accuracy of a stage).

The control circuit is not illustrated in the description of Embodiment 3. However, as described in detail in Embodiment 1, the effect of obtaining the conventional ideal sensor dynamic characteristics (gain/phase characteristics) can be similarly obtained by using the sum signal of the proportional amplifier circuit and the differentiation circuit as the sensor output signal.

Further, the MM sensor applied to Embodiment 3 is a linear motion type and has a structure that is a completely “axisymmetric” with respect to the axis of the movable portion. When the axis of the movable portion is defined as the Z-axis, and the X-axis orthogonal to the Z axis is set, each part constituting the sensor is completely “mirror-symmetric” with respect to the center portion of the X-axis. Due to the “axisymmetric” and “mirror-symmetric” structure, the impacts of thermal expansion on the two electrodes on the front side and the rear side are completely the same. Therefore, the differential signals of the two electrodes can avoid the impact of thermal expansion.

### [Supplement 2] Method for Confirming Effect of Applying Present Invention (Part 1)

### 1. Configuration of Present Invention

As described above, the present invention is configured by combining the following a. and b.:
a. To form a plurality of grooves, holes, and the like at the relative movement surface of the fixed-side and movable-side electrodes so as to reduce the dynamic pressure (squeeze pressure) of the air-viscous fluid generated between the electrodes; and
b. To provide a damping unit based on an electrical circuit into the servo amplifier so as to compensate for the reduction in the above-described mechanical damping effect.

In the above a., by actually measuring the groove shape formed at the electrode, or the like, and numerically analyzing the viscous fluid, the damping reduction effect can be theoretically predicted. However, the electrical damping effect of the above b. cannot easily be obtained. As such, the following method is proposed for verifying that the present invention functions effectively by the combination of a. and b. without greatly disassembling the mechanical units of the acceleration sensor.

### 2. Method of Obtaining Damping Coefficient for Inter-Electrode Gap

(1) The operating point of the movable electrode is changed so that the inter-electrode gap h₀ can be changed in a range from the lower limit value to the upper limit value. The operating point is set by using a bias current flowing through the coil. The inter-electrode gap h₀ can be estimated from an actual measurement value of capacitance [see Expression (6) of the present specification].
(2) Under the condition of the operating point set in the above (1), the servo-type vibration detector main body is subjected to sweep excitation to obtain the sensor dynamic characteristics (gain/phase characteristics).
(3) The damping coefficient C is obtained from the peak value of the gain at the resonance point. The damping coefficient C can be obtained from the following expression by obtaining a damping ratio ζ from the graphs of FIG. 11 or FIG. 12 of the present specification.

$$\begin{matrix}[ Mathematical Expression 30 ] & \\ C = 2 ς \sqrt{{mK}_{P}} & ( 30 )\end{matrix}$$

In Expression (30), m is the mass of the sensor movable portion, and K_{P} is a proportional gain including the rigidity of the support spring. The proportional gain K_{P} can be obtained from the relational expression [Expression (5) of the present specification] between a resonance frequency f₀ and the mass m.

Therefore, the damping coefficient C for the inter-electrode gap h₀ can be obtained through the above steps (1) to (3).

### 3. Verification of Effect of Applying Present Invention

The graph of FIG. 6 described above illustrates the obtained damping coefficient C for the inter-electrode gap h₀. The same graph provides comparison between the conventional type with no microgroove (groove) being formed (one-dot chain line) and the present invention with a microgroove being formed (chain line). Here, assume that the mechanical damping of the electrode with a microgroove being formed is C_{M}, and the electrical damping provided in the electrical circuit of the servo amplifier is C_{E}. The hybrid damping C_{T}=C_{M}+C_{E}, obtained by adding the electrical damping C_{E} to the mechanical damping C_{M} is indicated by a solid line.

The value of the electrical damping C_{E} is determined by an electrical circuit irrespective of the inter-electrode gap h₀.

The results indicated in the graph of FIG. 6 is summarized as follows.
(1) In the case of a conventional sensor in which a plurality of grooves (microgrooves), holes, and the like are not formed at the relative movement surface of the electrode, the damping coefficient C_{M} is inversely proportional to the cube of the gap h₀ [Expression (6) of the present specification] and sharply increases as the inter-electrode gap h₀ decreases.
(2) Mechanical damping is sufficiently reduced by forming a plurality of grooves, holes, and the like at the electrode, and electrical damping is provided so as to compensate for the reduction in mechanical damping effect. With this configuration, the damping coefficient C_{T} maintains a substantially constant value. In this case, C_{T}≈C_{E}.

Therefore, if the graph of the damping coefficient C for the inter-electrode gap h₀ is between the above (1) and (2), it can be verified that the present invention is applied.

### [Supplement 3] Method for Confirming Effect of Applying Present Invention (Part 2)

By the following method, it can be verified that the damping unit based on the electrical circuit contributes to the sensor performance so as to compensate for the reduction in the damping effect by the groove or the hole formed between the electrodes.

### 1. Method for Obtaining Each Damping Coefficient

(1) The inter-electrode gap h₀ is estimated from an actual measurement value of capacitance [see Expression (6) of the present specification].
(2) The mechanical damping coefficient C_{M} is obtained for the following two cases by the viscous fluid analysis described in [3-1] of the present specification from the outer diameter of the electrode, the above-described inter-electrode gap h₀ and the shape(s) of the groove and/or the hole formed at the electrode surface. (i) A mechanical damping coefficient when the groove and/or the hole is (are) formed is defined as C_{M}=C_{MA}. (ii) A mechanical damping coefficient when the groove and/or the hole is (are) not formed (conventional sensor) is defined as C_{M}=C_{MB}. In this case, C_{MB}>C_{MA}.
(3) The servo-type vibration detector main body is subjected to sweep excitation to obtain the sensor dynamic characteristics (gain/phase characteristics). The damping coefficient C_{T} is obtained from the dynamic characteristics. The damping coefficient C_{T} is obtained from the damping ratio (as described in [Supplement 2]. The damping coefficient C_{T} includes all of a mechanical damping coefficient C_{M}, an electrical damping coefficient C_{E} incorporated in a servo amplifier, and the damping coefficient C_{ME} attributable to an eddy current generated in a coil bobbin or the like.

### Verification of Application of Present Invention

It is assumed that the “resonance peak value” and the “phase delay”, both of which are evaluation indices of the sensor dynamic characteristics (gain/phase characteristics), satisfy the target specification of the sensor. Note that the damping is assumed to be C_{ME}≈0.
(1) Case of C_{T}≈C_{MB}
(2) Case of C_{MA}<C_{T}<C_{MB}

In the case of the above (1), the electrical damping C_{E} is all replaced with the mechanical damping C_{M}.

In the case of the above (2), the damping coefficient is hybrid damping in which electrical damping C_{E} is added to mechanical damping C_{M}. Both are derived from the graph of FIG. 6 (relationship between the damping coefficient and the inter-electrode gap) of the present specification.

### Second Invention Group Included in Present Specification

The present specification includes a servo-type acceleration sensor according to the following Embodiments 2-1 to 2-5 (second invention group).

### [Embodiment 2-1] Eliminating Disadvantage of Etching (Part 1) Through-Processing of Discontinuous Groove

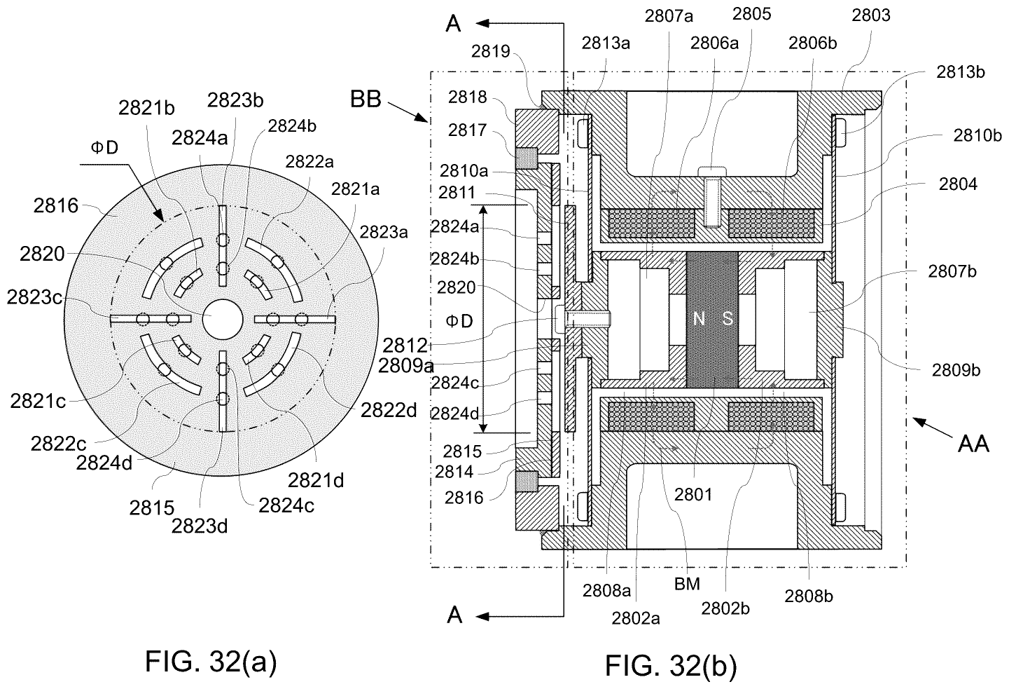

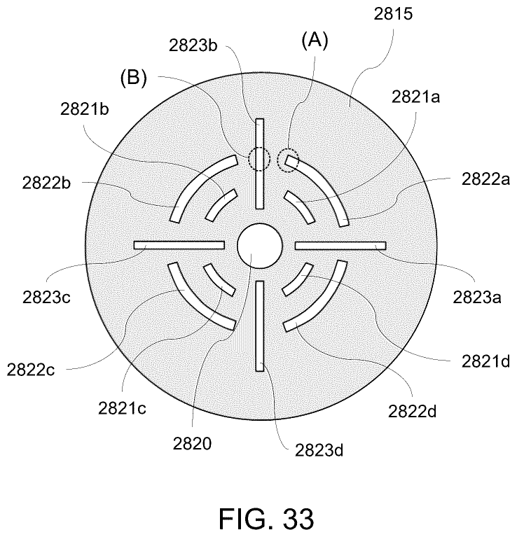

FIG. 32 illustrates an example of a servo-type acceleration sensor according to Embodiment 2-1 of the present invention, in which FIG. 32(a) is a view taken along a line AA in FIG. 32(b) and viewed in a direction of arrows AA, and FIG. 32(b) is a front sectional view of a sensor main body. FIG. 33 is a view illustrating a shape of a single fixed-side electrode plate.

A two-dot chain line AA section in FIG. 32(b) illustrates a moving-magnet (MM) actuator unit that drives the movable portion in the axial direction. A two-dot chain line BB section illustrates a displacement detection unit that detects capacitance. The present invention uses an etching method for a microgroove formed at an electrode to simultaneously achieve the following (i) and (ii): (i) formation of a groove shape with which optimum damping performance can be obtained, and (ii) significant improvement in mass productivity. An application of the MM servo-type acceleration sensor in the present embodiment has been filed by the inventors of the present invention and the application is pending. The actuator unit of the present embodiment is further improved from that of the pending application. Hereinafter, a specific structure of the present embodiment will be described separately for the actuator unit and the displacement detection unit.

### [1-1] Actuator Unit

Reference sign 2801 denotes a permanent magnet magnetized in the axial direction, reference sign 2802a denotes a front pole piece portion, reference sign 2802b denotes a rear pole piece portion, reference sign 2803 denotes a coil-side yoke member, reference sign 2804 denotes a coil bobbin, reference sign 2805 denotes a fastening bolt for fastening the coil bobbin and the coil-side yoke member, reference sign 2806a denotes a front coil, and reference sign 2806b denotes a rear coil. The winding directions of the coils are set such that the directions of Lorentz forces acting on the front coil and the rear coil are identical each other. Reference signs 2807a and 2807b are void portions formed at the center portions of the front and rear pole piece portions 2802a and 2802b. Reference sign 2808a denotes a front magnetic void portion, and reference sign 2808b denotes a rear magnetic void portion, each of which indicates a void in the radial direction between respective one of the two pole piece portions and the coil-side yoke member. A closed-loop magnetic circuit B_{M} is formed by “the permanent magnet 2801→the front pole piece portion 2802a→the front magnetic void portion 2808a→the coil-side yoke member 2803→the rear magnetic void portion 2808b→the permanent magnet 2801”. Reference sign 2809a denotes a front inner peripheral support member of the pole piece portion, reference sign 2809b denotes a rear inner peripheral support member, reference sign 2810a denotes a front disc, and reference sign 2810b denotes a rear disc. Reference sign 2811 denotes a movable-side electrode. Reference sign 2812 denotes a fastening bolt for fastening the movable-side electrode 2811 and the inner peripheral support member 2809a. Reference signs 2813a and 2813b denote bolts for fastening the two discs 2810a and 2810b and the coil-side yoke member 2803 on the outer peripheral side.

The movable portion of the present example includes the permanent magnet 2801, the pole piece portions 2802a and 2802b, and the movable-side electrode 2811. The fixed portion includes the coil bobbin 2804 in which each coil is housed and the coil-side yoke member 2803.

In the acceleration sensor of the present embodiment, a moving magnet type that has been already proposed is used as the drive unit of the above-described movable portion. As is well known, when a current flows through a conductor placed in a magnetic field, Lorentz force, which is an electromagnetic force, is generated. All actuators have, regardless of the type of driving principle thereof, a relative force relationship between the fixed side and the moving side. That is, when one of the fixed side and the moving side is fixed, the other moves. In the present example, when a current flows through the force coils 2806a and 2806b housed in the coil bobbin 2804, a reaction force of Lorentz force for moving the movable portion in the axial direction is generated.

### [1-2] Displacement Detection Unit

In the displacement detection unit (two-dot chain line BB section) in FIG. 32(b), reference sign 2814 denotes a fixed-side electrode base and reference sign 2815 denotes a fixed-side electrode plate. The fixed-side electrode plate is bonded and fixed to the fixed-side electrode base 2814 at an outer peripheral portion 2816. Reference sign 2817 denotes an insulating ring, and reference sign 2818 denotes a fixing ring. The fixed-side electrode base 2814 is held by the fixing ring with the insulating ring interposed therebetween. Reference sign 2819 denotes a portion on which an adhesive is applied for fixing the fixing ring 2818 to the coil-side yoke member 2803.

In the present embodiment, the fixed-side electrode plate is formed to have an outer diameter larger than that of the movable-side electrode 2811. Thus, the fixed-side electrode plate is bonded and fixed to the fixed-side electrode base 2814 at the outer peripheral portion 2816. A discontinuous groove is not formed at the outer peripheral portion 2816, which does not obstruct the bonding and fixation. As will be described later, bolting can also be performed using the outer peripheral portion 2816.

### (1) Etching of Fixed-Side Electrode Plate

In the fixed-side electrode plate 2815, two rows of discontinuous ring-shaped grooves, a center through-hole, and four discontinuous radial grooves are formed by through-etching at the fixed-side electrode plate. FIG. 33 illustrates a shape of a fixed-side electrode plate alone. Reference sign 2820 denotes a center through-hole, and reference signs 2821a, 2821b, 2821c, and 2821d denote discontinuous first ring-shaped grooves equally divided into four portions in the circumferential direction. Similarly, reference signs 2822a, 2822b, 2822c, and 2822d denote discontinuous second ring-shaped grooves equally divided into four portions in the circumferential direction. Four discontinuous radial grooves are formed at the fixed-side electrode plate in addition to the above-described two rows of discontinuous ring-shaped grooves. Reference sign 2823a denotes a discontinuous first radial groove, reference sign 2823b denotes a discontinuous second radial groove, reference sign 2823c denotes a discontinuous third radial groove, and reference sign 2823d denotes a discontinuous fourth radial groove.

In the electrode surface of the present embodiment, the microgrooves are formed in the form of both the discontinuous circumferential groove and the discontinuous radial groove. This is for reducing the increase in the damping effect when the inter-electrode gap is narrowed to improve the sensor sensitivity. The same or similar method can be used to respond to a case in which the electrode outer diameter is increased for improving the sensor sensitivity.

### (2) Hole Processing of Fixed-Side Electrode Base

Through-holes for setting the above-described pressure inside the groove to atmospheric pressure are formed at the two rows of the discontinuous ring-shaped grooves and the four discontinuous radial grooves formed at the fixed-side electrode plate 2815 in the fixed-side electrode base 2814. For example, reference signs 2824a and 2824b denote through-holes for the discontinuous second radial groove, and reference signs 2824c and 2824d denote through-holes for the discontinuous fourth radial groove. These through-holes are formed to be larger than the groove width. The same applies to the through-holes communicating with the other grooves (detailed description is omitted).

In the present embodiment, the continuous ring-shaped grooves and the through-holes are not formed at the fixed-side electrode 217 by machining. Instead, the discontinuous ring-shaped grooves and the discontinuous radial grooves are formed at the fixed-side electrode plate 2815, which is a thin plate, by through-etching. The through-holes communicating with the discontinuous grooves and atmospheric pressure is formed at the fixed-side electrode base 2814. Therefore, these discontinuous grooves can maintain atmospheric pressure at all times. According to the present invention, the following effects can be obtained.

(1) Capability to Form a Groove Shape with which Optimum Damping Performance can be Obtained.

For example, when the electrode outer diameter is further increased and the inter-electrode gap is further decreased to obtain higher sensor sensitivity, the damping due to squeeze pressure further increases. In order to reduce this damping, not only the ring-shaped groove (FIG. 2 (a)) as described in the Embodiment 1 but also, for example, a radial groove is required. It is assumed that, for example, the groove having a groove width h_{G}=about 0.1 mm is formed for reducing a decrease in capacitance as much as possible. In the case of machining, application of lathing is difficult, and end milling with high production cost is required for both the ring-shaped groove and the radial groove. In the present invention, however, the microgrooves are formed by etching. Therefore, the selection of the number and shape of the grooves does not affect the production cost.

Furthermore, the damping performance (damping coefficient C) required in the present invention can be selected from many options. When the outer diameter of the electrode and the inter-electrode gap are determined, the allowable range of the damping performance (damping coefficient C) for obtaining the optimum gain/phase characteristics is very narrow. This is because, as described above, the following three items (i) resonance peak value, (ii) phase delay, and (iii) sensor sensitivity, which are the sensor dynamic characteristics, are in a trade-off relationship. Too large damping causes overdamping and increases the phase delay in the above (ii). Insufficient damping increases the resonance peak value in the above (i). Further considering the sensor sensitivity in the above (iii), the allowable range of the damping performance (value of the damping coefficient C) is very narrow. The shape of the microgroove for obtaining the predetermined damping coefficient C under predetermined conditions can be predicted with high accuracy by the viscous fluid analysis described above. The etching pattern has no constraints including those imposed on machining, and any shape can be selected. Therefore, according to the present invention, an electrode with a microgroove having the best damping performance can be provided at low cost.

### (2) Excellence in Mass Productivity

Through-etching makes it possible to simultaneously produce several tens of electrodes with a microgroove (fixed-side electrode plate in FIG. 33), which are joined to one metal plate having a large area. It suffices to cut a junction (bridge) between individual single plates in use. Therefore, excellent mass productivity can be ensured, and a significant cost reduction can be achieved, as well as variation in damping performance (damping coefficient C) can be made very small.

In the present embodiment, four discontinuous radial grooves are formed in addition to two rows of the discontinuous ring-shaped grooves. In the present embodiment, the flow path connecting the “portion at which no groove is formed” and the “groove” can be sufficiently narrowed. For example, as illustrated in FIG. 33, the distance between a left end of the first ring-shaped groove 2822a (A) and the second radial groove 2823b (B) can be sufficiently reduced. If one plate is not divided by the formation of the grooves, there is no problem in practical use, and the viscous fluid resistance at flow paths between the grooves [between (A) and (B)] can be reduced. Therefore, the discontinuous ring-shaped groove in the present embodiment may be considered as a “pseudo circumferential groove” as compared with a circumferential groove described in Embodiment 1. In addition, since the pressure inside each groove is maintained at atmospheric pressure due to the through-hole communicating with the atmosphere, a sufficiently large effect of reducing the damping effect can be obtained. On the other hand, when the damping effect is too large, the damping effect can be adjusted by increasing the distance between the discontinuous grooves, for example, the distance between the above (A) and (B).

### [Supplement: Bolted Structure]

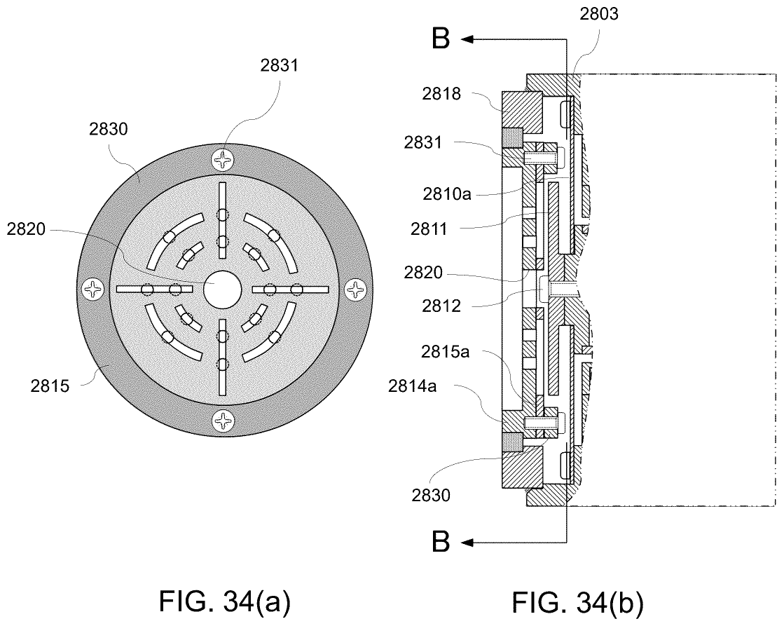

FIG. 34 illustrates the fixed-side electrode plate being bolted to the fixed-side electrode base without significantly changing the structure of the present embodiment. FIG. 34(a) is a sectional view taken along a line BB in FIG. 34(b) and viewed in a direction of arrows BB, and FIG. 34(b) is a front sectional view illustrating only an electrode portion. Reference sign 2830 denotes a ring for fastening, and reference sign 2831 denotes a fastening bolt. The fixed-side electrode plate 2815a is fixed to the fixed-side electrode base 2814a by fastening bolts 2831 with the rings 2830 for fastening interposed therebetween.

### [Embodiment 2-2] Fixed-Side Electrode Made of One Through-Etched Plate

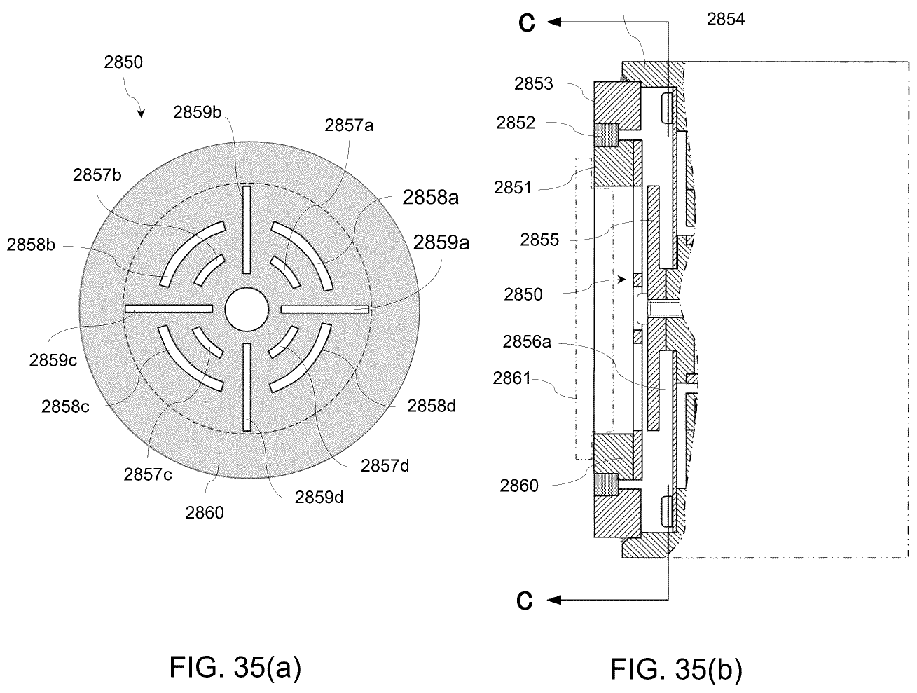

FIG. 35 illustrates an example of a servo-type acceleration sensor according to Embodiment 2-2 of the present invention. A fixed-side electrode is formed with only one plate formed with grooves by etching. FIG. 35(a) is a view taken along a line CC in FIG. 35(b) and viewed in a direction of arrows CC, and FIG. 35(b) is a front sectional view illustrating only an electrode portion.

Reference sign 2850 denotes a fixed-side electrode plate, reference sign 2851 denotes a fixed-side electrode base, reference sign 2852 denotes an insulating ring, reference sign 2853 denotes a fixing ring, reference sign 2854 denotes a coil-side yoke member, reference sign 2855 denotes a movable-side electrode, and reference sign 2856a denotes a front disc. Similarly to Embodiment 2-1, the fixed-side electrode plate 2850 includes discontinuous first ring-shaped grooves (2857a to 2857d), discontinuous second ring-shaped grooves (2858a to 2858d), and discontinuous radial grooves (2859a to 2859d). The fixed-side electrode plate is bonded and fixed to the fixed-side electrode base at a bonding portion 2860.

In the present embodiment, each discontinuous groove (microgroove) formed at the fixed-side electrode plate is directly open to the atmosphere on the opposite side of the movable electrode side. Therefore, the through-hole for connecting the groove and the atmosphere as described in the above embodiments is unnecessary. When the electrode includes a through-hole connecting the groove and the atmosphere, a groove width h_{G} needs to be set so that a viscous fluid resistance Rₘ is sufficiently small to allow air to flow along the groove. The larger the groove width h_{G} is, or the larger the number of grooves is, the lower the effective area of the capacitance is. In the present embodiment in which each groove is open to the atmosphere at the back face, the viscous fluid resistance can be set to Rₘ=0. As a result, since each groove width h_{G} can be made sufficiently small, the impact of the capacitance due to the formation of the microgrooves can be sufficiently reduced. Provided, however, that the shape of the discontinuous groove needs to satisfy the following conditions:
(i) To maintain strength that prevents the fixed-side electrode plate from being deformed or divided even when the discontinuous groove is formed; and
(ii) To set f_{P}>fₙ, where f_{P} is a primary resonance frequency when the outer peripheral portion of the single fixed-side electrode plate is fixed, and fₙ is a resonance frequency determined by a mass m of the movable portion of the entire acceleration sensor and a proportional gain K_{P} of the servo amplifier.

As described above, the resonance frequency of the servo-type acceleration sensor is generally set with a limitation of fₙ=350 to 500 Hz. When the shape of the discontinuous groove is selected so as to satisfy the above (ii), the impact on the sensor dynamic characteristics (gain/phase characteristics) can be avoided.

### [Supplement]

In FIG. 35(b), reference sign 2861 denotes an air filter (imaginary line) mounted to the opening of the fixed-side electrode base 2851. This air filter is mounted to prevent dirt, dust, and the like from entering the inter-electrode gap and maintain a clean state of the inter-electrode gap at all times. The effect of mounting the air filter can be applied to all the embodiments of the present invention. The mounting position of the air filter is not limited to the fixed-side electrode base.

### [Embodiment 2-3] Microgrooving Using Double-Side Half Etching

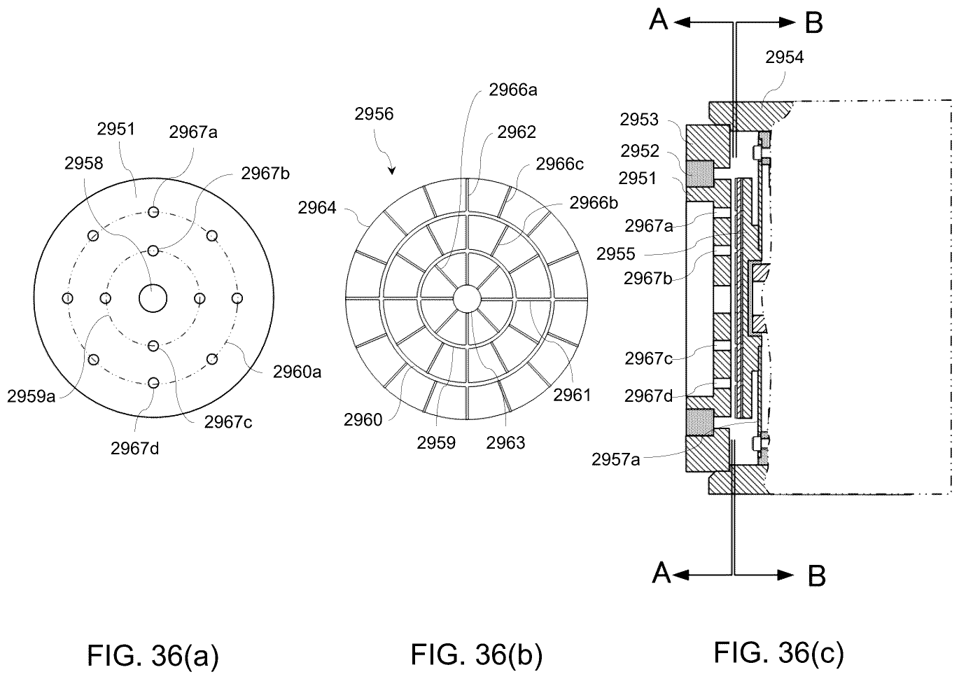

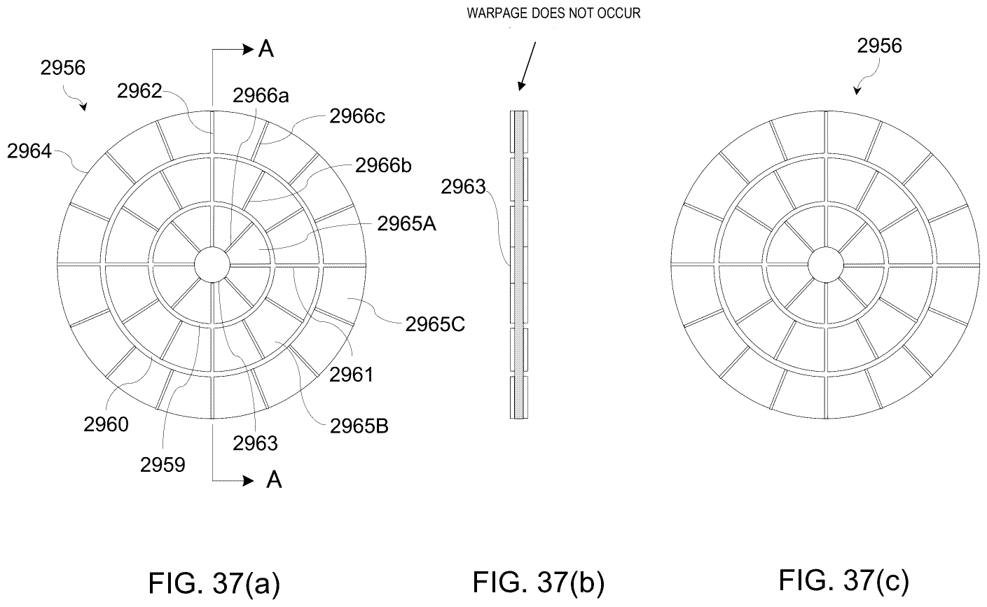

FIG. 36 illustrates an example of a servo-type acceleration sensor according to Embodiment 2-3 of the present invention. Microgrooves are formed at a plate surface by microgrooving using double-sided half etching. FIG. 36(a) is a view taken along a line AA in FIG. 36(c) and viewed in a direction of arrows AA, FIG. 36(b) is a view taken along a line BB in FIG. 36(c) and viewed in a direction of arrows BB, and FIG. 36(c) is a front sectional view of a sensor main body illustrating only an electrode portion. FIG. 37 illustrates a shape of the single plate, in which FIG. 37(a) is a front view of the plate, FIG. 37(b) is a side view thereof, and FIG. 37(c) illustrates a back face of FIG. 37(a).

Reference sign 2951 denotes a fixed-side electrode base, reference sign 2952 denotes an insulating ring, reference sign 2953 denotes a fixing ring, reference sign 2954 denotes a coil-side yoke member, reference sign 2955 denotes a movable-side electrode, reference sign 2956 denotes a movable-side electrode plate, and reference sign 2957a denotes a front disc. Reference sign 2958 denotes a center through-hole formed at the fixed-side electrode base.

On the front face and the back face of the movable-side electrode plate 2956, the following various grooves and recesses at the center portion are formed symmetrically. FIG. 37(a) illustrates the front face of the movable-side electrode plate 2956. A first ring-shaped groove 2959 and a second ring-shaped groove 2960 are formed concentrically at the front face of the movable-side electrode plate 2956. Two grooves of a horizontal-direction radial groove 2961 and a vertical-direction radial groove 2962 are formed in a cross shape around the axis. Reference sign 2963 denotes a recess formed at the axis portion, and reference sign 2964 denotes an outer peripheral portion of the movable-side electrode plate 2956. A section between the recess 2963 and the first ring-shaped groove 2959 is defined as an A section 2965A, a section between the first ring-shaped groove 2959 and the second ring-shaped groove 2960 is defined as a B section 2965B, and a section between the second ring-shaped groove 2960 and the outer peripheral portion 2964 is defined as a C section 2965C. For example, a plurality of radial grooves are formed in such a manner that a radial groove 2966a is formed in the section A, a radial groove 2966b is formed in the section B, and a radial groove 2966c is formed in the section C.

In FIG. 36(a), a through-hole connected to the atmosphere is formed at the fixed-side electrode base 2951. Reference sign 2959a denotes a first ring-shaped groove equivalent circle, and reference sign 2960a denotes a second ring-shaped groove equivalent circle. Through-holes communicating with atmospheric pressure, for example, 2967a, 2967b, 2967c, and 2967d are formed at positions of the two equivalent circles. These through-holes allow the first ring-shaped groove 2959 and the second ring-shaped groove 2960 to maintain atmospheric pressure. These through-holes, including the center through-hole 2958, may be formed by etching. FIG. 37(c) illustrates a back face (reference signs for detailed parts in the drawing are omitted) of the movable-side electrode plate, and the back face has the same groove shape as the front face (corresponding to FIG. 36(b)). The back face is fixed to the movable-side electrode base 2955 by using an adhesive.

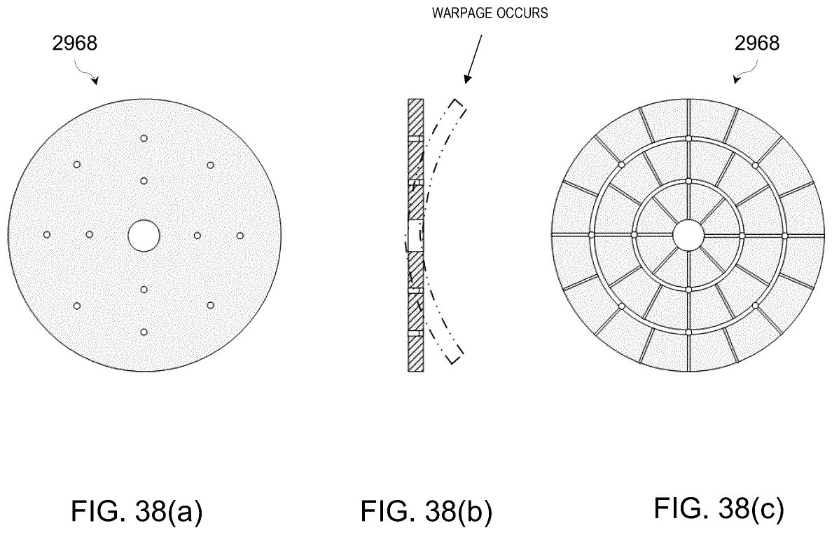

In the present embodiment in which microgrooves are formed at the plate surface by microgrooving using double-sided half etching, the following effects (1) to (3) can be obtained.
(1) Capable of selecting optimum groove shape. Unlike the above-described through-etching method, fine and complicated continuous grooves can be formed. Accordingly, it is possible to form optimum microgrooves that can reduce the damping effect of a larger squeeze pressure.
(2) Capable of eliminating warpage of substrate. As illustrated in FIG. 38(b), in the case of single-sided half etching, when the substrate is thin, the rigidity decreases, and warpage due to residual stress occurs. In the present embodiment to which double-sided half etching is applied, warpage of the substrate (movable-side electrode plate 2956) can be eliminated. FIG. 38 illustrates a case in which microgrooves are formed at a movable-side electrode plate 2968 by one-side half etching and with through-holes, in which FIG. 38(a) is a front view of the movable-side electrode plate 2968, FIG. 38(b) is a side view thereof, and FIG. 38(c) is a back-side view thereof.
(3) Capable of achieving increase of adhesive strength. The back face (FIG. 37(c)) of the movable-side electrode plate 2956 at which the microgrooves are formed by double-sided half etching is bonded and fixed to the movable-side electrode base. It is found that this configuration can greatly increase the adhesive strength by flowing the adhesive into the flow groove of the movable-side electrode plate 2956.

### [Embodiment 2-4] Forming Large Number (n) of Small-Diameter Holes at Electrode Surface and Finely Adjusting Damping Effect by Increasing or Decreasing the Number n

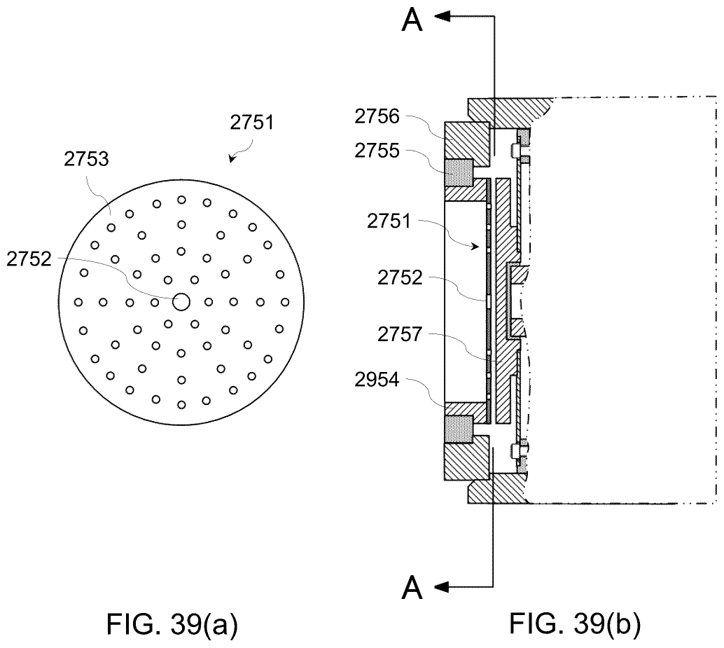

FIG. 39 illustrates an example of a servo-type acceleration sensor according to Embodiment 2-4 of the present invention, in which FIG. 39(a) is a view taken along a line AA in FIG. 39(b) and viewed in a direction of arrows AA, and FIG. 39(b) is a front sectional view of an acceleration sensor.

The embodiment described above provides a case in which the ring-shaped groove or the cross-shaped radial groove is formed at the electrode surface in order to reduce the dynamic pressure of the air-viscous fluid. In the present embodiment, reduction in squeeze pressure is achieved by forming only a large number of through-holes instead of also forming a continuous groove shape. The point of the present embodiment is that the effect of reducing squeeze pressure is adjusted not by the number of ring grooves or the like but by the number n of through-holes. The through-holes is disposed axisymmetric so that a moment load due to damping force is not applied to the electrodes. The damping effect (damping coefficient) decreases as the number n of the through-holes increases, and conversely, the damping effect (damping coefficient) increases as the number n decreases. By setting n in this way, the damping coefficient can be finely adjusted.

In FIG. 39(a), reference sign 2751 denotes a fixed-side electrode including a thin disc, and reference sign 2752 denotes a center through-hole. In the present embodiment, the number n=52 of through-holes 2753 are formed at the fixed-side electrode 2751. In FIG. 39(b), reference sign 2754 denotes an inner peripheral-side fixing ring, reference sign 2755 denotes an insulating ring, reference sign 2756 denotes an outer peripheral-side fixing ring, and reference sign 2757 denotes a movable-side electrode. A disc-shaped fixed-side electrode 2751 is fixed to an opposing face of the movable-side electrode of the inner peripheral-side fixing ring 2754. When a total area of the through-holes is defined as ΔS, an area excluding ΔS from the total electrode area S_{A} is an effective area S_{E} as the capacitive sensor. When the thickness of the movable-side electrode is reduced, the hole diameter of the through-hole may be sufficiently small. When an electrode outer diameter is set to Φ13 mm, the total electrode area S_{A}=133 mm². In the case in which the through-hole diameter Φ is 0.1 mm, when the number of the through-holes is assumed to be n=52, the total area ΔS=0.41 mm². The effective area as a capacitive sensor is S_{E}=132.6 mm², and the rate of decrease in capacitance is only 0.3%. When the through-hole diameter Φ is 0.3 mm, ΔS=3.67 mm², and the rate of decrease in capacitance is 2.76%. In both cases, the rate of decrease in capacitance is a negligible value.

### [Embodiment 2-5] Measuring Inclination of Electrode by Multi-Electrode Structure

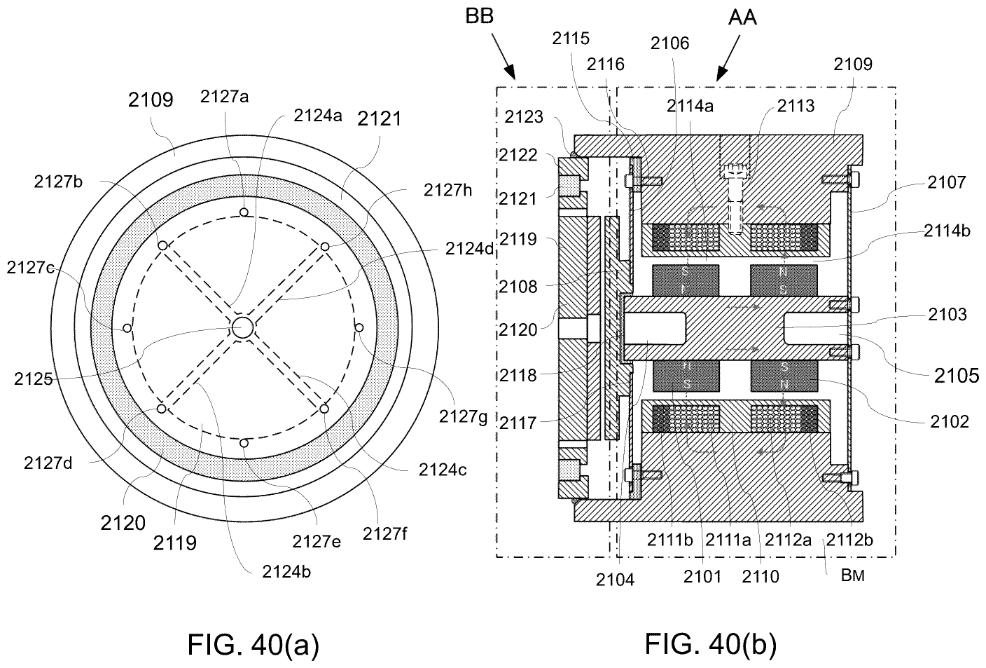

FIG. 40 illustrates an example of a servo-type acceleration sensor according to Embodiment 2-5 of the present invention. By mounting a plurality of independent electrodes to an electrode surface, an inter-electrode gap and an inclination angle can be measured from the capacitance of each electrode. FIG. 40(a) is a front view of the sensor main body, and FIG. 40(b) is a front sectional view. A one-dot chain line AA section in FIG. 40(b) illustrates a moving-magnet (MM) actuator unit that drives the movable portion in the axial direction. A two-dot chain line BB section illustrates a displacement detection unit that detects capacitance.

### [1-1] Configuration of Actuator Unit

In the actuator unit (one-dot chain line AA section) in FIG. 40b, reference sign 2101 denotes a front permanent magnet, reference sign 2102 denotes a rear permanent magnet, and reference sign 2103 denotes a pole piece portion (movable-side yoke member). Both the front permanent magnet and the rear permanent magnet includes a plurality of segment permanent magnets each magnetized in the radial direction, and are mounted to the pole piece portion 2103. The magnetization directions of the front permanent magnet 2101 and the rear permanent magnet 2102 in the radial direction are opposite to each other. Reference signs 2104 and 2105 denote cylindrical void portions formed on the left and right of the pole piece portion 2103 in order to reduce the weight of the pole piece portion. Reference sign 2106 denotes a front disc, reference sign 2107 denotes a rear disc, reference sign 2108 denotes a movable-side electrode supported by the front disc, reference sign 2109 denotes a coil-side yoke member, reference sign 2110 denotes a coil bobbin, reference sign 2111a denotes a front force coil, reference sign 2111b denotes a front verification coil, reference sign 2112a denotes a rear force coil, reference sign 2112b denotes a rear verification coil, and reference sign 2113 denotes a coil bobbin fastening bolt (indicated by an imaginary line).

Reference sign 2114 denotes a magnetic void portion formed between the inner peripheral surface of the coil bobbin 2110 and the two permanent magnets. Reference sign 2114a denotes a front magnetic void portion, and reference sign 2114b denotes a rear magnetic void portion. As indicated by chain line arrows, a closed-loop magnetic circuit B_{M} is formed by “the rear permanent magnet 2102→the rear magnetic void portion 2114b→the coil-side yoke member 2109→the front magnetic void portion 2114a→the permanent magnet 2101→the pole piece portion 2103→the rear permanent magnet 2102”. The front disc 2106 also serves as a conductive path for supporting the movable portion and detecting capacitance. In order to detect a minute capacitance signal between the movable-side electrode 2108 and the fixed-side electrode (to be described later), a conductive path coupling the movable-side electrode 2108 and the outside is completely electrically insulated. That is, the front disc 2106 is fastened to the coil-side yoke member 2109 using a bolt 2116, with an outer peripheral ring 2115 interposed therebetween. The outer peripheral ring 2115 is made of a non-conductive material, and the front disc 2106 and the outer peripheral ring 2115 are fixed in advance using an adhesive. By making the diameter of the bolt hole formed at the front disc 2106 larger than the bolt diameter, the bolt 2116 and the front disc 2106 are electrically insulated. The movable-side electrode 2108 is bonded and fixed to the front disc 2106 at a junction 2117. The center portion of the movable-side electrode 2108 is bonded and fixed to the end face of the pole piece portion with a non-conductive material 2118 interposed therebetween. Although an eddy current is generated at the pole piece portion and the coil-side yoke member, the capacitance signal between the two electrodes (movable side and fixed side) can avoid the impact of the eddy current by the electrical insulation countermeasure (non-conductive materials 2115 and 2118). Examples of applicable non-conductive materials include mica, porcelain (ceramics), glass, and polyimide (engineering plastic), all of which are inorganic solid insulating materials. In order to control the current flowing through the two force coils 2111a and 2112a as well as the verification coils 2111b and 2112b, the lead wires of these coils pass through the coil-side yoke member 2109 and are coupled to a control circuit installed outside (not illustrated).

The movable portion of the present example includes the two permanent magnets 2101 and 2102, the pole piece portion 2103, and the movable-side electrode 2108. The fixed portion includes the coil bobbin 2110 in which each coil is housed and the coil-side yoke member 2109.

### [1-2] Configuration of Displacement Detection Unit

In the displacement detection unit (one-dot chain line BB section) in FIG. 40(b), reference sign 2119 denotes a fixed-side electrode base and reference sign 2120 denotes a fixed-side electrode plate. The fixed-side electrode base 2119 is made of a non-conductive material (ceramic material). The fixed-side electrode plate is bonded and fixed to the fixed-side electrode base. Reference sign 2121 denotes an insulating ring, and reference sign 2122 denotes a fixing ring. The fixed-side electrode base is held by the fixing ring with the insulating ring interposed therebetween. Reference sign 2123 denotes a portion on which an adhesive is applied for fixing the fixing ring 2121 to the coil-side yoke member 2109.

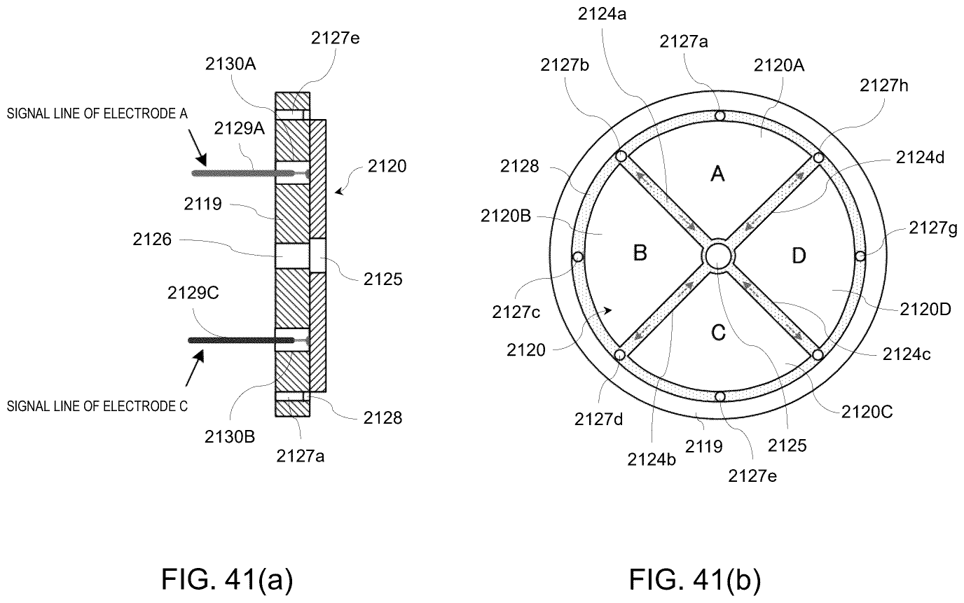

FIG. 41 illustrates a state in which the fixed-side electrode plate 2120 is mounted to the fixed-side electrode base 2119, in which FIG. 41(a) is a side sectional view, and FIG. 41(b) is a front view. The fixed-side electrode plate 2120 includes four independent electrodes. In FIG. 41(b), reference sign 2120A denotes a fixed electrode A, reference sign 2120B denotes a fixed electrode B, reference sign 2120C denotes a fixed electrode C, and reference sign 2120D denotes a fixed electrode D. Reference sign 2124a denotes a groove between the fixed electrode A and the fixed electrode B, reference sign 2124b denotes a groove between the fixed electrode B and the fixed electrode C, reference sign 2124c denotes a groove between the fixed electrode C and the fixed electrode D, and reference sign 2124d denotes a groove between the fixed electrode D and the fixed electrode A. Each of the grooves concurrently exerts the following effects of (1) and (2): (1) electrical insulation between the electrodes, and (2) reduction in the squeeze pressure of the air-viscous fluid. Reference sign 2125 denotes a center through-hole formed at the fixed-side electrode plate, and reference sign 2126 denotes a center through-hole formed at the fixed-side electrode base 2119. Reference signs 2127a to 2127h denote eight flow holes formed at the outer peripheral portion of each of the fixed electrodes. A circumferential groove 2128 is formed at an outer peripheral portion of each of the fixed electrodes so as to house these flow holes.

In FIG. 41(a), reference signs 2129A and 2129C denote signal lines for detecting the capacitances of the fixed electrode A and the fixed electrode C. Reference signs 2130A and 2130C are through-holes for drawing out the signal lines. The same or similar signal lines and through-holes are formed at the fixed electrode B and the fixed electrode D (not illustrated).

### [2] Fabrication of Fixed-Side Electrode Plate by Etching Method

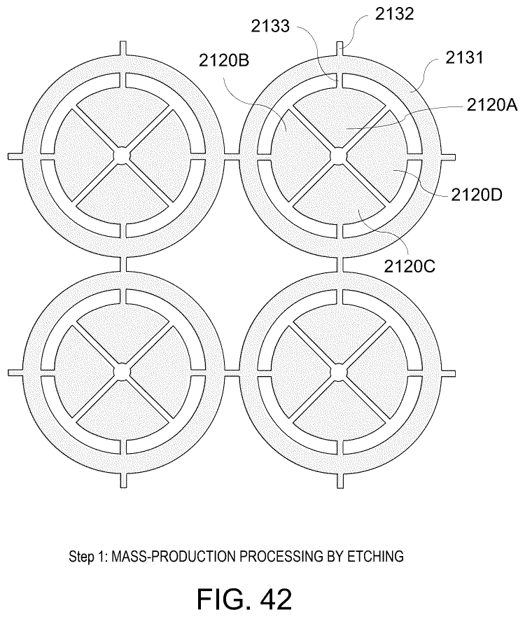

Hereinafter, an example in which the fixed-side electrode plate is mass-produced by an etching method will be described with reference to FIGS. 42 to 45.

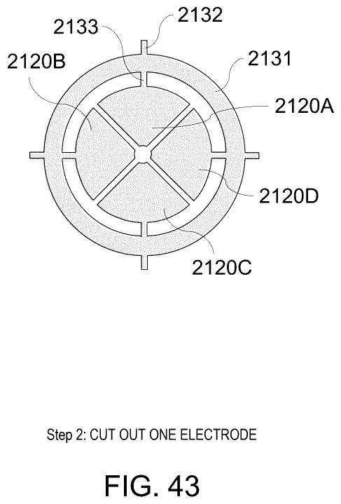

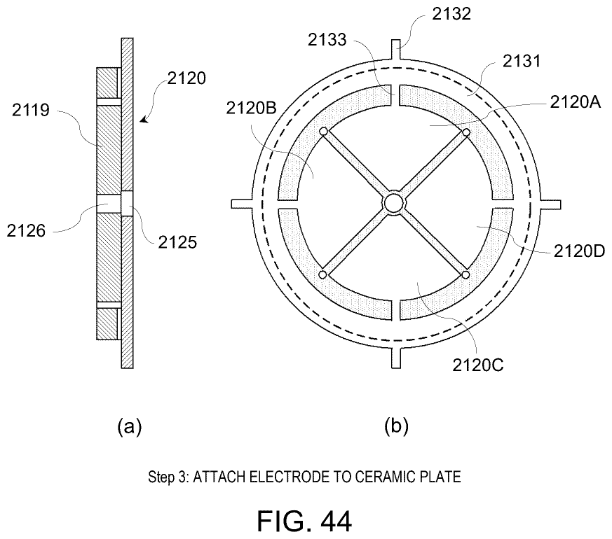

FIG. 42 illustrates “mass-production processing by etching” in Step 1, and illustrates a state in which several tens of etched parts including the fixed-side electrode plate are joined to one metal plate having a large area. Reference sign 2131 denotes a ring-shaped portion, reference sign 2132 denotes a bridge (junction) A connecting this ring-shaped portion and another ring-shaped portion (not illustrated), and reference sign 2133 denotes a bridge B connecting the ring-shaped portion 2131 and the fixed electrode 2120A. FIG. 43 illustrates a state in which “one electrode is cut out” in Step 2, and illustrates a state in which four of the bridges A between the ring-shaped portions are cut and separated. FIG. 44 illustrates a state in which “the electrode is attached to a ceramic plate” in Step 3. The fixed-side electrode plate including the ring-shaped portion cut and separated in the process of Step 2 is bonded and fixed to the fixed-side electrode base which is a non-conductive material (ceramic material).

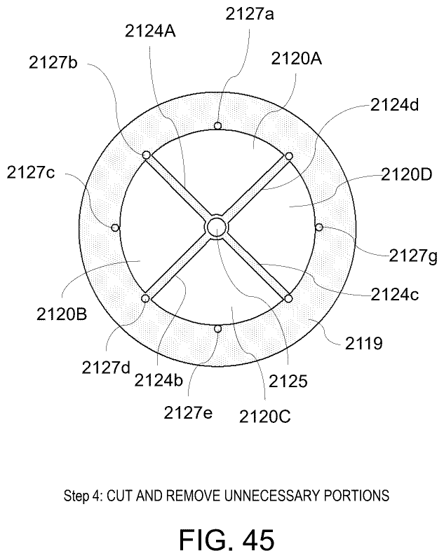

FIG. 45 illustrates a state in which “unnecessary portions are cut and removed” in Step 4. By cutting the bridges B at four positions connecting the ring-shaped portion 2131 and the fixed electrodes 2120A, 2120B, 2120C, and 2120D, the ring-shaped portion 2131 is cut and separated from each fixed electrode.

### [3] Measure Gap Between Electrodes and Inclination Angle

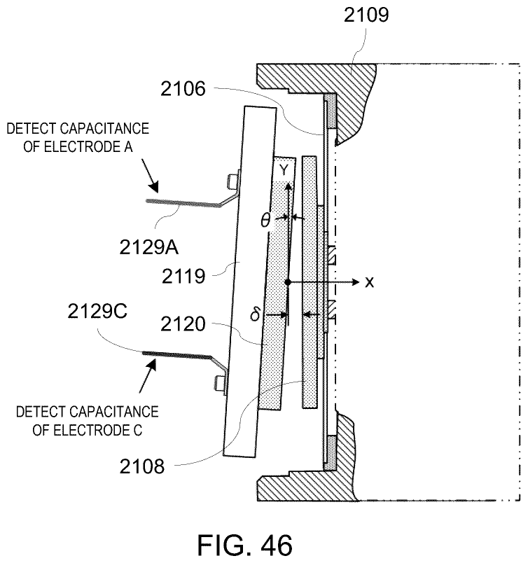

FIG. 46 is a model view illustrating a method for measuring a gap between electrodes and an inclination angle in a sensor of the present invention in which multiple electrodes are incorporated. A Z-axis is defined in a drawing center direction with respect to an X-axis and a Y-axis illustrated in FIG. 46. Further, a Z_{Θ}-axis in a rotation direction around the Z-axis and a Y_{Θ}-axis in a rotation direction around the Y-axis are defined. In this case, the values of the above Z_{Θ} and Y_{Θ} are the inclination angle between each electrode. In the present embodiment, four sets of independent electrodes are disposed in the circumferential direction in order to obtain the values of the above Z_{Θ} and Y_{Θ}.

For example, by measuring the capacitance between the fixed electrode A and the opposing movable-side electrode 2108 as well as between the fixed electrode C and the opposing movable-side electrode 2108, the inclination angle of the inter-electrode gap in the Z_{Θ}-axis direction can be obtained. Similarly, the inclination angle in the Y_{Θ}-axis direction is obtained. In the next process, it suffices to adjust the inclination angle and the position in the X-axis direction of the fixed-side electrode base 2119 so that the values of Z_{Θ} and Y_{Θ}→0 and the capacitance reaches a target value (an adjustment jig or the like is not described). In the mass production assembly process of the conventional acceleration sensor, the absolute value of the inter-electrode gap and the inclination angle of the gap cannot be obtained except that the slit (gap) between electrodes is observed from the outer surfaces of the two electrodes by using an optical means such as a high magnification camera. However, a slit width: d=20 to 30 μm has been the practical measurement limit of the optical method as the gap adjustment unit. Difficulty in adjustment of the inter-electrode gap is an important problem that hinders improvement in sensitivity of the servo-type acceleration sensor, and is a main factor that lowers yield and reliability in mass production.

By applying the sensor structure and the method of the present invention, the absolute value of the inter-electrode gap and the allowable inclination angle can be made sufficiently asymptotically close to the target values. For example, by narrowing only the gap without changing the electrode outer diameter, the capacitance can be increased, and the sensor sensitivity can be improved. Since the etching excellent in mass productivity can be applied to the sensor structure and the method, only the work of drawing out the signal line of each electrode is required, and the cost is not greatly increased. In addition, concerning the behavior of the movable portion during the sensor operation, the change in the capacitance (gap) of each fixed electrode can be observed in real time. This is effective for developing a measure to improve the dynamic stability of the movable portion.

### Third Invention Group Included in Present Specification

The present specification includes a servo-type acceleration sensor according to the following Embodiments 3-1 and 3-2 (third invention group).

### Background Leading Up to Present Invention

The above-described servo-type acceleration sensor (FIG. 66) has a problem in an aspect of production technology related to yield and reliability in mass production, in addition to the adjustment of a gap between electrodes. The problem is attributable to a basic operation principle of a moving coil type (hereinafter referred to as an MC type or MC) in which a sensor signal needs to be transmitted and received between a coil and a fixed side because the coil (16a and 16b) as a movable portion moves. A conductive path that couples the movable portion and the fixed side and through which a plurality of signals flow needs to be formed by using an elastic member (disc-shaped springs 20 and 21) coupling the movable portion and the fixed side. As a result, (1) division of the disc-shaped spring for formation of a plurality of conductive paths, (2) insulation of the signal line, and (3) a complicated production method involving an extra-fine wire soldering process, and the like are required. These requirements are major factors that lower yield and reliability in mass production.

The inventors of the present invention have proposed and filed an application of a moving-magnet (hereinafter, referred to as MM type or MM) servo-type acceleration sensor that does not require an ultrafine wire processing by fixing a coil and making a permanent magnet movable. The filed application is pending. The MM servo-type acceleration sensor has no precedent in the past. This seems to be attributable to a stereotype (blind spot) of “disadvantageous transfer characteristics and responsiveness of the MM type in a high frequency range due to the increased inertial mass of the movable portion”, which can also be regarded as an implicit premise. The already-proposed invention re-examines and takes advantages of this “blind spot” by the ingenuity described as follows. That is, with the following methods including
(1) a magnetic circuit configuration that reduces the weight of the movable portion (movable member),
(2) a magnetic pole shape for reducing the impact of leakage flux, and
(3) finding out a coil specification (the number of turns and the wire diameter) that can achieve both the increase of generative force and the reduction in heat generation by devising an electromagnet structure capable of increasing the coil volume,
disadvantages of the MM type are eliminated, and the sensor performance greatly exceeding that of the MC type can be provided by utilizing the characteristics of the MM type.

In addition to the above-described features of the MM servo-type acceleration sensor, the present invention focuses on a point that both ends of the movable member can have an open structure. That is, the idea of the present invention is originated from a speculation that if the movable member can be fixedly supported by using the “open structure at both ends of the movable member in the axial direction”, an inter-electrode gap may be adjusted with higher accuracy without being limited to the optical measurement means.

### [Embodiment 3-1] (Hereinafter, Description of an MM Type Will be Provided)

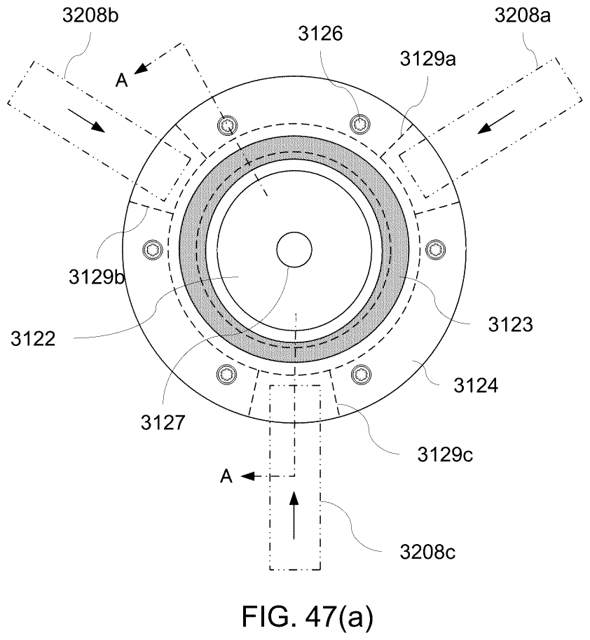

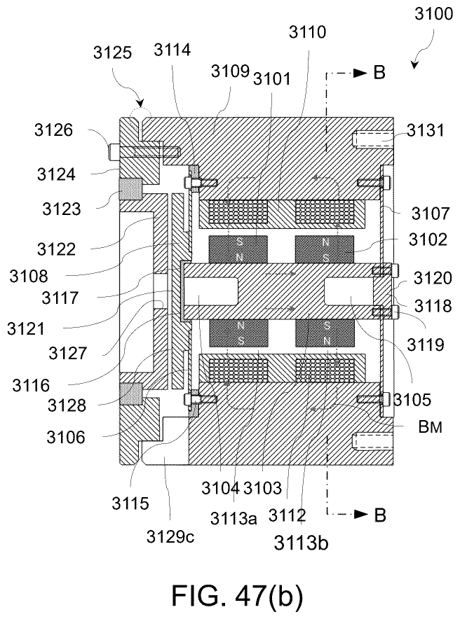

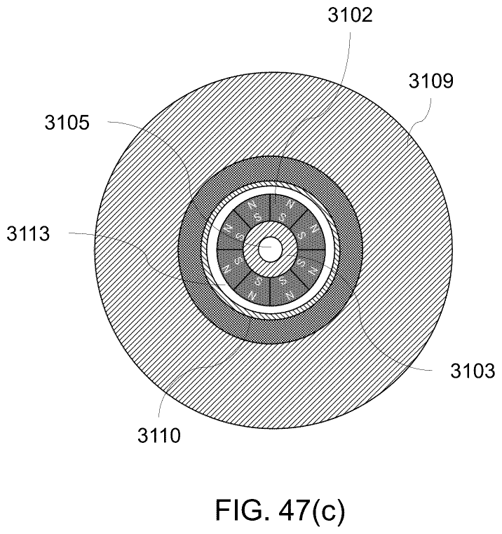

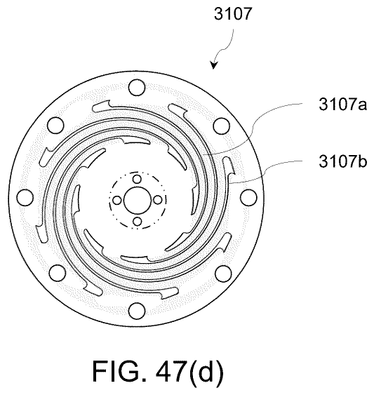

FIG. 47 illustrates an example of an MM servo-type acceleration sensor according to Embodiment 3-1 of the present invention. In the inter-electrode gap adjustment method in the present embodiment, a change in capacitance held by the acceleration sensor itself is used to detect the position of the sensor movable portion in the axial direction.

FIG. 47a is a side view of FIG. 47b, FIG. 47b is a sectional view taken along a line AA in FIG. 47a, FIG. 47c is a sectional view taken along a line BB in FIG. 47b, and FIG. 47d is an external view of a spiral disc spring alone. As described above, an application of the MM servo-type acceleration sensor has been filed by the inventors of the present invention and the application is pending. The actuator unit is further improved from that of the pending application for achieving high-accuracy inter-electrode gap adjustment.

### [1] Sensor Structure of Present Embodiment

### [1-1] Actuator Unit

In FIG. 47b, reference sign 3100 denotes a sensor main unit. Reference sign 3101 denotes a front permanent magnet, reference sign 3102 denotes a rear permanent magnet, and reference sign 3103 denotes a pole piece portion (movable-side yoke member). As illustrated in FIG. 47c, both the front permanent magnet and the rear permanent magnet includes a plurality of segment permanent magnets each magnetized in the radial direction, and are mounted to the pole piece portion 3103. The magnetization directions of the front permanent magnet 3101 and the rear permanent magnet 3102 in the radial direction are opposite to each other. Reference signs 3104 and 3105 denote cylindrical void portions formed on the left and right of the pole piece portion 3103 in order to reduce the weight of the pole piece portion. Reference sign 3106 denotes a front spiral disc spring (hereinafter, the front disc), and reference sign 3107 denotes a rear spiral disc spring (hereinafter, the rear disc). As illustrated in FIG. 47d, the front disc and the rear disc include ridges 3107a and grooves 3107b, both of which form a spiral pattern. The front disc 3106 also serves as a signal transmission path that propagates the electrical signal of the movable-side electrode to a control circuit installed outside. The shape of the spring is not limited to this spiral curve in the present embodiment. This also applies to the embodiments to be described later. It suffices to select a spring structure and specifications with which a low rigidity and a low resonance frequency can be obtained from the characteristics required for an acceleration sensor. For example, a well-known plate spring having a cloud-shaped slit or the like can also be applied. Reference sign 3108 denotes a movable-side electrode supported by the front disc, reference sign 3109 denotes a coil-side yoke member (housing), reference sign 3110 denotes a coil bobbin, reference sign 3111 denotes a front force coil and a verification coil, and reference sign 3112 denotes a rear force coil and a verification coil. The winding directions of the coil 3111 and the coil 3112 are opposite to each other. Reference sign 3113 denotes a magnetic void portion formed between the inner peripheral surface of the coil bobbin 3110 and the two permanent magnets. Reference sign 3113a denotes a front magnetic void portion, and reference sign 3113b denotes a rear magnetic void portion. As indicated by chain line arrows, a closed-loop magnetic circuit B_{M} is formed by “the permanent magnet 3102→the coil-side yoke member 3109→the permanent magnet 3101→the pole piece portion 3103→the permanent magnet 3102”. The front disc 3106 also serves as a conductive path for supporting the movable portion and detecting capacitance. In order to detect a minute capacitance signal between the movable-side electrode 3108 and the fixed-side electrode (to be described later), a conductive path coupling the movable-side electrode 3108 and the outside is completely electrically insulated. That is, the front disc 3106 is fastened to the coil-side yoke member 3109 using a bolt 3115, with an outer peripheral ring 3114 interposed therebetween. The outer peripheral ring 3114 is made of a non-conductive material, and the front disc 3106 and the outer peripheral ring 3114 are fixed in advance using an adhesive. By making the bolt hole diameter formed at the front disc 3106 larger than the bolt diameter, the bolt 3115 and the front disc 3106 are electrically insulated. The movable-side electrode 3108 is bonded and fixed to the front disc 3106 at a junction 3116. The center portion of the movable-side electrode 3108 is bonded and fixed to the end face of the pole piece portion with a non-conductive material 3117 interposed therebetween. Although an eddy current is generated in the pole piece portion and the coil-side yoke member, the capacitance signal between the two electrodes (movable side and fixed side) can avoid the impact of the eddy current by the electrical insulation countermeasure (non-conductive materials 3114 and 3117). Examples of applicable non-conductive materials include mica, porcelain (ceramics), glass, and polyimide (super engineering plastic), all of which are inorganic solid insulating materials. In order to control the current flowing through the two force coils 3111 and 3112, the lead wires of these coils pass through the coil-side yoke member 3109 and are coupled to a control circuit installed outside (not illustrated).

Reference sign 3118 denotes a disc fastening member fastened using a bolt 3119 at a rear end face of the pole piece portion 3103, and reference sign 3120 denotes a rear end face portion located at the center portion of the disc fastening member. Reference sign 3121 denotes a front end face portion located at the center portion of the movable-side electrode 3108.

The movable portion (movable member) of the present embodiment includes the two permanent magnets 3101 and 3102, the pole piece portion 3103, the movable-side electrode 3108, and the disc fastening member 3118. The fixed portion includes the coil bobbin 3110 in which each coil is housed and the coil-side yoke member 3109. In the acceleration sensor of the present embodiment, a moving magnet type (MM type) that has been already proposed is used as the drive unit of the above-described movable portion. As is well known, when a current flows through a conductor placed in a magnetic field, Lorentz force, which is an electromagnetic force, is generated. All actuators have, regardless of the type of driving principle thereof, a relative force relationship between the fixed side and the moving side. That is, when one of the fixed side and the moving side is fixed, the other moves. In the present example, when a current flows through the force coils 3111 and 3112 housed in the coil bobbin 3110, a reaction force of Lorentz force for moving the movable portion in the axial direction is generated.

In the MM sensor of the present embodiment, the permanent magnets and the coils are disposed so as to include the two independent magnetic void portions 3113a and 3113b on the left and right sides of the closed-loop magnetic circuit B_{M}. Disc springs that support the movable portion are also respectively provided at the two left and right places 3106 and 3107. As a natural result, the movable portion including the pole piece portion 3103 has an open structure at both ends in the axial direction.

### [1-2] Displacement Detection Unit

Reference sign 3122 denotes a fixed-side electrode, reference sign 3123 denotes an insulating ring, and reference sign 3124 denotes a fixing ring (a fixed-side electrode support member). The fixed-side electrode 3122 is held by the fixing ring with the insulating ring interposed therebetween. Reference sign 3125 denotes a portion on which an adhesive is applied for fixing the fixing ring 3124 to the coil-side yoke member 3109 (fixed member), and reference sign 3126 denotes a fastening bolt for temporarily fixing the fixing ring 3124 and the coil-side yoke member 3109. Reference sign 3127 denotes a through-hole formed at the center portion of the fixed-side electrode 3122. Reference sign 3128 denotes a void portion between the fixed-side electrode 3122 and the movable-side electrode 3108.

In FIGS. 47a and 47b, reference sign 3129 denotes an opening for inserting a gap adjustment sheet (to be described later) into the void portion (inter-electrode gap) 3128. In the present embodiment, the openings 3129 are formed at three positions (chain lines 3129a, 3129b, and 3129c) in the circumferential direction of the coil-side yoke member (fixed member) 3109. Reference signs 3208a, 3208b, and 3208c denote gap adjustment sheets (two-dot chain line) that are gap adjustment members. In a gap adjustment step (Step 4) to be described later, the gap adjustment sheet is inserted into the void portion 3128 from the opening portion. Through this adjustment process, correction for bringing an inter-electrode gap d close to a target value d₀ (Δd→0) and inclination angle correction of the gap (Δθ→0) are performed. In FIG. 47b, reference sign 3131 denotes a screw-fastening portion for fastening the sensor main unit 3100 to a sensor main unit fixed member (to be described later).

### [2] Attention Point of Present Invention

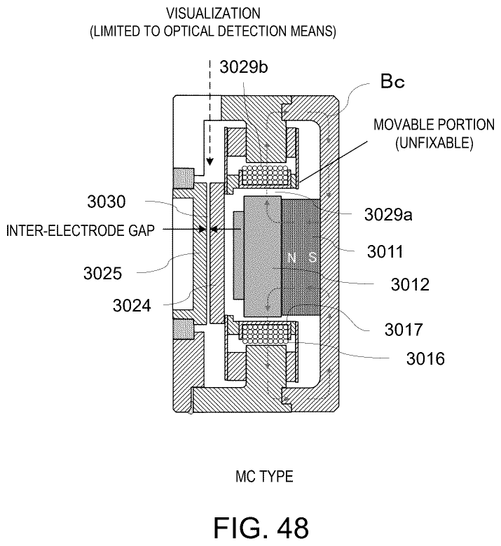

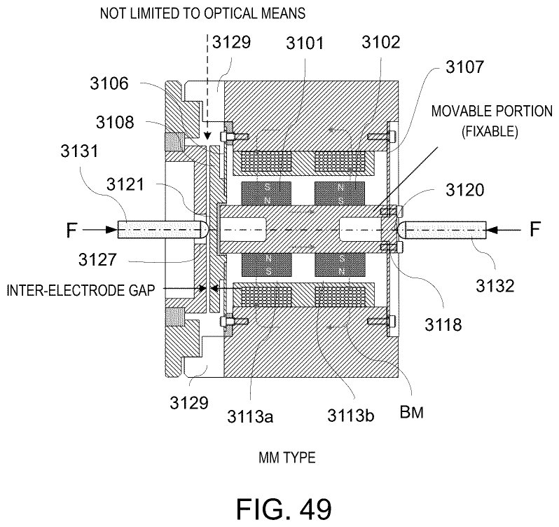

FIG. 48 is a view illustrating that adjustment of a gap between electrodes is limited to optical means in the conventional MC type, and FIG. 49 is a view illustrating that, in an MM type of the present invention, adjustment of a gap between electrodes is not limited to optical means, and the gap is adjusted by pressing both ends of a movable portion to fix the movable portion. Hereinafter, focusing points of the present invention will be described on the basis of comparison between the conventional MC type (FIG. 48) and the MM type of the present invention (FIG. 49).

### (1) Case of Conventional MC Type

As illustrate in an example in the conventional structure of the MC type (FIG. 48), the lightweight movable portion (a coil 3016 and a coil bobbin 3017) to which a movable-side electrode 3024 is mounted is housed so as to surround the fixed portion (a permanent magnet 3011 and a pole piece portion 3012) having a large mass. The reason for adopting this structure is that, as described above, the inertial mass of the movable portion is required to be reduced as much as possible in order to obtain sensor performance with a wide frequency band and high responsiveness. In the above-described structure, there is no means for mechanically fixing the movable portion while maintaining the state in which the movable-side electrode 3024 is inclined by a minute amount at the time of adjustment of a gap between the electrodes. Therefore, the conventional MC type adjusts a gap between electrodes by using optical means (e.g., a high vision microscope) to observe the inter-electrode gap (slit) from the outer surface. That is, it is necessary to select a measure such as adjusting the inclination of the fixed-side electrode so that an inter-electrode gap (void portion 3030) is uniform in the circumferential direction in accordance with the inclined state of the movable-side electrode 3024.

### (2) Case of MM Type of Present Invention

In the case of the MM type of the present invention, attention is paid to the point that both ends of the movable portion can have an open structure. As described above, the reason why both ends of the movable portion can have an open structure is that, in the MM sensor of the present embodiment, the permanent magnets and the coils are disposed so as to include the two independent magnetic void portions 3113a and 3113b on the left and right sides of the closed-loop magnetic circuit B_{M}.

FIG. 49 illustrates a state in which both ends of the movable portion are pressed by applying a force F in the axial direction by the front support rod 3131 and a rear support rod 3132 at the time of adjusting a gap between electrodes. The movable portion includes the two permanent magnets 3101 and 3102, the pole piece portion 3103, the movable-side electrode 3108, and the disc fastening member 3118. The spherical distal ends of the above-described two support rods 3131 and 3132 are in point contact with the front end face portion 3121 and the rear end face portion 3120. That is, the movable portion can be fixed without applying a moment of an external force to the movable portion by the support method of pressing the left and right ends of the movable portion on the same axis. Therefore, in the inter-electrode gap adjustment process of the MM type of the present invention, even when the movable-side electrode 3108 is inclined by a minute amount, the movable portion can be mechanically fixed while maintaining the inclined state. That is, it is expected that a gap adjustment sheet (gap adjustment member) such as a shim, a shim ring, and a spacer used for gap adjustment of a precision machine can be applied.

When both electrodes or one electrode is formed in, for example, a protruding shape, a gap adjustment member can be inserted into a portion having a large inter-electrode distance to adjust the gap. In this case, the gap adjustment member may not have a sheet shape, and may have a block shape with a sufficient thickness (not illustrated).

### (3) Reason why Both Ends of MM Movable Portion can have Open Structure Despite Including Magnetic Circuit

Hereinafter, features of the MM type of the present invention will be considered from comparison of the closed-loop magnetic circuits. In the MM type, a permanent magnet is disposed at a movable portion (pole piece portion 3103), and a coil is disposed at an outer peripheral portion so as to surround the permanent magnet. The reversed arrangement is unfavorable because the inertial mass of the movable portion increases. As illustrated in FIG. 49 in which the permanent magnet is disposed at the movable portion, the closed-loop magnetic circuit B_{M} needs to include the two left and right magnetic void portions 3113a and 3113b. The disc springs 3106 and 3107 for supporting the movable portion (pole piece portion 3103) are also provided at two positions on the left and right. As a natural result, both ends of the movable portion have an open structure (open axes). As described above, the MM type can solve the problem in the MC type related to the ultrafine wire processing but has the disadvantage of the increase in the inertial mass of the movable portion. However, as a result of eliminating the disadvantage of the MM type by the already-filed patent, a measure that can solve another major problem in production technology, that is, a problem relating to the adjustment of a gap between electrodes has emerged. That is, the effect of the present invention relating to the inter-electrode gap adjustment in mass production is a newly found feature of the MM type of the present invention.

### [Embodiment 3-2] (Adhesive-Free Gap Adjustment: Enabling Disassembly/Reassembly by Screw-Fastening)

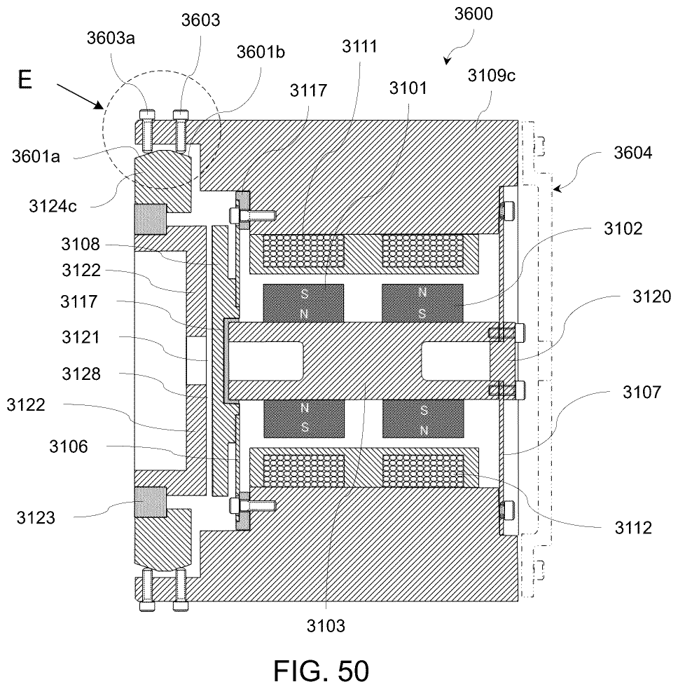

FIG. 50 is an example of an MM servo-type acceleration sensor according to Embodiment 3-2 of the present invention, and illustrates a structure in which the fixed-side and movable-side electrodes are fastened without using an adhesive at the final stage of the inter-electrode gap adjustment process.

### [1] Problem in Conventional Acceleration Sensor

One of the major problems in the conventional acceleration sensor (FIG. 66) is that a high yield cannot be obtained in mass production. As described above in the specific structure (FIG. 66) of the conventional acceleration sensor, the movable portion including the movable-side electrode 24 is manufactured by a bonding method for connecting many parts. The reason for adopting the bonding method is that the inertial mass of the movable portion is required to be reduced as much as possible in order to obtain sensor performance with a wide frequency band and high responsiveness.

In the case of a servo-type acceleration sensor, in order to obtain a product that can undergo performance evaluation, a bonding method needs to be applied to adjustment of an inter-electrode gap at the final stage of a mass production process. It is not easy to detach the bonded parts from the main body again and reproduce the sensor main body in the state before bonding. As a result, there is such a problem that, when a defect is found in the product quality at the stage of the basic performance evaluation or the stage of the reliability evaluation, the basic cycle of “disassembly of a sensor main body→cause investigation→countermeasure→reassembly→reevaluation” cannot be implemented. This problem is attributable to a basic operation principle and a basic structure of a conventional servo-type acceleration sensor. Defect-founded products cannot be reused and need to be discarded, and this is the largest factor that lowers the yield.

### [2] Sensor Structure of Present Embodiment

Since the “actuator unit” and the “displacement detection unit” of the present embodiment have many common parts with those of Embodiment 3-1, the reference signs in the drawing are described only for main parts. A part having a shape different from those of Embodiment 3-1 is denoted by appending a symbol C.

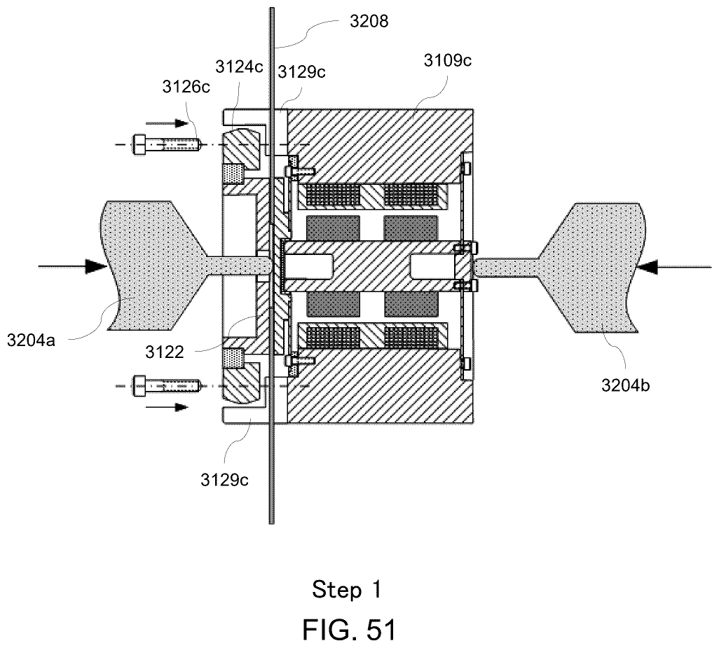

FIG. 50 is a front sectional view of the present embodiment, and FIGS. 51 to 53 illustrate inter-electrode gap adjustment processes (Steps 1 to 3). In FIG. 50, the coil-side yoke member (housing) 3109 is changed to a coil-side yoke member (housing) 3109C, the fixing ring (fixed-side electrode support member) 3124 is changed to a fixing ring (fixed-side electrode support member) 3124C, and the opening 3129 is changed to an opening 3129C (FIG. 51). In the present embodiment, the openings 3129C are formed at three positions (chain lines 3129Ca, 3129Cb, and 3129Cc) in the circumferential direction of the coil-side yoke member (fixed member) 3109C (details are not illustrated). Reference sign 3600 denotes a sensor main unit.

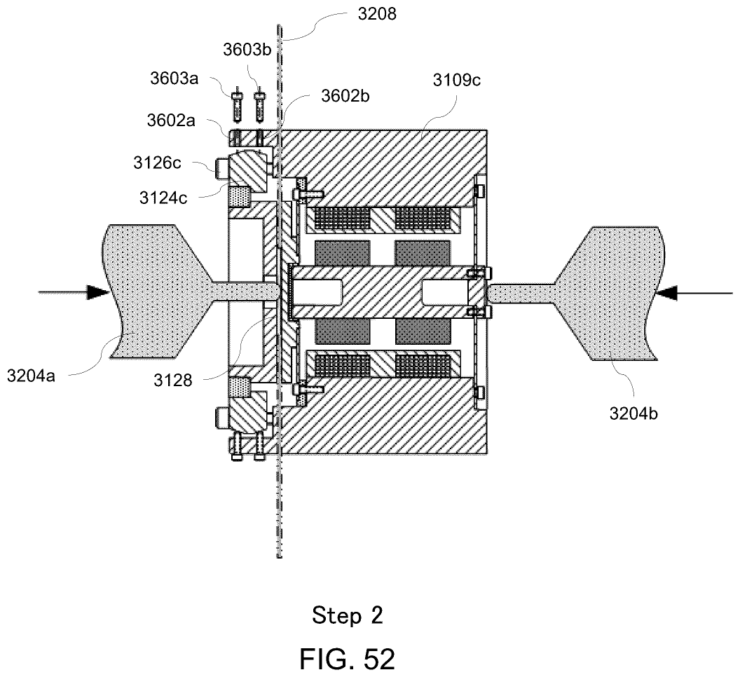

FIG. 50 illustrates a state in which the assembly process of the sensor of the present embodiment is completed, that is, a state in which the fixing ring 3124C is fixed using the bolt attached to the coil-side yoke member 3109C at a position indicated by a chain line circle E. Reference signs 3601a and 3601b denote tapered portions formed at the outer peripheral surface of the fixing ring 3124C, reference signs 3602a and 3602b denote threaded portions (see FIG. 52) formed at the coil-side yoke member 3109C, and reference signs 3603a and 3603b denote radial-direction fastening bolts. Since components in the horizontal direction of vertical drag from the tapered faces by the left and right fastening bolts are balanced between the left and right, the fixed-side electrode 3122 side is reliably fixed to the coil-side yoke member 3109C.

### [3] Example of Gap Adjustment Process

Hereinafter, the description of the present embodiment will be started from a state in which both the left and right ends of the sensor movable portion are already fixed by a front support rod 3204a and a rear support rod 3204b.

### Step 1 Set Inter-Electrode Gap by Shim

In FIG. 51, a shim 3208 is inserted into the inter-electrode gap (void portion 3128) from the opening 3129C, and the fixing ring 3124C and the coil-side yoke member 3109C are fixed by axial-direction fastening bolts 3126C.

Step 2 Fix Movable-Electrode Side and Fixed-Electrode Side with Radial-Direction Fastening Bolts

In FIG. 52, the fixing ring 3124C is fixed from the outer peripheral surface of the coil-side yoke member by the radial-direction fastening bolts 3603a and 3603b while the shim 3208 is inserted into the inter-electrode gap 3128. At this stage, the front support rod 3204a and the rear support rod 3204b that support the movable portion are put in position on both end faces of the sensor main body in the axial direction. However, the positions of the radial-direction fastening bolts 3603a and 3603b are at the outer peripheral surface of the sensor main body, and the work space required for fastening is sufficiently large. Therefore, the fixed-electrode side can be easily fixed by the radial-direction fastening bolts.

Step 3 Release Support Rod, Shim, or Like from Sensor Main Body

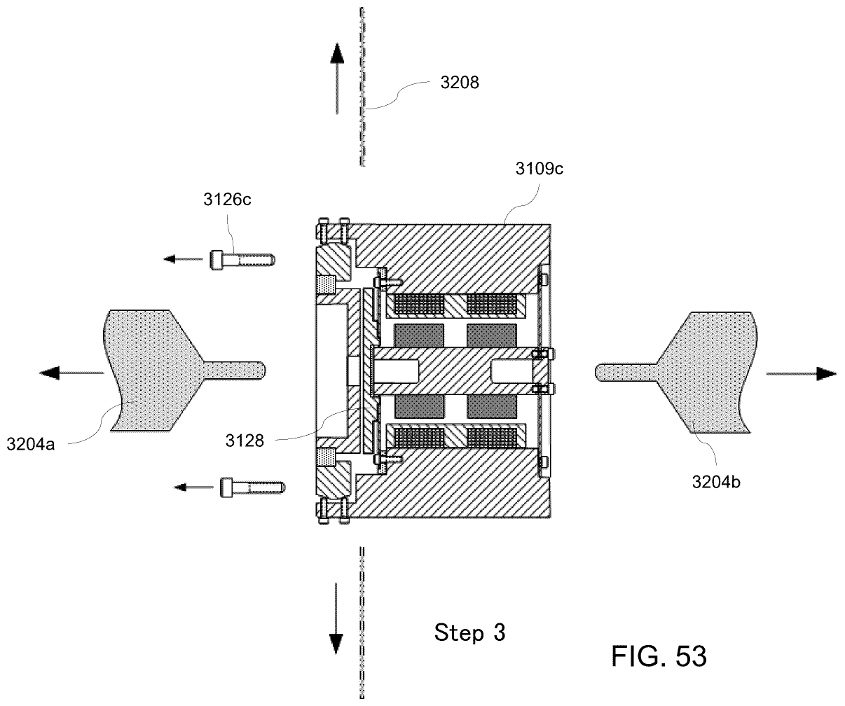

In FIG. 53, the front support rod 3204a, the rear support rod 3204b, and the axial-direction fastening bolts 3126C are removed. Since the sensor movable portion including the movable-side electrode 3108 is not restricted in the axial direction, the shim can be easily released from the sensor main body. At this stage, the process of adjusting a gap between electrodes in which the bonding method is omitted is completed.

After the completion of the process in the above Step 3, the procedure enters a stage at which a product can undergo basic performance evaluation, reliability evaluation, or the like. When a defect is found in a product at the above-described evaluation stage, it suffices to implement the basic cycle of “disassembly of a sensor main body→cause investigation→countermeasure→reassembly→reevaluation”, as described above.

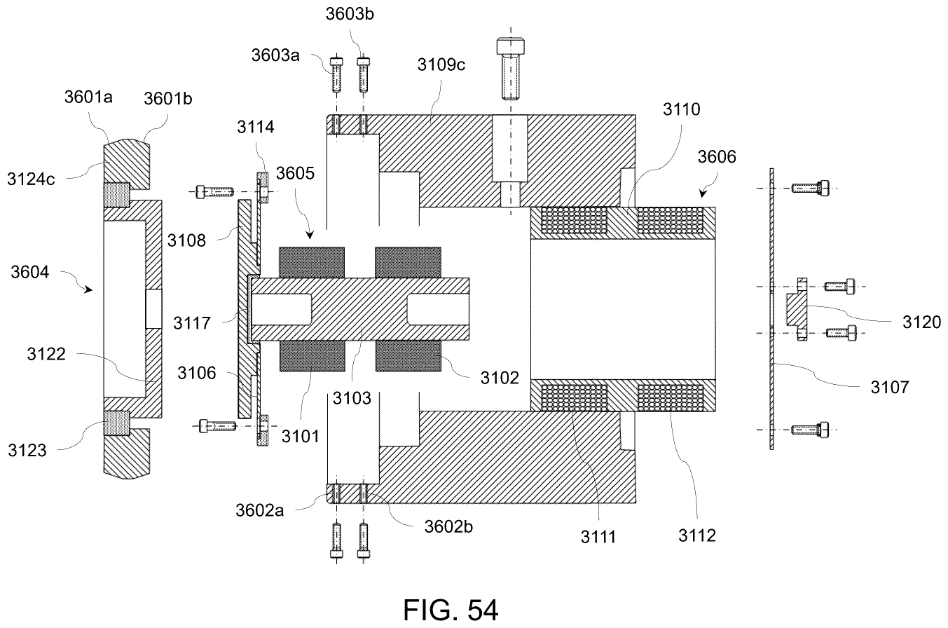

FIG. 54 is a view illustrating a state in which this product is disassembled after the process of Step 3 is completed.

When the present invention is applied to the MM type having an open structure at both ends in the axial direction, the sensor main body can be disassembled not only at the fixed-side electrode member, but also at each part constituting the acceleration sensor and the following unit including a plurality of parts.
(i) A fixed electrode-side unit 3604: Includes the fixed-side electrode 3122, the insulating ring 3123, and the fixing ring 3124C.
(ii) A movable electrode-side unit 3605: Includes the movable-side electrode 3108, the front disc 3106, the pole piece portion 3103, the front permanent magnet 3101, the rear permanent magnet 3102, and the outer peripheral ring 3114.
(iii) A coil unit 3606: Includes the coil bobbin 3110, the front force coil 3111, and the rear force coil 3112.

The coil-side yoke member 3109C, the rear disc 3107, the rear end face portion 3120, and the like can be disassembled on a part-by-part basis.

The above-described unit is configured by fixing a plurality of parts by using an adhesive. The portion to be unitized is limited to a portion requiring weight reduction of the movable portion and electrical insulation between parts. When a defect is found in the quality of a product after completion of the process of Step 3, it suffices to inspect the following items for each of the above-described disassembled units. Examples of items to be inspected in detail include: dust floating in narrow gaps between electrodes, part processing accuracy, basic specifications of each part (disc rigidity, magnetization characteristics of permanent magnet), assembly accuracy (at void portions of the magnetic circuit, and the like), and electrical insulation characteristics (at the support portions 3114 and 3117 made of an insulating material in the front disc 3106, and the like). As a result, the cause of a defect can be quickly inspected, and each part can be reprocessed and reused. In the case of the conventional servo-type acceleration sensor, as will be described later in Supplement (2), it is not easy to perform not only the inter-electrode gap adjustment process but also the factor investigation when a defect is found. In many cases, the product main body needs to be disposed of.

### [4] Screw-Fastening Structure of Movable-Side Electrode and Movable Member

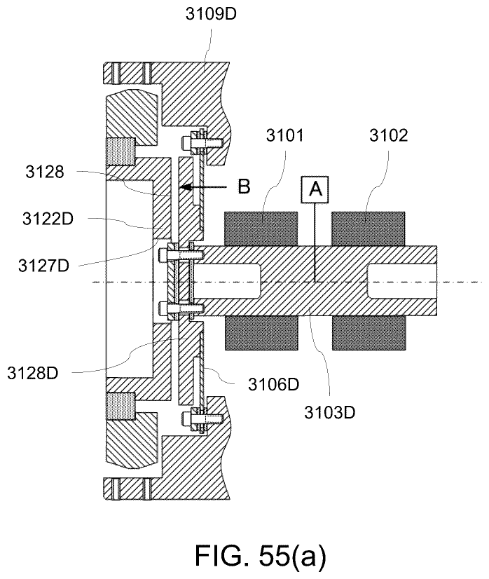

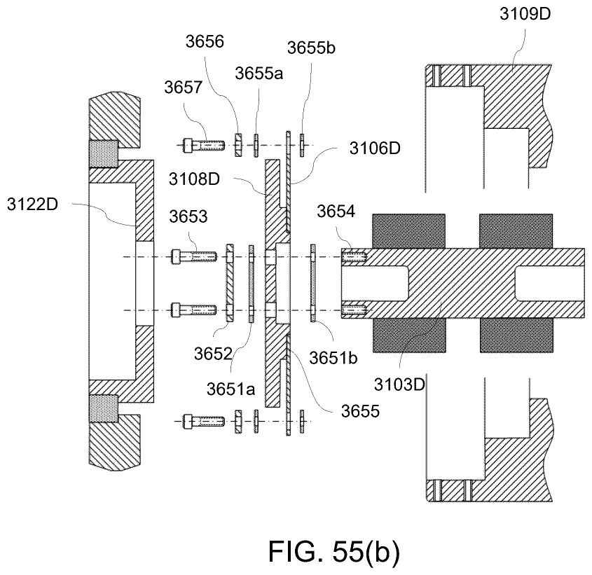

FIG. 55 illustrates a structure obtained by improving Embodiment 3-2 of the present invention described above. This structure is obtained by reconfiguring the movable electrode-side unit 3605 configured by bonding a plurality of parts into a structure that can be further disassembled to screwable elements. FIG. 55a is a front sectional view of a movable-side electrode and the vicinity thereof, and FIG. 55b is an exploded view. Hereinafter, a part having a shape different from that of Embodiment 3-1 is denoted by appending a symbol D. A movable-side electrode 3108D is sandwiched between an insulating sheet 3651a and an insulating sheet 3651b from the front and back, and is fastened to a pole piece portion 3103D using bolts 3653, with a washer 3652 interposed therebetween. Reference sign 3654 denotes a screwed portion formed at an end face of the pole piece portion 3103D. A front disc 3106D is bonded and fixed to the movable-side electrode 3108D in advance at a junction 3655. The front disc 3106D is sandwiched between an insulating sheet 3655a and an insulating sheet 3655b from the front and back, and is fastened to a coil-side yoke member 3109D using a bolt 3657, with a washer 3656 interposed therebetween.

By screwing the movable-side electrode 3108D and the pole piece portion 3103D, high accuracy can be ensured for squareness of an electrode surface B of the movable-side electrode 3108 with respect to an axis A of the movable member (pole piece portion 3103D), as compared with a bonding method in which the thickness tends to be uneven.

In the present embodiment, as a means for maintaining a predetermined inter-electrode gap, the axial-direction fastening bolt 3126C for fastening the fixing ring 3124C and the coil-side yoke member 3109C is used in order to insert the gap adjustment sheet 3208 into the inter-electrode gap 3128 and maintain a state of pressing the fixed-side electrode 3122 against the movable-side electrode 3108. Instead of this method, as a gap adjustment unit, a state of a predetermined inter-electrode gap being maintained may be measured by an optical method using the opening 3129C, and the fixed-electrode side may be screw-fastened in a state in which a position in the axial direction and an angle of the fixed electrode 3122 are constrained by another means. In any method, inter-electrode gap adjustment without using an adhesive can be achieved by utilizing the sensor structure of the present invention.

In the acceleration sensor of the present invention, as long as it can be confirmed that the mass production specification can be reliably satisfied after the quality evaluation, an adhesive may be used to prevent the fastening bolts 3603a and 3603b from being loosened at the screw fastening portions (chain line circle E in FIG. 50) in order to establish higher long-term reliability. Alternatively, a portion for being subjected to application of the adhesive and a portion for fastening the adhesive (for example, the tapered portion 3601a is used) may be separately provided for both members. In this case, the fastening bolts 3603a and 3603b may be detached at the final stage.

In FIG. 50, reference sign 3604 denotes a rear-direction stopper (indicated by an imaginary line) of the movable portion (pole piece portion 3103). In the front direction, the fixed-side electrode 3122 serves as a stopper that prevents the movement of the movable portion. With these two stoppers, when a large acceleration exceeding the measurable range is applied, the displacement of the movable portion in the axial direction can be reduced so that deformation of the front disc 3106 and the rear disc fall within the range of elastic deformation. The rear-direction stopper 3604 may be attached to the sensor main body after the above-described gap adjustment process is completed.

### Fourth Invention Group Included in Present Specification

The present specification includes a servo-type acceleration sensor according to the following Embodiments 4-1 and 4-2 (fourth invention group).

### [Embodiment 4-1] Permanent Magnet Magnetized in Axial Direction

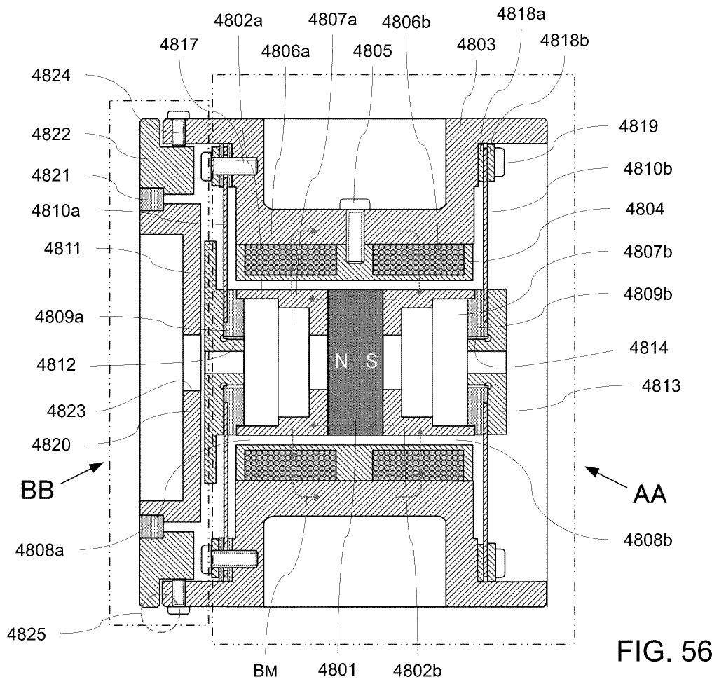

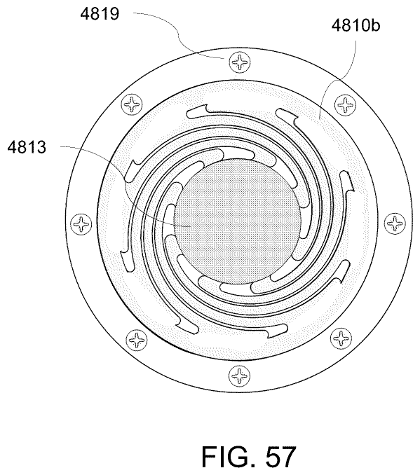

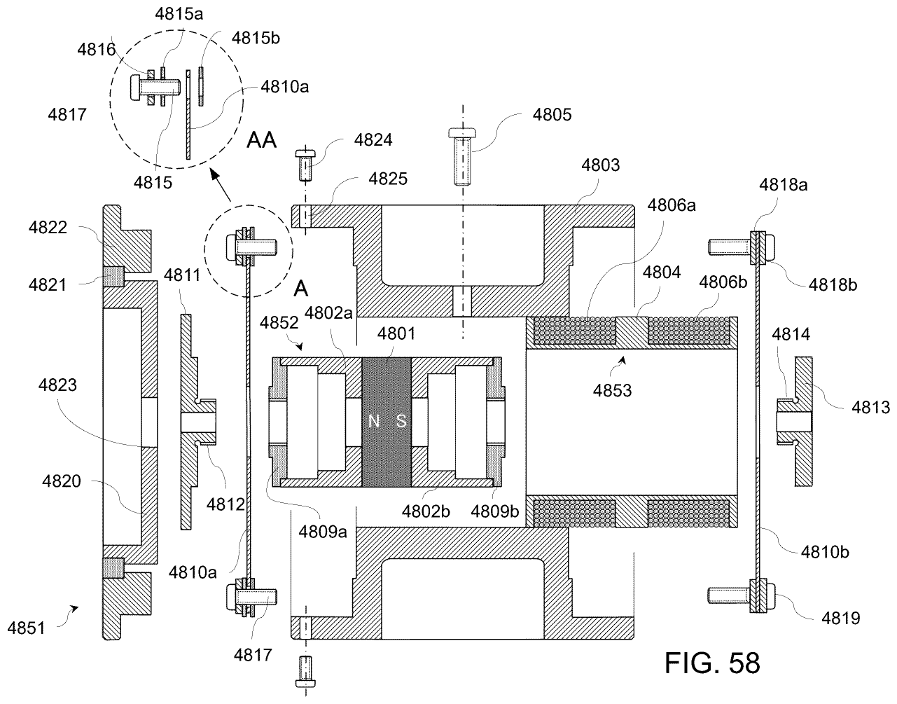

FIG. 56 is a front sectional view of a servo-type acceleration sensor according to Embodiment 4-1 of the present invention. FIG. 57 is an external view illustrating a rear disc having a spiral pattern and a support member, and FIG. 58 is an exploded view illustrating a part configuration of the sensor of the present embodiment. A two-dot chain line AA section in FIG. 56 illustrates a moving-magnet (MM) actuator unit that drives the movable portion in the axial direction. A two-dot chain line BB section illustrates a displacement detection unit that detects capacitance. The MM servo-type acceleration sensor has already been filed by the inventors of the present invention, and the filed application is pending. The present embodiment proposes a new MM sensor structure that is not disclosed in the already-filed application. Hereinafter, a specific structure thereof will be described separately for the actuator unit and the displacement detection unit.

### [1] Sensor Structure of Present Embodiment

### [1-1] Actuator Unit

Reference sign 4801 denotes a permanent magnet magnetized in the axial direction, reference sign 4802a denotes a front pole piece portion, reference sign 4802b denotes a rear pole piece portion, reference sign 4803 denotes a coil-side yoke member (fixed member), reference sign 4804 denotes a coil bobbin, reference sign 4805 denotes a fastening bolt for fastening the coil bobbin and the coil-side yoke member, reference sign 4806a denotes a front coil, and reference sign 4806b denotes a rear coil. The winding directions of the coils are set such that the directions of Lorentz forces acting on the front coil and the rear coil are identical each other. Reference signs 4807a and 4807b are void portions formed at the center portions of the front and rear pole piece portions 4802a and 4802b.

The front pole piece portion and the rear pole piece portion are formed in a stepped hollow shape in order to reduce the weight of the movable portion. A magnetic flux Φ flowing through the closed-loop magnetic circuit is constant, and a magnetic flux density B=Φ/S, where S is a sectional area of the magnetic path. The magnetic flux Φ decreases and the magnetic flux density also decreases as the distance from the permanent magnet increases. Thus, the thickness of a sleeve at or near the opening end of the pole piece portion is reduced within the range of the sectional area ensuring that a magnetic saturation phenomenon does not occur.

Reference sign 4808a denotes a front magnetic void portion, and reference sign 4808b denotes a rear magnetic void portion, each of which indicates a void in the radial direction between respective one of the two pole piece portions and the coil-side yoke member. A closed-loop magnetic circuit B_{M} is formed by “the permanent magnet 4801→the front pole piece portion 4802a→the front magnetic void portion 4808a→the coil-side yoke member (fixed member) 4803→the rear magnetic void portion 4808b→the permanent magnet 4801”. Reference sign 4809a denotes a front inner peripheral support member of the pole piece portion, and reference sign 4809b denotes a rear inner peripheral support member. The front and rear inner peripheral support members are made of a non-conductive material. The front inner peripheral support member and the rear inner peripheral support member are bonded and fixed to the pole piece portions 4802a and 4802b in advance, respectively. Reference sign 4810a denotes a front disc, reference sign 4810b denotes a rear disc, and reference sign 4811 denotes a movable-side electrode. Reference sign 4812 denotes a screw-fastening portion formed between the inner peripheral side of the front inner peripheral support member 4809a and the movable-side electrode 4811. The inner peripheral side of the front disc 4810a is held by screw-fastening between the front inner peripheral support member 4809a and the movable-side electrode 4811. Reference sign 4813 denotes a rear fastener, and reference sign 4814 denotes a screw-fastening portion formed between the inner peripheral side of the rear inner peripheral support member 4809b and the rear fastener. Similarly to the front side, the inner peripheral side of the rear disc 4810b is held by screw-fastening between the rear inner peripheral support member and the rear fastener.

As illustrated in the AA section of FIG. 58, the outer peripheral side of the front disc 4810a is sandwiched between an insulating sheet 4815a and an insulating sheet 4815b from the front and back, and is fastened to the coil-side yoke member 4803 using a bolt 4817, with a washer 4816 interposed therebetween. The outer peripheral side of the rear disc 4810b is sandwiched between a washer 4818a and a washer 4818b from the front and back, and is fastened to the coil-side yoke member 4803 using a bolt 4819. If conversion to a differential type to be described later is considered, it is sufficient that the insulating sheet be applied to fixation of the outer peripheral side of the rear disc 4810b similarly to the front side (not illustrated) in order to make the sensor main body compatible.

The movable portion of the present example mainly includes the permanent magnet 4801, the pole piece portions 4802a and 4802b, the movable-side electrode 4811, and the rear fastener 4813. The fixed portion includes the coil bobbin 4804 in which each coil is housed and the coil-side yoke member 4803. In the acceleration sensor of the present embodiment, a structure obtained by improving the moving magnet type that has been already proposed is used as the drive unit of the above-described movable portion. As is well known, when a current flows through a conductor placed in a magnetic field, Lorentz force, which is an electromagnetic force, is generated. All actuators have, regardless of the type of driving principle thereof, a relative force relationship between the fixed side and the moving side. That is, when one of the fixed side and the moving side is fixed, the other moves. In the present example, when a current flows through the force coils 4806a and 4806b housed in the coil bobbin 4804, a reaction force of Lorentz force for moving the movable portion in the axial direction is generated.

FIG. 57 is an external view illustrating a rear disc having a spiral pattern and a support member applied to the present embodiment. The same applies to the front disc.

### [1-2] Displacement Detection Unit

In the displacement detection unit (two-dot chain line BB section) in FIG. 56, reference sign 4820 denotes a fixed-side electrode, reference sign 4821 denotes an insulating ring, reference sign 4822 denotes a fixing ring, and reference sign 4823 denotes a center through-hole formed at the center portion of the fixed-side electrode. The fixed-side electrode 4820 is held by the fixing ring with the insulating ring interposed therebetween. Reference sign 4824 denotes a positioning bolt of the fixed-side electrode, and reference sign 4825 denotes a tapered portion (to be described later) formed at a boundary between the coil-side yoke member 4803 and the fixing ring. After the inter-electrode gap between the fixed-side electrode 4820 and the movable-side electrode 4811 is set, the fixing ring 4822 is fixed to the coil-side yoke member 4803 by using the positioning bolt 4824.

### [2] Assembly of Sensor Main Body

### [2-1] Configuration of Units

FIG. 58 is a view illustrating a part configuration of the sensor of the present embodiment. The acceleration sensor of the present embodiment is based on the following units including a plurality of parts, and is configured by bolting single parts to these units.
(i) A fixed electrode-side unit 4851: Includes the fixed-side electrode 4820, the insulating ring 4821, and the fixing ring 4822.
(ii) A movable member unit 4852: Includes the front pole piece portion 4802a, the front inner peripheral support member 4809a, the permanent magnet 4801, the rear pole piece portion 4802b, and rear inner peripheral support member 4809b.
(iii) A coil unit 4853: Includes the coil bobbin 4804, the front force coil 4806a, and the rear force coil 4806b.

The fixed electrode-side unit 4851 and the movable member unit 4852 are configured by fixing a plurality of parts by using an adhesive in advance.

### [2-2] Bolting of Unit and Each Single Part

When formation of each unit is completed, the process proceeds to bolting work between each unit and a single part. The coil unit 4853 is fixed at a plurality of positions in the circumferential direction by using the fastening bolts 4805 while being inserted into the center portion of the coil-side yoke member (fixed member) 4803.

At the left end portion of the movable member unit 4852, the movable-side electrode 4811 is screwed to the front inner peripheral support member 4809a in a state in which the front disc 4810a is held. The outer peripheral portion of the front disc 4810a is sandwiched between the insulating sheets 4815a and 4815b from the front and back and screw-fastened to the coil-side yoke member 4803, in order to achieve electrical insulation between the coil-side yoke member 4803 and the disc. By screw-fastening the movable-side electrode 4811 and the movable member unit 4852, high accuracy can be ensured for squareness of the electrode surface of the movable-side electrode 4811 with respect to the axis of the movable member unit and for squareness of the front disc 4810a, as compared with a bonding method for the conventional MC type, in which the thickness tends to be uneven.

Similarly, the right end portion of the movable member unit 4852 is screw-fastened by the rear fastener 4813 while the rear disc 4810b is held. The outer peripheral portion of the rear disc 4810b is sandwiched between the metal washers 4818a and 4818b from the front and back and fixed to the coil-side yoke member 4803. This is because electrical insulation between the coil-side yoke member 4803 and the disc need not be achieved. Note that the insulating sheets 4815a and 4815b may be used instead of the metal washers 4818, in order to have compatibility with a differential type (Embodiment 4-2) to be described later.

### [2-3] Screwing of Fixed-Side Electrode

After the assembly of the actuator unit is completed by the process of the above [2-2], the inter-electrode gap of the displacement detection unit is set. The absolute value of the inter-electrode gap and the inclination angle of the gap is obtained by measuring the slit (gap) between electrodes from the outer surfaces of the two electrodes by using an optical means such as a high magnification camera. With the fixed electrode-side unit 4851 firmly held, the fixing ring 4822 is screwed with the positioning bolt 4824 so as to reserve a predetermined inter-electrode gap by using a jig that can finely adjust the position in the axial direction and angle of the fixed electrode 4820.

Instead of the above-described method, the inventors of the present invention have proposed in another application the following inter-electrode gap adjustment method using the structural features of the MM type. That is, the movable member unit 4852 is fixed from both ends using jigs by utilizing the opening structure of both ends in the axial direction of the MM type. In this state, the gap adjustment sheet is inserted into the inter-electrode gap. The fixed-side electrode 4820 is screwed using the positioning bolt 4824 while the fixed-side electrode is kept pressed against the movable-side electrode 4811 (the above-described method is not illustrated). In any method, inter-electrode gap adjustment without using an adhesive and assembly of the sensor main body by bolting can be achieved by utilizing the sensor structure of the present invention.

### [3] Quality Evaluation of Sensor Main Body

After the completion of the above-described processes, the procedure enters a stage at which a product can undergo basic performance evaluation, reliability evaluation, or the like. When a defect is found in a product at the above-described evaluation stage, it suffices to implement the basic cycle of “disassembly of a sensor main body→cause investigation→countermeasure→reassembly→reevaluation”.

As illustrated in an exploded view of the sensor of the present embodiment in FIG. 58, the sensor main body of the present embodiment can be disassembled not only at the fixed electrode-side unit 4851, but also at the above-described unit including a plurality of parts and individual single parts. It suffices to inspect the following matters of each unit and a single part after disassembly for the quality defect of a product.

Examples of items to be inspected in detail include: dust floating in narrow gaps between electrodes, part processing accuracy, basic specifications of each part (rigidity of the front and rear discs, magnetization characteristics of the permanent magnet), assembly accuracy (at void portions of the magnetic circuit, and the like), and electrical insulation characteristics (at the support portions 4815 and 4816 made of an insulating material in the front disc, and the like). As a result, the cause of a defect can be quickly inspected, and each part can be reprocessed and reused. In the case of the conventional servo-type acceleration sensor, it is not easy to perform not only the inter-electrode gap adjustment process but also the factor investigation when a defect is found. In many cases, the product main body needs to be disposed of.

In the acceleration sensor of the present invention, as long as it can be confirmed that the mass production specification can be reliably satisfied after the quality evaluation, an adhesive may be used to prevent the fastening bolt at each screw-fastened portion from being loosened in order to establish higher long-term reliability. For example, at the junction between the fixing ring 4822 and the coil-side yoke member 4803 that are bolted so as to reserve a predetermined inter-electrode gap, the tapered portion 4825 (chain line circle in FIG. 56) for applying an adhesive to both members may be separately provided. In this case, the positioning bolts 4824 may be detached at the final stage.

### [4] Numerical Magnetic Field Analysis

### [4-1] Analysis Result

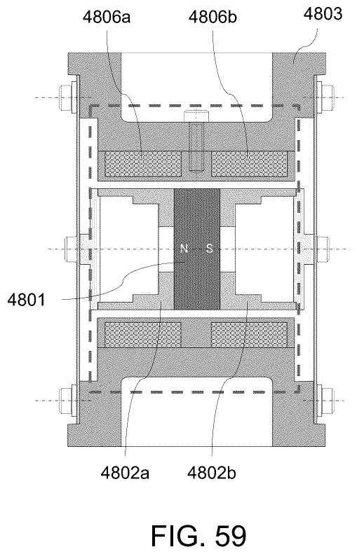

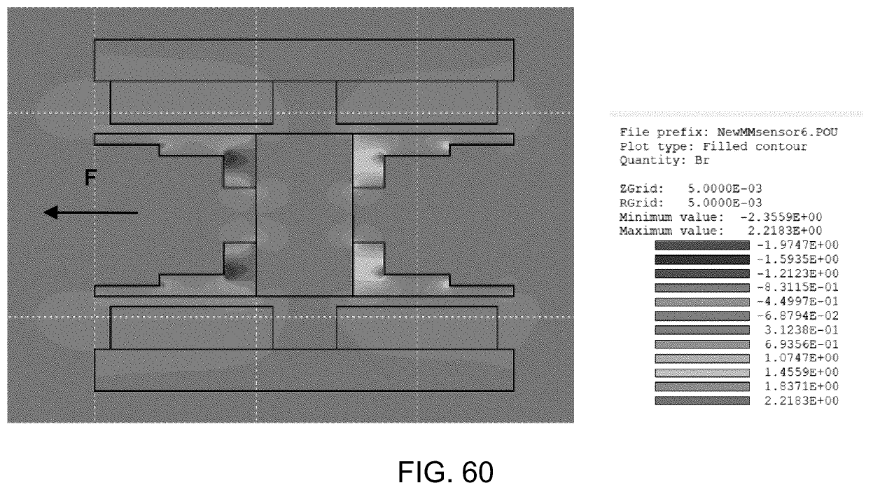

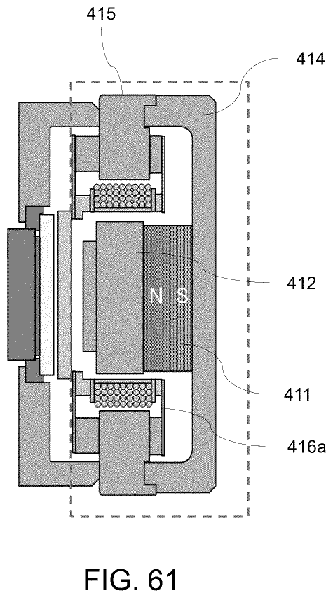

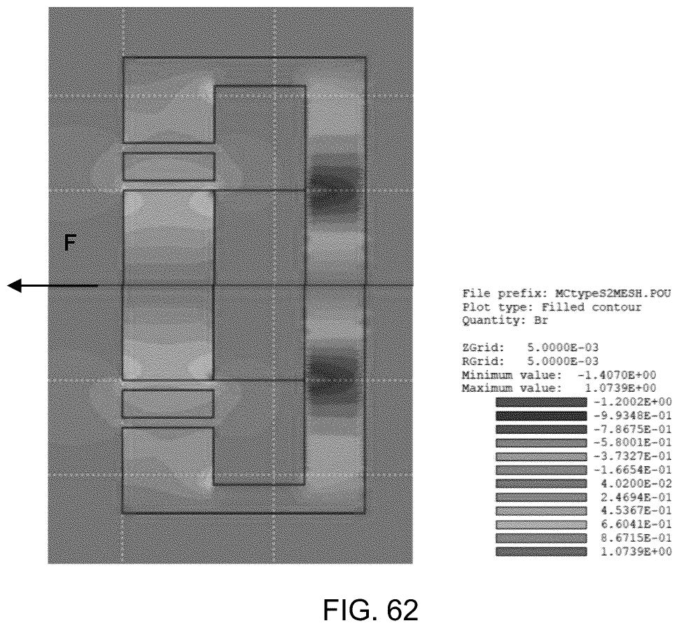

Hereinafter, a result of obtaining the magnetic flux density distribution of the actuator unit of the MM sensor of the present embodiment will be described in comparison with that of the conventional MC type. FIG. 59 is a model view of the actuator unit of the MM sensor, FIG. 60 indicates a numerical analysis result of the MM sensor, FIG. 61 is a model view of an actuator unit of a conventional MC sensor, and FIG. 62 indicates a numerical analysis result of the conventional MC sensor. As can be seen from the numerical analysis result of the MM type, the magnetic flux density distribution is axisymmetric and mirror-symmetric, and the magnitude of the magnetic flux density decreases as the distance from the permanent magnet increases. The generative force (Lorentz force) is obtained from the number of turns of the coil disposed in the magnetic field and the current value.

TABLE 5
Analysis result of generative force

| | | MM type | MC type | Supplement |
|---|---|---|---|---|
| | Symbol | (Present embodiment) | (Conventional type) | (Ratio of MM type to MC type) |
| Mass of movable portion | m | 2.86 g | 1.25 g | 2.29 times |
| Force constant | Kt | 12.7N/A | 4.6N/A | 2.77 times |
| (Generative force with | | | | |
| respect to current) | | | | |

For the MM type, the analysis conditions are as follows: the coil wire diameter: Φ0.05 mm, the number of coil turns: 2400 (two coils), and the type of the permanent magnet: neodymium. For the MC type, the analysis conditions are as follows: the coil wire diameter: Φ0.03 mm, the number of coil turns: 1000, and the type of the permanent magnet: samarium cobalt.

### [4-2] Generative Force and Electrical Resistance

The mass of the movable portion in the MM type is 2.29 times that in the MC type. The generative force in the MM type is 2.77 times that in the MC type, and an increase rate of the generative force is greater than that of the mass of the movable portion. That is, what can be seen is elimination of the disadvantage of the MM type in which the mass of the movable portion increases as compared with the MC type. In addition, although the number of coil turns in the MM type is 2.4 times that in the MC type, an increase in coil electrical resistance is reduced by utilizing a structural feature that a coil housing volume can be increased. That is, in the MM type, the coil wire diameter is larger than that in the MC type and the coil sectional area is 2.78 times that in the MC type, so that an increase in the coil electrical resistance R leading to heat generation is reduced.

### [5] Features of Present Embodiment

### [5-1] Outline of Basic Structure

In the present embodiment, the drive unit (actuator) of the MM acceleration sensor is configured by disposing the pole piece portions on the front side and the rear side so as to sandwich the permanent magnet magnetized in the axial direction, and installing the coil on the fixed side opposing each of the pole piece portions. That is, the present embodiment has an “axisymmetric and mirror-symmetric” actuator structure in which the permanent magnet is installed at the center portion.

### [5-2] Features of Present Embodiment

### 1. Effects in Performance Aspect

For example, when evaluation is performed on the generative force of the actuator, two MC coil bobbins can be installed at the outer peripheral portion of the pole piece portion, where the outer diameter can be set large, and thus the large coil housing volume can be reserved. Therefore, a large number of coil turns can be set without increasing electrical resistance accompanied by heat generation while a coil having a large wire diameter is used. The generative force is proportional to the number of coil turns. Thus, the embodiment of the present invention eliminates the disadvantage of the MM type requiring the generative force enough to compensate for the amount of increase in the inertial mass.

Since the outer diameter of the pole piece portion can be the same as the outer diameter of the permanent magnet, the outer diameter of the pole piece portion can be increased as compared with the actuator structure magnetized in the radial direction. Even if the pole piece portion is formed in a hollow shape and the thickness thereof is made sufficiently small for achieving the reduction in the weight of the movable portion, a sufficient magnetic path area can be set, and thus magnetic saturation hardly occurs.

Furthermore, the magnetic flux flowing in the axial direction of the movable portion is smaller as the distance from the permanent magnet increases. Accordingly, if the thickness of the hollow pole piece portion is made smaller as it is closer to the end portion as illustrated in FIG. 56, the weight of the movable portion can be further reduced without causing magnetic saturation. The permanent magnet may have a through-hole structure (not illustrated). In addition, since the outer diameter of both end portions of the pole piece portion can be increased, the movable member can be supported with a high rigidity at the center portion. A disc cut as in the conventional MC type need not to be performed, and the effective support length of the disc in the radial direction can be increased. Therefore, the movable member can be dynamically stably supported.

### 2. Productivity Improvement Effect

When evaluation is performed from the viewpoint of productivity, the movable portion using the permanent magnet magnetized in the axial direction is easy to be assembled during mass production as compared with the magnet magnetized in the radial direction. In addition, since the outer diameter of the pole piece portion can be increased, a disc (the elastic support member) that supports the movable portion at both ends can be stably installed. Therefore, the perpendicularity between the disc surface and the movable electrode surface with respect to the axis of the sensor main body can be obtained with high accuracy.

Further, in the sensor of the present embodiment, an adhesive-free method based on bolting work can be applied to a unit including a plurality of parts and individual single parts. When a defect is found in a product at the performance evaluation stage, the basic cycle of “disassembly of a sensor main body→cause investigation→countermeasure→reassembly→reevaluation” can be quickly implemented. Therefore, the production yield can be significantly improved as compared with the conventional MC type.

### 3. Effects in Quality Aspect

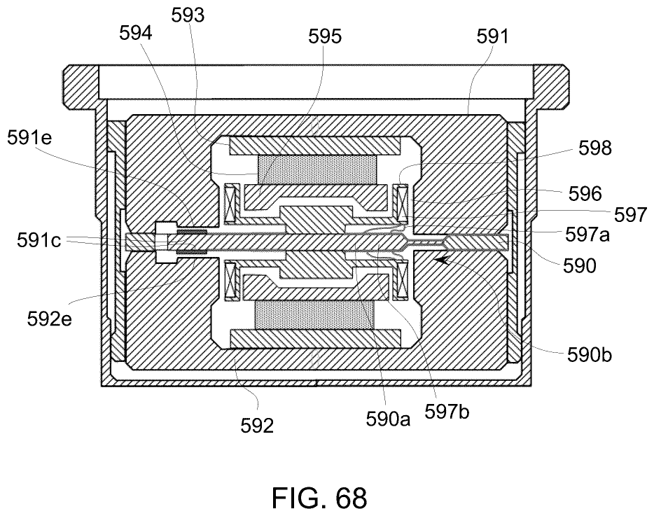

When evaluation is performed in a quality aspect, for example, for the impact of thermal expansion on thermal deformation of members, an axisymmetric and mirror-symmetric structure of a coil as a heat source is extremely effective for countermeasures against thermal expansion. As can be seen by comparing the numerical analysis results of the MM type of the present embodiment indicated in FIG. 60 and the numerical analysis results of the conventional MC type indicated in FIG. 62, the MM actuator unit of the present embodiment has a completely mirror-symmetric magnetic flux density distribution. In the case of the MM type of the present embodiment, the heat distribution is also a mirror-symmetric distribution since the coils disposed bilaterally symmetrically also serve as heat sources. The swing type (FIG. 68), which is a conventional sensor, has a pendulum structure having one end as a fixed end and has a non-mirror-symmetric structure. Thus, the impact of deformation of each member due to thermal expansion on sensor characteristics cannot be avoided. The conventional MC type (FIG. 66) has an axisymmetric structure but not a mirror-symmetric structure.

### [Embodiment 4-2] Application of Present Invention to Differential Type

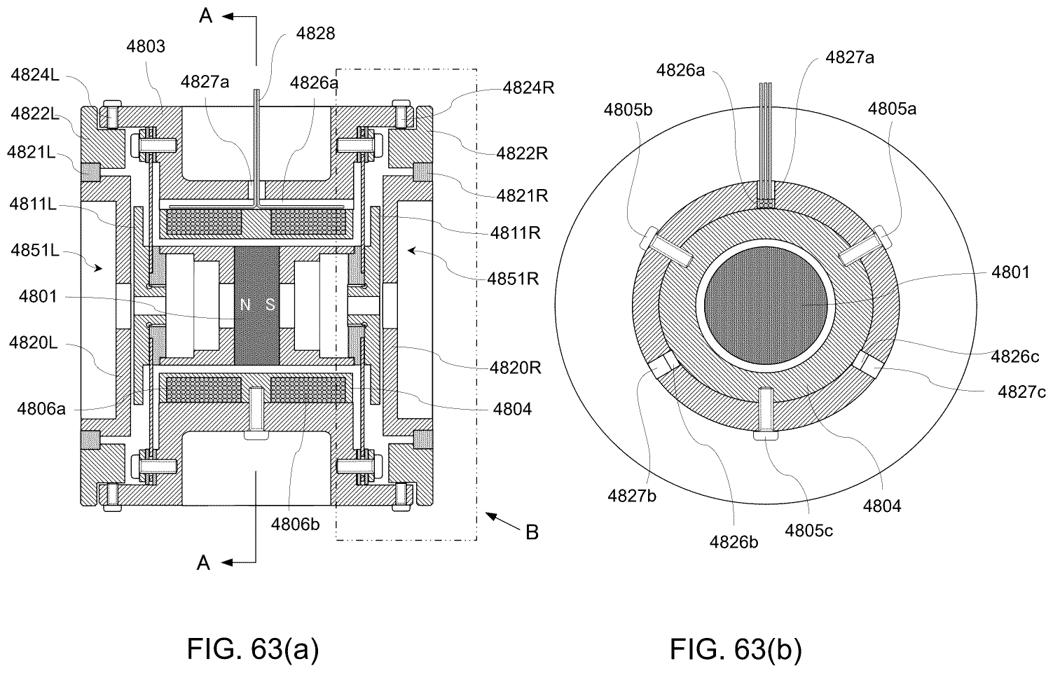

FIG. 63 illustrates a differential servo-type acceleration sensor according to Embodiment 4-2 of the present invention, in which FIG. 63(a) is a front sectional view, and FIG. 63(b) is a view taken along a line AA in FIG. 63(a) and viewed in a direction of arrows AA.

### [1] (Conversion to Differential Sensor)

In the present embodiment, focusing on the structural characteristics of the linear motion MM type in which both the left and right output shafts are open-ended, electrodes for detecting capacitance are respectively provided at two positions on the left and right to form a differential capacitive sensor. An approach to make the acceleration sensor differential can provide a high-resolution sensor in which the sensor output is unsusceptible to disturbance signals such as noise and a drift. The reason why high resolution can be achieved by the differential type is that disturbance signals such as noise and a drift are canceled by taking a difference between two main signals having a phase difference of 180 degrees.

In FIG. 63(b), a portion indicated by an imaginary line B is a portion added to the sensor of Embodiment 4-1. The operation of converting (upgrading) the sensor of Embodiment 4-1 to a differential type is easy. First, the rear fastener 4813 (FIG. 56) is detached from the sensor of Embodiment 4-1, and a movable-side electrode 4811R is mounted instead. Next, it is sufficient that a fixed electrode R-side unit 4851R be fixed using a positioning bolt 4824R through the process of adjusting a gap between the electrodes. The fixed electrode R-side unit Includes a fixed-side electrode 4820a, an insulating ring 4821R, and a fixing ring 4822R.

### [2] Axisymmetric and Mirror-Symmetric Structure

By making the sensor of the present invention differential, the entire sensor including the actuator unit and the displacement detection unit can have an axisymmetric and mirror-symmetric structure. In the present embodiment, grooves, fastening bolts, and the like formed at the fixed member are also formed and disposed equally in the circumferential direction, and thus a perfect axisymmetric structure is realized. Parts constituting the sensor main body are made of materials having different thermal expansion coefficients. For example, when the acceleration sensor is installed at an environmental temperature higher than normal temperature, the sensor main body is three-dimensionally thermally deformed due to a difference in thermal expansion coefficient of the constituent part. In the sensor of the present embodiment, even when the inter-electrode gap changes due to thermal deformation, the distribution in which the left and right inter-electrode gaps change is also the same due to the axisymmetric and mirror-symmetric structure. Therefore, the sensor output can avoid the impact of thermal deformation of members. As described above, the invar alloy which is a low thermal expansion material is used for the housing portion of the conventional swing acceleration sensor (FIG. 68). However, invar alloys are hard-to-work materials and accordingly has significant problems in aspects of productivity and cost. In the sensor of the present invention, the impact of thermal expansion is avoided by devising the sensor structure by utilizing the characteristics of the MM type. Therefore, there is no major constraint on the type of the magnetic material, and the cost can be greatly reduced.

FIG. 63(b) is a view taken along a line AA in FIG. 63(a) and viewed in a direction of arrows AA. Reference signs 4805a, 4805b, and 4805c denote fastening bolts for fixing the coil bobbin 4804 to the coil-side yoke member (fixed member) 4803. Reference signs 4826a, 4826b, and 4826c are grooves formed at the inner peripheral surface of the coil-side yoke member 4803 in the axial direction. Reference signs 4827a, 4827b, and 4827c are radial-direction through-holes formed at the coil-side yoke member and having openings at the grooves. In FIG. 63(b), reference sign 4828 denotes lead wires of the front force coil 4806a and the rear force coil 4806b. The lead wire 4828 is disposed in the axial direction along the groove 4826a and is guided to the outside through the radial-direction through-hole 4827a.

In the present embodiment, the three grooves and the through-holes, both of which are formed at the inner surface of the coil-side yoke member (fixed member) 4803, are equally divided into three portions at intervals of 120 degrees in the circumferential direction. The same applies to the fastening bolts for fixing the coil bobbin. The reason for equally dividing them into three portions in the circumferential direction is to maintain an axisymmetric structure. For extracting a lead wire of the force coil (including the verification coil), it suffices to use the groove 4826a and the through-hole 4827a, which are one groove and one through-hole among the grooves and through-holes. The signal line from the movable-side electrode for detecting the capacitance between the electrodes may use another groove (not illustrated). The presence or absence of the lead wire of the coil and the signal wire of the electrode does not affect deformation of the member due to thermal expansion. There is no constraint on the number of the groove portions and the through-holes. The through-holes may not be used as long as the groove portions and the through-holes are disposed axisymmetrically. The effects of the present invention that axisymmetrically forms the groove portions and the through-holes are not limited to the application to the differential type. It is not necessary to have a mirror-symmetric structure. The impact on deformation of members due to thermal expansion can be reduced as long as a sensor has an axisymmetric structure.

### REFERENCE CHARACTERS LIST

101 permanent magnet
102 movable-side member
105 fixed-side member
116, 104 movable-side yoke member
106 coil
110 movable portion of displacement detector
117 void portion

1. A servo-type vibration detector comprising:
a housing as a fixed member;
a movable member being provided to be movable in a predetermined direction with respect to the housing;
an elastic member being configured to support the movable member, the movable member being disposed with a void portion being interposed between the housing and the movable member;
a displacement detection unit being configured to detect displacement of the movable member in the predetermined direction;
a drive unit being configured to be driven by a servo amplifier, the drive unit being configured to generate a generative force with which the movable member is returned to an origin position when a relative displacement of the movable member from the origin position is detected at the displacement detection unit;
a movable-side electrode being provided at the movable member; and
a fixed-side electrode being provided opposing the movable-side electrode, the fixed-side electrode being closer to the housing than the movable-side electrode is,
wherein
the displacement detection unit is configured to detect a capacitance being formed at a void portion between the movable-side electrode and the fixed-side electrode,
either a groove or a hole communicating with the atmosphere is formed at a relative movement surface between the movable-side electrode and the fixed-side electrode, and is configured to reduce a damping effect of a dynamic fluid pressure being generated at the void portion between the movable-side electrode and the fixed-side electrode, and
the servo amplifier includes a damping unit based on an electrical circuit, and is configured to compensate for a reduction in the damping effect.

2. (canceled)

3. The servo-type vibration detector according to claim 1, wherein the damping unit based on the electrical circuit includes a differentiation circuit being configured to differentiate a signal of the relative displacement.

4. The servo-type vibration detector according to claim 3, further comprising a proportional amplifier circuit being configured to proportionally amplify the signal of the relative displacement that is output from the displacement detection unit,
wherein
the drive unit is configured to be driven by a sum signal of the proportional amplifier circuit and the differentiation circuit, and
the sum signal is a sensor output signal indicating a detected vibration.

5. The servo-type vibration detector according to claim 1, wherein two sets of the displacement detection units are provided, each of the two sets of the displacement detection units individually includes the movable-side electrode and the fixed-side electrode, and a gap of a void portion between the movable-side electrode and the fixed-side electrode of one of the two sets of the displacement detection units is configured to change in an opposite phase with respect to a gap of a void portion between the movable-side electrode and the fixed-side electrode of the other of the two sets of the displacement detection units.

6. The servo-type vibration detector according to claim 5, wherein
the movable-side electrode is provided at each of both end portions of the movable member in an axial direction,
the fixed-side electrode is provided opposing each of the movable-side electrodes, and is closer to the housing than a corresponding one of the movable-side electrodes is, and
a differential sensor is configured by detecting a difference between two capacitances formed between the movable-side electrodes and the respective fixed-side electrodes.

7. The servo-type vibration detector according to claim 1, further comprising:
a coil being fixed to the fixed member; and
a permanent magnet being disposed to generate a magnetic flux flowing in the void portion between the housing and the movable member,
wherein
the movable member includes the permanent magnet and a movable-side yoke member being configured to form a magnetic path between the movable-side yoke member and the permanent magnet, or consists of the movable-side yoke member, and
a closed-loop magnetic circuit is formed by the movable member, the void portion between the housing and the movable member, the fixed member, and the permanent magnet, to constitute the drive unit using an electromagnetic force that moves the movable member in an axial direction.

8. (canceled)

9. The servo-type vibration detector according to claim 1, wherein
ζ_{M}+ζ_{E}≥0.2 holds, or ζ_{M}≤0.6 holds,
where a mechanical damping ratio ζ_{M} and an electrical damping ratio ζ_{E} are defined as
$$\begin{matrix}[ Mathematical Expression 31 ] & \\ \begin{matrix}{ς}_{M} = \frac{{C}_{M}}{2 \sqrt{{mK}_{P}}} \\ {ς}_{E} = \frac{{C}_{E}}{2 \sqrt{m {K}_{P}}}\end{matrix} & ( 31 )\end{matrix}$$
where m is an inertial mass of the movable member, with a unit of kg,
K_{P} is a proportional gain that is a sum of an electrical gain of the servo amplifier and a mechanical spring rigidity of the elastic member, with a unit of N/m,
C_{M} is a mechanical damping coefficient with a unit of Ns/m, and
C_{E} is an electrical damping coefficient of the servo amplifier.

10-12. (canceled)

13. A servo-type vibration detector comprising:
a housing as a fixed member;
a movable member being provided to be movable in a predetermined direction with respect to the housing;
an elastic member being configured to support the movable member, the movable member being disposed with a void portion being interposed between the housing and the movable member;
a displacement detection unit being configured to detect displacement of the movable member in the predetermined direction;
a drive unit being configured to be driven by a servo amplifier, the drive unit being configured to generate a generative force with which the movable member is returned to an origin position when a relative displacement of the movable member from the origin position is detected at the displacement detection unit;
a movable-side electrode being provided at the movable member; and
a fixed-side electrode being provided opposing the movable-side electrode, the fixed-side electrode being closer to the housing than the movable-side electrode is,
wherein
the displacement detection unit is configured to detect a capacitance being formed at a void portion between the movable-side electrode and the fixed-side electrode,
discontinuous-shaped grooves each communicating with the atmosphere is formed at a relative movement surface between the movable-side electrode and the fixed-side electrode, and is configured to reduce a damping effect of a dynamic fluid pressure generated at the void portion between the movable-side electrode and the fixed-side electrode, and
the discontinuous-shaped grooves are each formed by passing through a plate-shaped member by using a surface processing technique.

14. The servo-type vibration detector according to claim 13, wherein the plate-shaped member having an outer diameter larger than an outer diameter of the movable-side electrode is attached to the fixed-side electrode at an outer peripheral portion of the plate-shaped member, and a hole communicating the discontinuous-shaped grooves and the atmosphere is formed at the fixed-side electrode or the movable-side electrode.

15. (canceled)

16. The servo-type vibration detector according to claim 13, wherein an outer peripheral portion of the plate-shaped member is attached to the fixed-side electrode, a portion at which the discontinuous-shaped grooves are formed is open to the atmosphere, and
the discontinuous-shaped groove are formed to satisfy f_{P}>fₙ,
where m is a mass of the movable member of the servo-type vibration detector,
K_{P} is a proportional gain of the servo amplifier,
fₙ is a resonance frequency determined by the m and the K_{P}, and
f_{P} is a primary resonance frequency when the outer peripheral portion of the plate-shaped member is fixed.

17. A servo-type vibration detector comprising:
a housing as a fixed member;
a movable member being provided to be movable in a predetermined direction with respect to the housing;
an elastic member being configured to support the movable member, the movable member being disposed with a void portion being interposed between the housing and the movable member;
a displacement detection unit being configured to detect displacement of the movable member in the predetermined direction;
a drive unit being configured to be driven by a servo amplifier, the drive unit being configured to generate a generative force with which the movable member is returned to an origin position when a relative displacement of the movable member from the origin position is detected at the displacement detection unit;
a movable-side electrode being provided at the movable member; and
a fixed-side electrode being provided opposing the movable-side electrode, the fixed-side electrode being closer to the housing than the movable-side electrode is,
wherein
the displacement detection unit is configured to detect a capacitance being formed at a void portion between the movable-side electrode and the fixed-side electrode,
a groove communicating with the atmosphere is formed at a relative movement surface between the movable-side electrode and the fixed-side electrode, and is configured to reduce a damping effect of a dynamic fluid pressure being generated at the void portion between the movable-side electrode and the fixed-side electrode, and
the groove is formed in a substantially symmetric shape by half etching at a front and a back of a plate-shaped member, one face of the plate-shaped member is mounted to an electrode surface by using a bolt or an adhesive, and a hole communicating with the atmosphere is formed at the other electrode surface opposing the plate-shaped member.

18. A servo-type vibration detector comprising:
a housing as a fixed member;
a movable member being provided to be movable in a predetermined direction with respect to the housing;
an elastic member being configured to support the movable member, the movable member being disposed with a void portion being interposed between the housing and the movable member;
a displacement detection unit being configured to detect displacement of the movable member in the predetermined direction;
a drive unit being configured to be driven by a servo amplifier, the drive unit being configured to generate a generative force with which the movable member is returned to an origin position when a relative displacement of the movable member from the origin position is detected at the displacement detection unit;
a movable-side electrode being provided at the movable member; and
a fixed-side electrode being provided opposing the movable-side electrode, the fixed-side electrode being closer to the housing than the movable-side electrode is,
wherein
the displacement detection unit is configured to detect a capacitance being formed at a void portion between the movable-side electrode and the fixed-side electrode, and
any one of relative movement surfaces of the movable-side electrode and the fixed-side electrode is made of a non-conductive material, a plurality of electrode surfaces are formed by division in a circumferential direction and are each fixed on or above a surface made of the non-conductive material, a flow groove having a substantially radial shape is formed at a boundary of the plurality of electrode surfaces, and the flow groove is configured to concurrently serve for a reduction in a damping effect of a dynamic fluid pressure being generated at the void portion between the movable-side electrode and the fixed-side electrode and as electrical insulation between the plurality of electrode surfaces, and
the plurality electrode surfaces and an opposing electrode surface constitute a plurality of sets of independent capacitive displacement detectors.

19. An assembly method for the servo-type vibration detector according to claim 18, the assembly method comprising:
measuring an inclination angle of the void portion between the movable-side electrode and the fixed-side electrode on a basis of signals of the plurality of sets of independent capacitive displacement detectors, and
correcting an inclination on a basis of a measurement result.

20. A servo-type vibration detector comprising:
a fixed member;
a movable member being provided to be movable in a predetermined direction with respect to the fixed member;
an elastic member being configured to support the movable member, the movable member being disposed with a void portion being interposed between the fixed member and the movable member;
a displacement detection unit being configured to detect displacement of the movable member in the predetermined direction;
a drive unit being configured to generate a force with which the movable member is returned to an origin position when a relative displacement of the movable member from the origin position is detected at the displacement detection unit;
wherein
the displacement detection unit includes
a movable-side electrode being provided at one end face of the movable member in an axial direction,
a fixed-side electrode being provided opposing the movable-side electrode, and
a fixed-side electrode support member being configured to support or being integrated with the fixed-side electrode,
the displacement detection unit is configured to detect a capacitance being formed at a void portion between the movable-side electrode and the fixed-side electrode,
an opening to which a gap adjustment unit of the void portion between the movable-side electrode and the fixed-side electrode is applicable is formed at the fixed member or the fixed-side electrode support member, and
both end portions of the movable member in the axial direction have open axes, or an end portion opposite to the movable-side electrode among the both end portions has an open axis.

21. (canceled)

22. The servo-type vibration detector according to claim 20, wherein the movable member is configured to be firmly held from an outside or restricted from moving in the axial direction by using the open axes at the both end portions in the axial direction or the open axis at the end portion of the movable member that is opposite to the movable-side electrode, the gap adjustment unit is a gap adjustment member including a shim or a spacer, and the opening being configured to receive insertion of the gap adjustment member into the void portion between the movable-side electrode and the fixed-side electrode is formed.

23. (canceled)

24. A servo-type vibration detector comprising:
a fixed member;
a movable member being provided to be movable in a predetermined direction with respect to the fixed member;
an elastic support member being configured to support the movable member, the movable member being disposed with a void portion being interposed between the fixed member and the movable member;
a displacement detection unit being configured to detect displacement of the movable member in the predetermined direction;
a drive unit being configured to be driven by a servo amplifier, the drive unit being configured to generate a generative force with which the movable member is returned to an origin position when a relative displacement of the movable member from the origin position is detected at the displacement detection unit;
a movable-side electrode being provided at the movable member; and
a fixed-side electrode being provided opposing the movable-side electrode, the fixed-side electrode being closer to the fixed member than the movable-side electrode is,
wherein
the displacement detection unit is configured to detect a capacitance being formed at a void portion between the movable-side electrode and the fixed-side electrode,
the movable member includes
a permanent magnet being magnetized in an axial direction, and
a pole piece including a front pole piece portion and a rear pole piece portion, both of which are disposed sandwiching the permanent magnet in the axial direction, and through both of which a magnetic flux flows,
the servo-type vibration detector further comprising:
a front coil being fixed to the fixed member in a void portion between an outer peripheral side of the front pole piece portion and an inner peripheral side of the fixed member; and
a rear coil being fixed to the fixed member in a void portion between an outer peripheral side of the rear pole piece portion and an inner peripheral side of the fixed member,
wherein the drive unit is configured to generate an electromagnetic force with which the movable member is moved in the axial direction by forming a closed-loop magnetic circuit by the permanent magnet, the front pole piece portion, the fixed member, the rear pole piece portion, and the permanent magnet.

25. The servo-type vibration detector according to claim 24, wherein when an axis of the movable member is defined as a Z-axis, and an X-axis orthogonal to the Z-axis is set at a center portion of the permanent magnet in the axial direction, the front pole piece portion and the rear pole piece portion, the front coil and the rear coil, and a front side and a rear side of the fixed member are respectively substantially axisymmetric with respect to the Z-axis, and are respectively substantially mirror-symmetric with respect to the X-axis.

26. The servo-type vibration detector according to claim 24, wherein respective winding directions of the front coil and the rear coil are set to ensure that directions of forces acting on the movable member by electromagnetic forces acting on the front coil and the rear coil are identical to each other.

27. (canceled)

28. The servo-type vibration detector according to claim 1, wherein
the movable-side electrode is fixed to one or both of distal end portions of the front pole piece portion and the rear pole piece portion with a non-conductive material interposed between the movable-side electrode and the front pole piece portion and/or the rear pole piece portion, and
the fixed-side electrode is disposed at an opposing face of the movable-side electrode.

29. (canceled)

30. The servo-type vibration detector according to claim 24, wherein
the movable-side electrode includes
a front movable-side electrode being fixed to a distal end portion of the front pole piece portion with a non-conductive material being interposed between the front movable-side electrode and the front pole piece portion, and
a rear movable-side electrode being fixed to a distal end portion of the rear pole piece portion with a non-conductive material being interposed between the rear movable-side electrode and the rear pole piece portion,
the fixed-side electrode includes
a front fixed-side electrode being provided opposing the front movable-side electrode, the front fixed-side electrode being closer to the fixed member than the front movable-side electrode is, and
a rear fixed-side electrode being provided opposing the rear movable-side electrode, the rear fixed-side electrode being closer to the fixed member than the rear movable-side electrode is, and
a differential sensor is configured by detecting a difference between two capacitances being formed between the front movable-side electrode and the front fixed-side electrode and between the rear movable-side electrode and the rear fixed-side electrode.

31. (canceled)
